(19) United States
(12) Patent Application Publication
(10) Pub. No.: US 2014/0250377 A1
(43) Pub. Date: Sep. 4, 2014

(54) METHOD AND SYSTEM FOR SEARCHING AND ANALYZING LARGE NUMBERS OF ELECTRONIC DOCUMENTS

(71) Applicant: Atigeo LLC, Bellevue, WA (US)

(72) Inventors: Radu Bisca, Bellevue, WA (US); Michael Sandoval, Bellevue, WA (US); Claudiu Barbura, Bellevue, WA (US); Wolf Kohn, Bellevue, WA (US); David Talby, Bellevue, WA (US)

(73) Assignee: Atigeo LLC, Bellevue, WA (US)

(21) Appl. No.: 14/171,681

(22) Filed: Feb. 3, 2014

Related U.S. Application Data
(60) Provisional application No. 61/772,467, filed on Mar. 4, 2013.

(51) Int. Cl. G06F 3/0481; G06F 17/30; G06F 3/0484

(52) U.S. Cl. CPC G06F 3/04815; G06F 3/04817; G06F 3/04842; G06F 17/30011
USPC 715/705; 715/850

(57) ABSTRACT

The current document is directed to methods and systems for accessing, searching, analyzing, and visualizing electronically stored information, including electronic documents. These methods and systems construct graph-like representations of information searches that can be visualized and manipulated in three dimensions. The three-dimensional rendering of search results allows for very large numbers of search results to be visualized conveniently using a graphical user interface displayed on an electronic display device. Methods and systems provide for three-dimensional manipulation of graph-like renderings of search results, visualization-assisted searching, and a large number of research tools for discovering and storing various types of links, connections, and relationships between electronically stored information entities.

### CROSS-REFERENCE TO RELATED APPLICATION

This application claims the benefit of Provisional Application No. 61/772,467, filed Mar. 4, 2013.

### TECHNICAL FIELD

The current document is related to electronic documents, graphical user interfaces, two-dimensional and three-dimensional visual representation of graphs, and, in particular, to a method and system for searching and analyzing electronic documents using graph-like representations of search results and other types of visual representations.

### BACKGROUND

The widespread adoption of electronic computer systems and the rapid and ongoing evolution of computer systems over the past 60 years has revolutionized many aspects of modern life and created large new industries and marketplaces. Up through at least the 1970s, governments, corporations, and other large organizations employed armies of typists and file clerks to generate and manage large numbers of paper documents. With the advent of word-processing applications and distributed, database-based, electronic document management systems, much of the former paper-based documents have been replaced with electronic documents. Similarly, it was standard practice, through at least the 1970s, for researchers in science, technology, economics, and other fields to spend hours in libraries to access journal articles and other printed publications in order to research various topics. Various online information services became available to supplement library-based research during the 1970s. Beginning in the mid 1990s, a huge amount of information contained in documents and publications was shifted to the Internet, allowing users to access the information through web browsers from document and information sources distributed across the world.

While modern technological advancements have vastly increased the number and accessibility of documents and other stored information, the technological advancements have also resulted in a geometrical growth in the amount of information and stored documents that are available to users of online information services and the Internet. Common, long-used practices of informal browsing and manual note-taking are no longer adequate for searching large numbers of documents and other types of stored information, analyzing electronic documents and other electronically stored information, and attempting to conceptualize many different links, connections, and associations between stored-information entities available from information sources that may provide access to hundreds of thousands, millions, or more electronic documents and other stored information. As a result, those who access and analyze electronically stored information continue to seek methods and systems to facilitate access and analysis of electronically stored information.

### SUMMARY

The current document is directed to methods and systems for accessing, searching, analyzing, and visualizing electronically stored information, including electronic documents. These methods and systems construct graph-like representations of information searches that can be visualized and manipulated in three dimensions. The three-dimensional rendering of search results allows for very large numbers of search results to be visualized conveniently using a graphical user interface displayed on an electronic display device. Methods and systems provide for three-dimensional manipulation of graph-like renderings of search results, visualization-assisted searching, and a large number of research tools for discovering and storing various types of links, connections, and relationships between electronically stored information entities.

### BRIEF DESCRIPTION OF THE DRAWINGS

FIG. 1 illustrates information entities and characteristics of information entities to which the currently described methods and systems are applied.

FIG. 2 illustrates document sources.

FIGS. 3A-C illustrate an example document search.

FIGS. 4A-F illustrate a graph-like rendering of search results provided by the currently described methods and systems.

FIG. 5 shows an alternative illustration of the graph-like rendering of the search process and search results illustrated in FIGS. 4A-F.

FIGS. 6A-G illustrate details about the three-dimensional display of the graph-like representations of searches and search results as well as basic manipulations of the graph-like renderings available to users through the GUI provided by the currently described methods and systems.

FIGS. 7A-N illustrate other types of operations and facilities made available to a user through the GUI provided by the currently disclosed methods and systems.

FIGS. 8A-I illustrate additional operations available to a user of the currently described method and system for manipulation of graph-like representations of search processes and search results.

FIGS. 9A-B illustrate a search-in-graph operation provided by the currently described methods and systems.

FIGS. 10A-K illustrate additional features of the GUI provided by the currently discussed methods and systems.

FIGS. 11A-E illustrate one navigation tool provided by the GUI that is, in turn, provided by the currently discussed methods and systems.

FIGS. 12A-F illustrate certain elements of a stack-mode display.

FIGS. 13A-13H illustrate the correspondence between a graph-like representation of a search process and search results and a stack representation of the same search process and search results.

FIG. 14 illustrates a third type of representation of search processes and search results referred to as a “heat-map display.”

FIG. 15 illustrates yet another feature of the GUI provided by the currently discussed methods and systems.

FIG. 16 provides a general architectural diagram for various types of computers and other processor-controlled devices.

FIG. 17 illustrates generalized hardware and software components of a general-purpose computer system.

FIG. 18 illustrates generalized hardware and software components of a general-purpose computer system that includes a virtualization layer.

FIG. 19 illustrates an Internet-connected distributed computer system.

FIG. 20 illustrates cloud computing.

FIG. 21 illustrates electronic communications between a client and server computer.

FIG. 22 illustrates the role of resources in RESTful APIs.

FIGS. 23A-D illustrate four basic verbs, or operations, provided by the HTTP application-layer protocol used in RESTful applications.

FIG. 24 provides one example of the data stored within a node object to describe a document node.

FIGS. 25A-H show data contained in a data script structure to describe an entire graph, in one implementation of the currently described methods and systems.

FIGS. 26-27 show control-flow diagrams that describe overall operation of one implementation of the currently described methods and systems.

### DETAILED DESCRIPTION

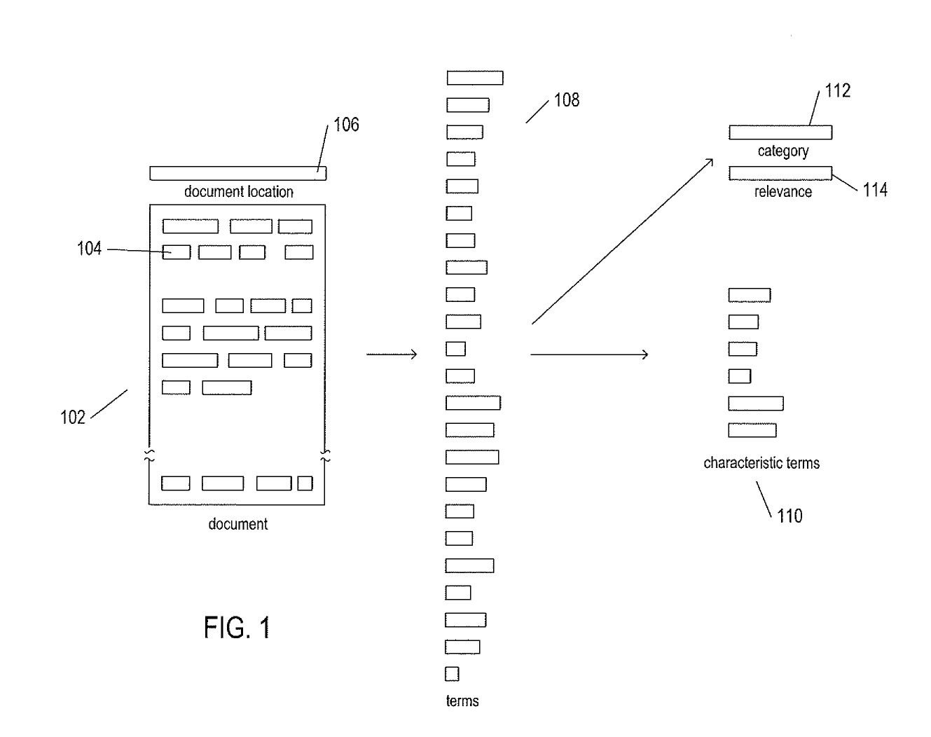

FIG. 1 illustrates information entities and characteristics of information entities to which the currently described methods and systems are applied. In the following discussion, information entities are referred to as “documents.” These may be traditional electronic documents, electronically stored publications, or any of many other types of information entities that include natural-language words and text. For purposes of the present discussion, a document 102 is considered to include a number of terms and short phrases, represented in FIG. 1 by small rectangles, such as rectangle 104. A document may be traditional electronic document, an electronically stored publication, or any of many other types of information entities that include natural-language words and text. Each document is associated with a document location 106. In many cases, the document location may be a universal resource locator (“URL”) or universal resource identifier (“URI”) that allows a web browser or other computer application to access the document through the Internet. Documents may also be associated with, or contain, titles. Each document can be processed to generate a list of terms 108 contained within the document. In the following discussion, the word “term” is used to generally mean a word or short phrase of a natural language, but may also include numbers, acronyms, and other groups of symbols that can be parsed from a document. Based on the list of terms 108 extracted from a document and on other considerations, a set of characteristic terms 110 can be selected to describe the document. In addition, the document can be assigned to a particular category of documents 112, with the assignment of the document to the category associated with a relevance score 114 that, in many implementations, is a real number in the range [0,1].

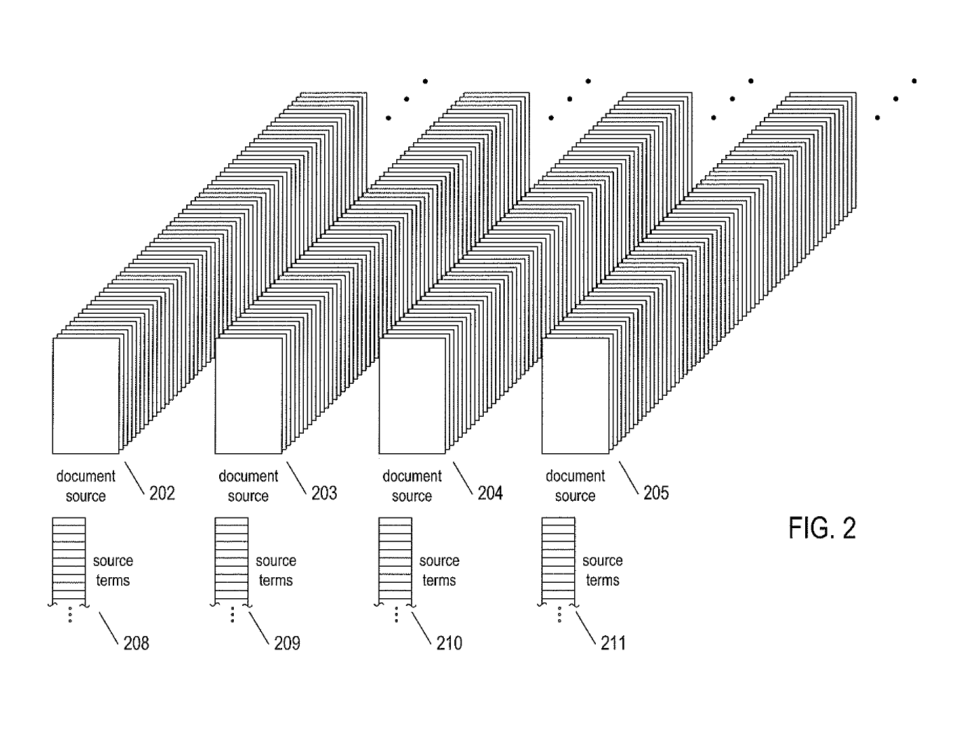

FIG. 2 illustrates document sources. In general, electronic documents and other types of electronically stored information are accessed from particular document sources, which may include online information services, electronic databases and archives, particular web sites, or the Internet in general. In FIG. 2, four different document sources 202-205 are illustrated as four large collections of documents. Just as a particular document may be characterized by a list of characteristic terms, document sources may also be associated with a generally much larger number of characteristic source terms 208-211.

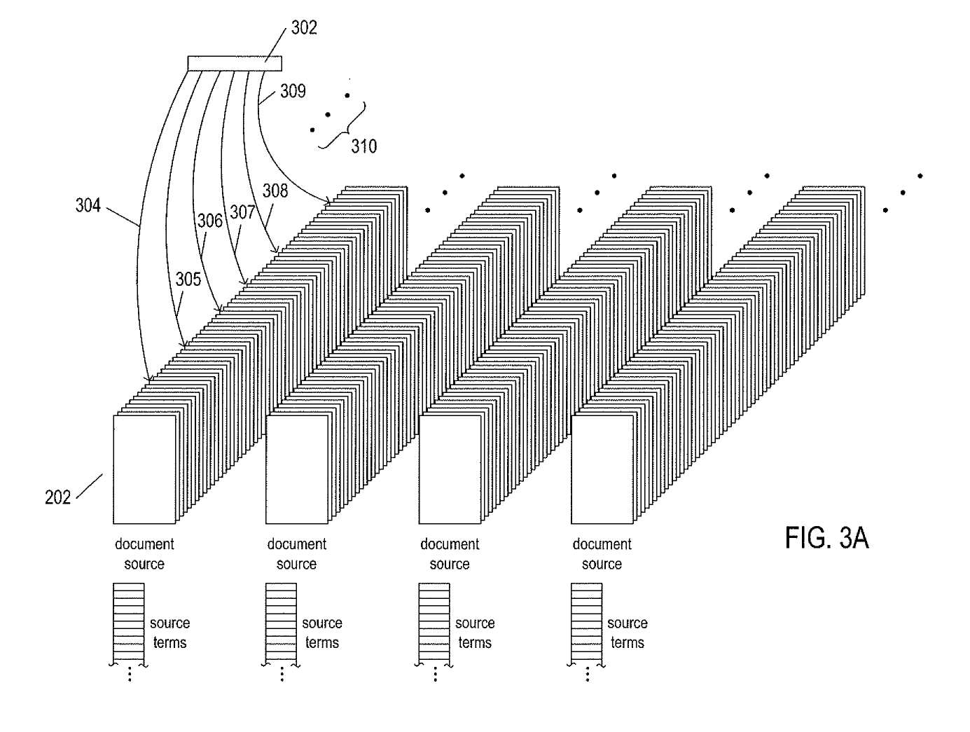

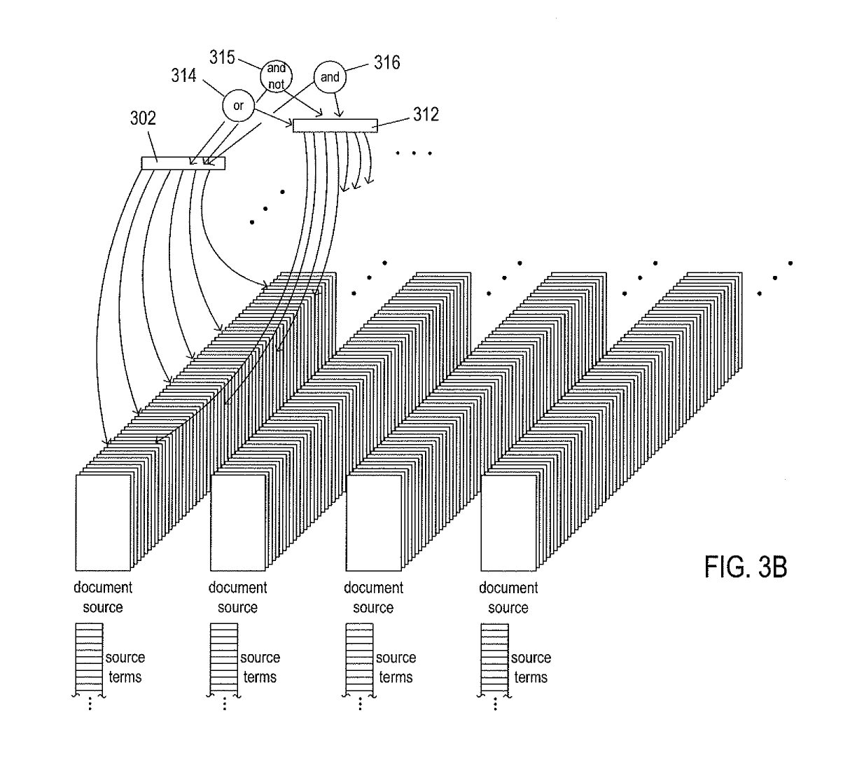

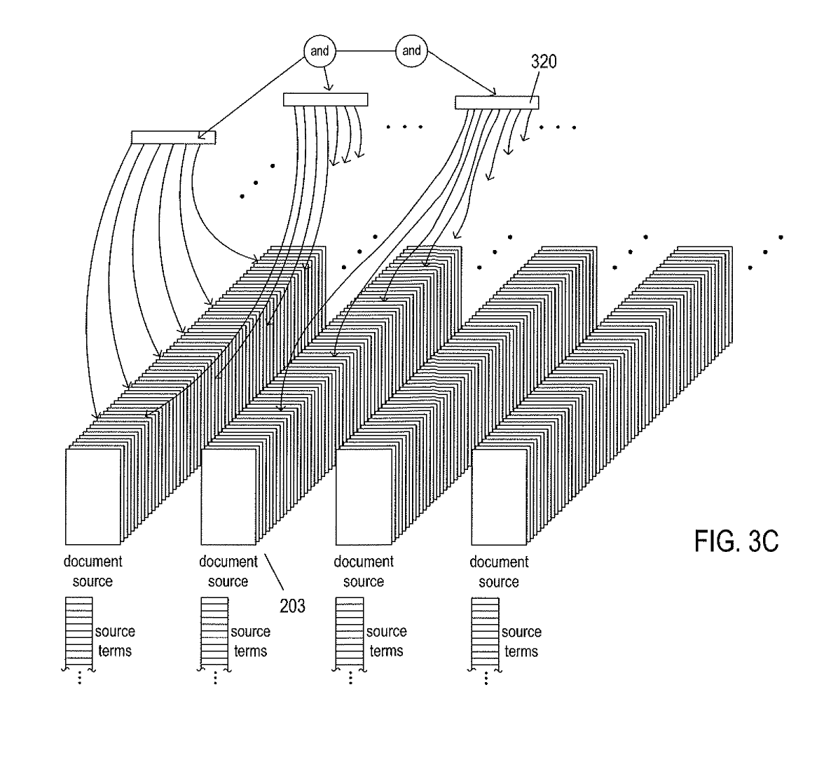

FIGS. 3A-C illustrate an example document search. As shown in FIG. 3A, the search begins based on a particular term 302. In this example, all of the documents in document source 202 are searched for the occurrence of the initial search term 302. In most document sources, many different types of indexes, including keyword indexes, are maintained for the documents accessible through the document source in order to facilitate this type of searching. As shown by arrows 304-309 and ellipses 310, a large number of documents within document source 202 may be identified as containing one or more instances of the original search term. As shown in FIG. 3B, a more complex search may involve the initial search term 302 as well as a second search term 312, with the search directed by a Boolean combination of the two search terms, such as the Boolean operators “OR” 314, “AND NOT” 315, and “AND” 316. Such multi-term searches may be carried out in a stepwise fashion, with the results produced from an initial single-term search, such as that shown in FIG. 3A, supplemented or modified by an additional search based on a second term or a Boolean-operator joined combination of the first term and second term. As shown in FIG. 3C, a multi-term search may be extended, using a third search term 320, to include documents of a second document source 203. Again, such multi-term searches may be carried out based on a single Boolean expression that includes all of the search terms or in stepwise fashion, with progressive modification of search results produced through a sequence of searches.

The types of document searches illustrated in FIGS. 3A-C may produce very large result sets. For even modestly sized document sources, tens of thousands or more documents may be retrieved from a single-term search. When a sequence of terms are employed in a sequence of searches that sequentially supplement and modify an initial search, a researcher may wish to somehow keep track of, or annotate, various relationships among the discovered documents. However, when result sets contain thousands, tens of thousands, or more documents, it is clearly impossible to create and maintain these types of annotations and indications of relationships between individual documents. In fact, it is often essentially impossible for the researcher to even cursorily review information about the documents produced by term searches due to the large volumes of documents in the results sets. In other words, modern technology provides for efficient and cost-effective storage of enormous numbers of electronic documents, easy access to these documents through the Internet, and powerful tools for searching for particular documents, but has, so far, not provided tools for efficient use and understanding of large result sets obtained by searching document sources for documents.

The current document discloses methods and systems for searching for documents that provide a graphical user interface (“GUI”) that allows a user to easily visualize search results, even search results containing thousands of documents, and provides tools for sequential searching, searching multiple document sources, annotating and storing search-based investigations and search results, and a variety of additional capabilities. Although searches and search results can be visualized in a variety of different ways, using the currently described methods and systems, a large number of the tools and GUI features are based on a three-dimensional, graph-like rendering of the search process and search results.

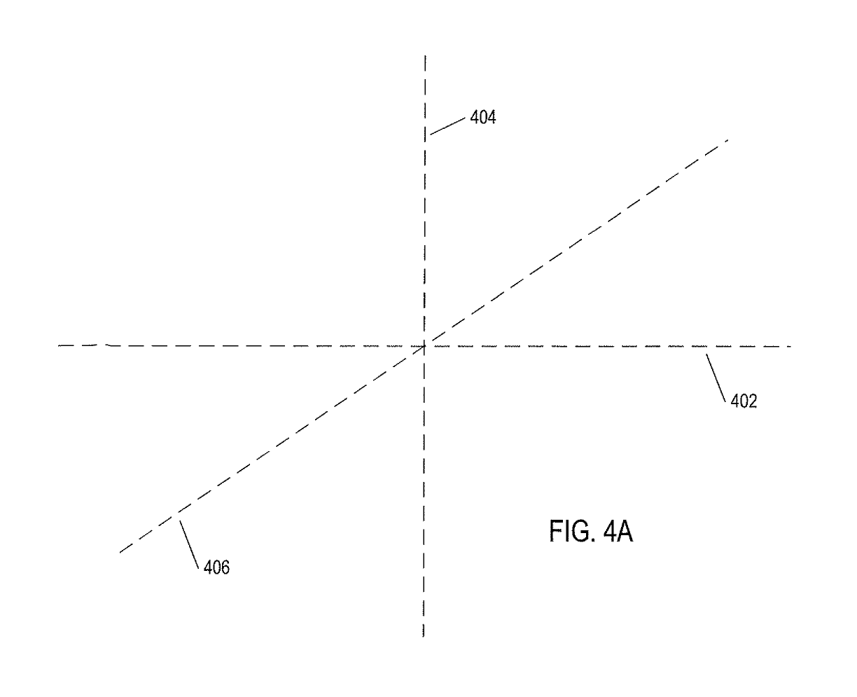

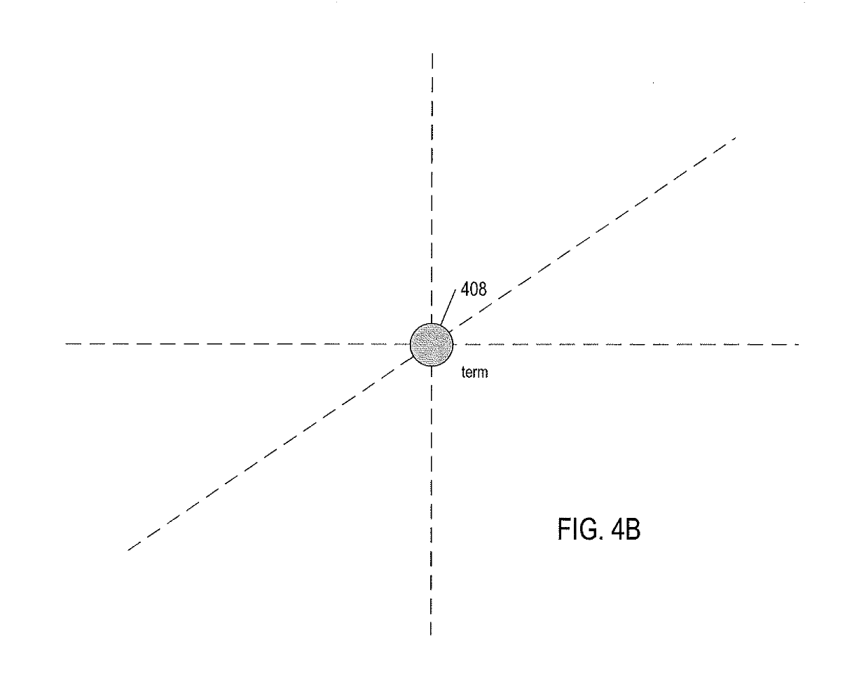

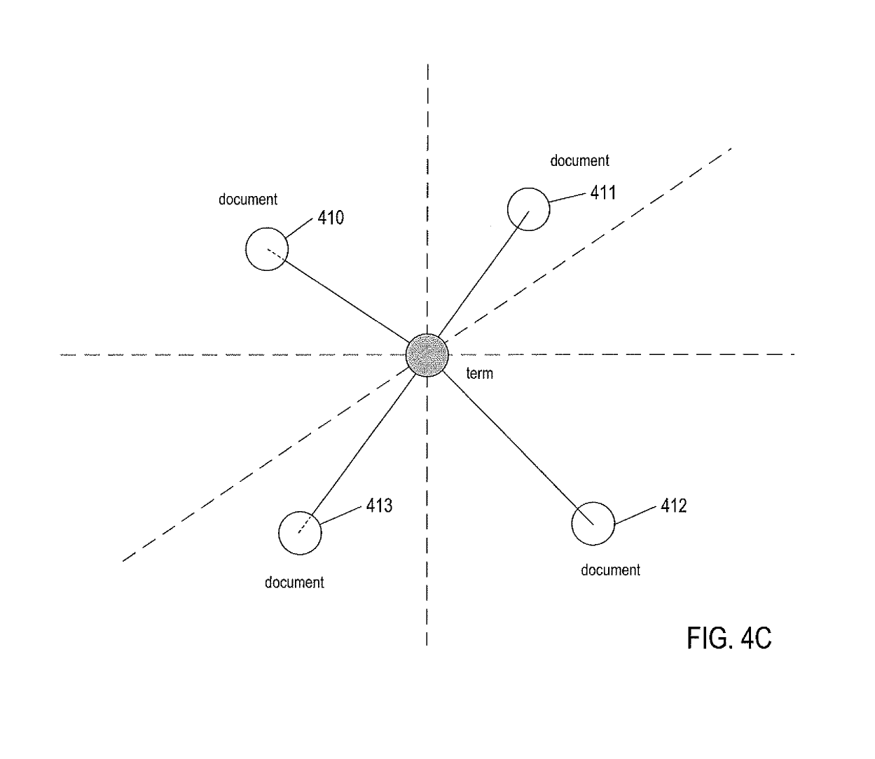

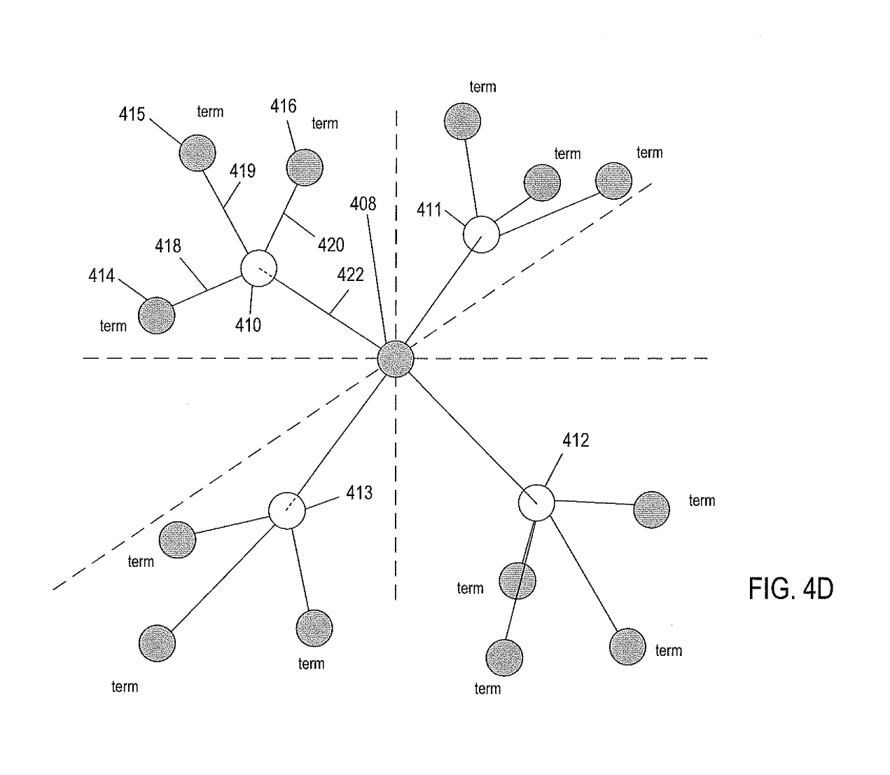

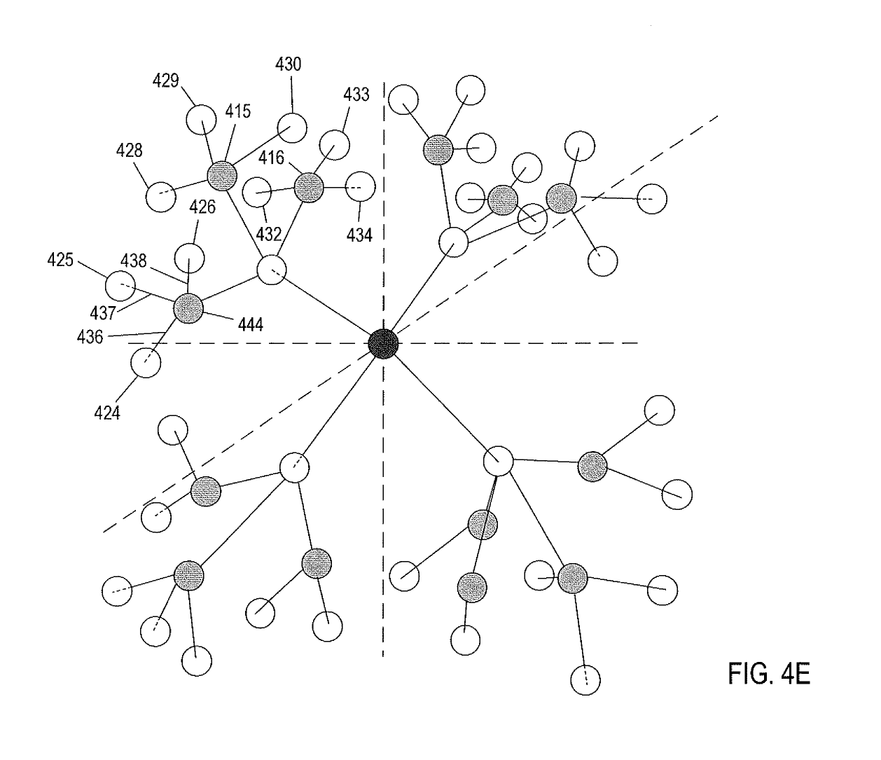

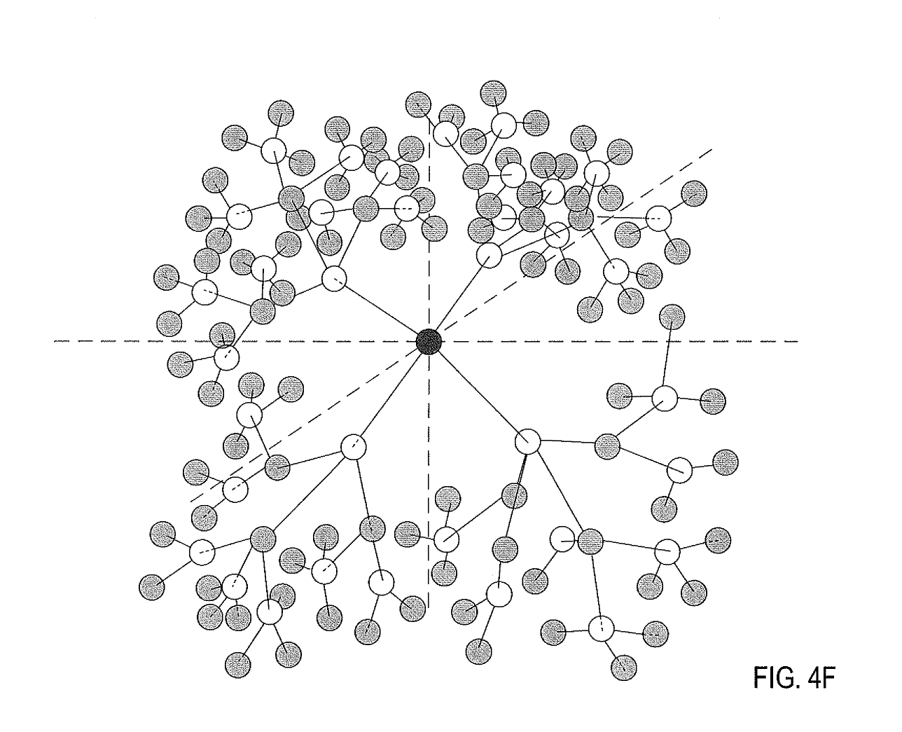

FIGS. 4A-F and 5 illustrate a graph-like rendering of search results provided by the currently described methods and systems. As shown in FIG. 4A, a document search and search results obtained by the document search are visualized in three dimensions. In many cases, a Cartesian coordinate system is used, with a horizontal y axis 402, a vertical x axis 404, and a z axis 406. The x and y axes lie in the plane of an electronic display device and the positive z axis projects outward, towards a viewer, orthogonal to the plane of the electronic display device. As shown in FIG. 4B, a document search may begin with a single search term. In one implementation, the initial search term 408 is represented by a spherical node and positioned coincident with the origin of the three-dimensional coordinate system. When the search is carried out with respect to documents accessible through a particular document source, a number of documents related to the search term is returned as a result set. As shown in FIG. 4C, these returned documents are represented by document nodes 410-413. In FIG. 4C, only four documents are shown in the initial result set although, in many cases, the initial result set may contain up to some maximum number of documents, with the maximum number a user-defined or default setting. Documents returned from a term search may be only those documents that contain more than a threshold number of instances of the search term. This threshold may also be a user-defined or default setting. The mechanics of the searching process and the various settings and parameters that define which documents, and the number of documents, returned by a particular term-based search are generally orthogonal to the currently described methods and systems for visualizing the search process and result sets returned by searched. In other words, the currently described methods and systems are related to display of the search process and search results, rather than implementation of the search process and specific types of search results.

As shown in FIG. 4D, each of the documents in the original result set 410-413 may be analyzed to produce a set of characteristic terms for the document. This analysis may involve considering the frequency of occurrences of terms within the document, the characteristic terms for the document source, and other such considerations, and may be controlled by various parameters and settings with respect to various thresholds and maximum numbers, just as for the term search. The characteristic terms for each document are then represented by additional term nodes linked to the respective document. For example, in FIG. 4D, the characteristic terms determined for document 410 represented by term nodes 414-416 connected to document 410 by links 418-420. Document 410 is connected to the original search term node 408 by link 422. As shown in FIG. 4E, new document searches can be spawned from each of the characteristic terms identified for each of the initial documents. For example, searches are spawned from term nodes 414-416, and these new searches produce additional document nodes 424-426, 428-430, and 432-434, respectively. Similar expansion of the other term nodes has been carried out to produce the graph shown in FIG. 4E. As before, the new documents produced by the new searches, such as documents 424-426 produced by a new search based on term node 414, are linked to the term node by links 436-438. The second-level or second-order searches spawned from the term nodes associated with the document nodes produced by the first term search may be based on any of various different Boolean connectors. For example, the search may be carried out for documents containing the initial search term and the characteristic term, for documents containing the initial search term but not containing the characteristic term, or for various other Boolean operators. The type of search used in the expansion may also be defined in user settings and, as discussed later, may be directly specified by a user for particular expansions. As can be appreciated from the graph shown in FIG. 4E, a convention is used in these illustrations in which term nodes are shaded and document nodes are unshaded. FIG. 4F illustrates the graph-like rendering of a multi-term search following addition of term nodes to the second level of documents. The number of initial document-node and term-node expansions carried out by the currently described methods and systems for an initial specified search term can be controlled by user-defined settings and parameters.

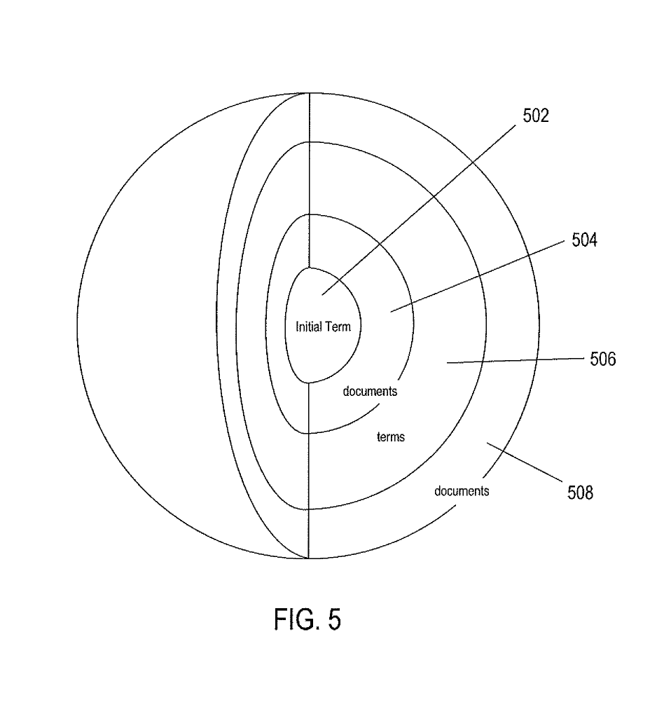

FIG. 5 shows an alternative illustration of the graph-like rendering of the search process and search results illustrated in FIGS. 4A-F. The graph-like rendering can be viewed as concentric layers. The innermost sphere 502 represents the initial search term. A next layer 504 contains the initial documents found by searching a document source using the initial search term. A next layer 506 includes the characteristic terms generated for each of the initially found documents. A next layer 508 includes a next set of documents found by searches that consider both the initial term 502 and characteristic terms 506 produced from the initially found documents. Each layer is an expansion of the next innermost layer, with document and term expansions alternating.

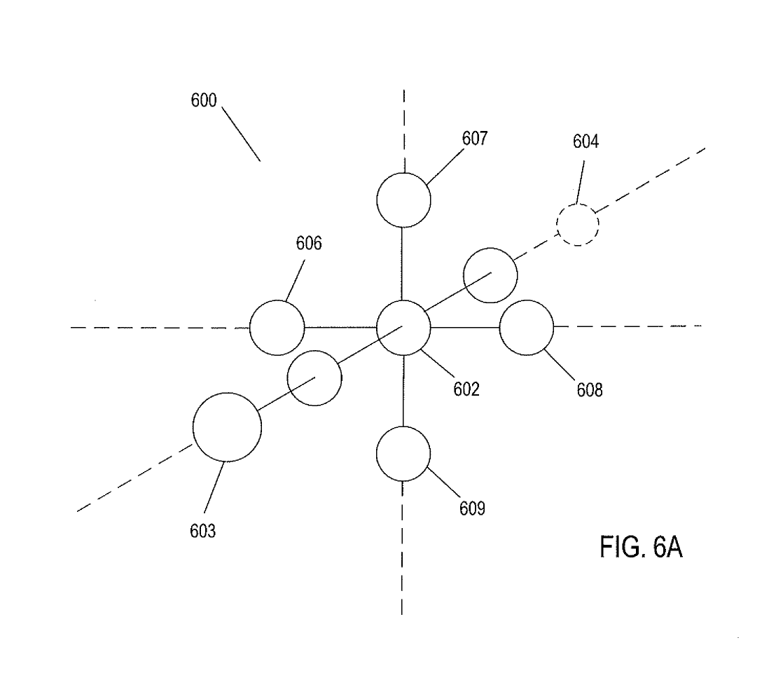

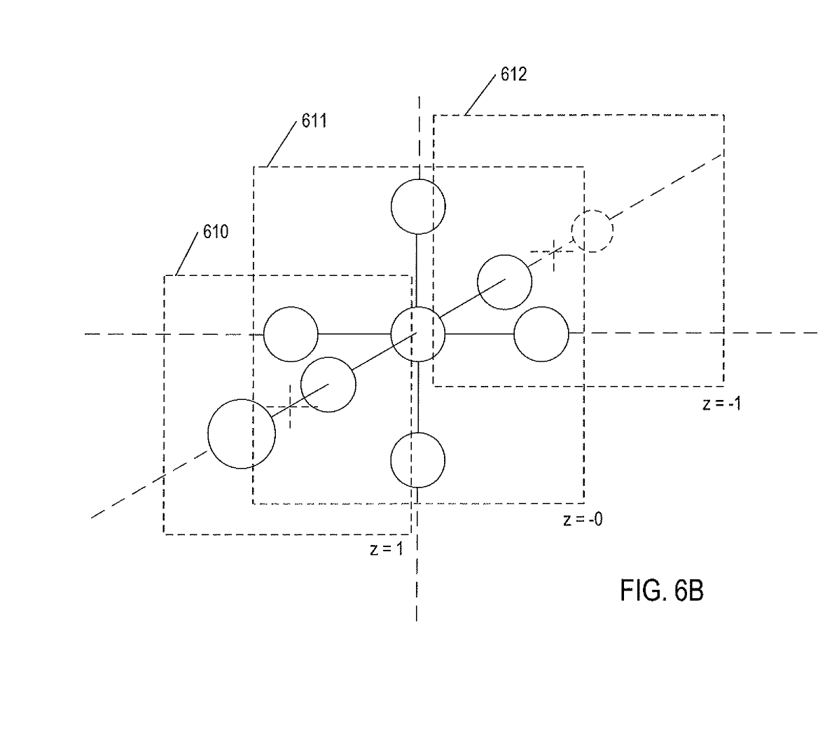

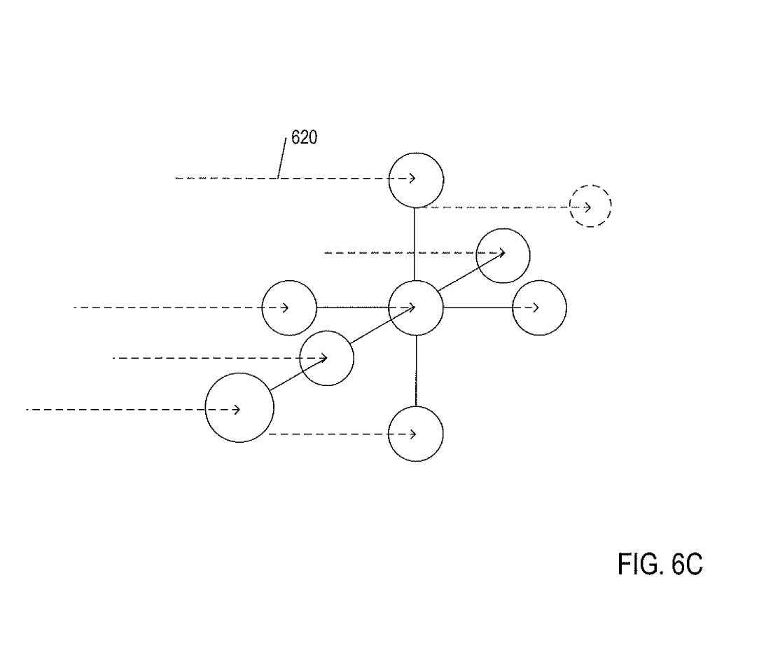

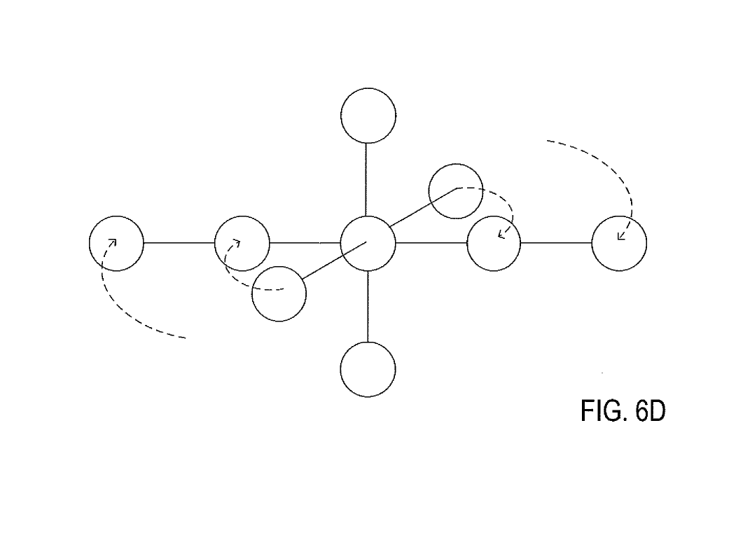

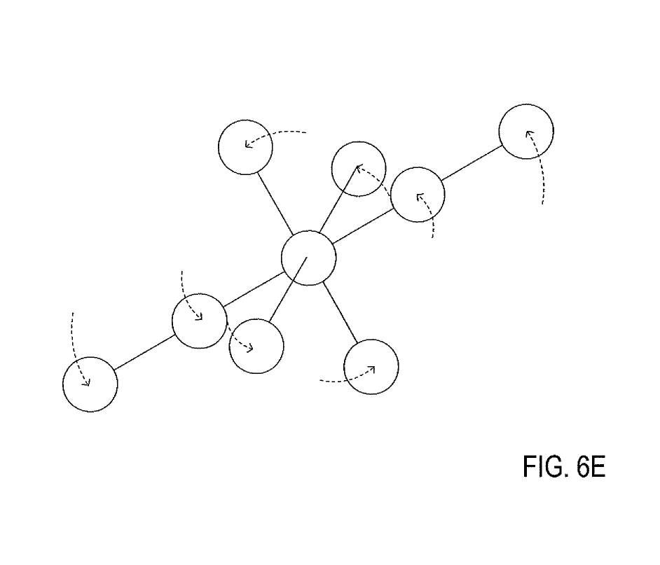

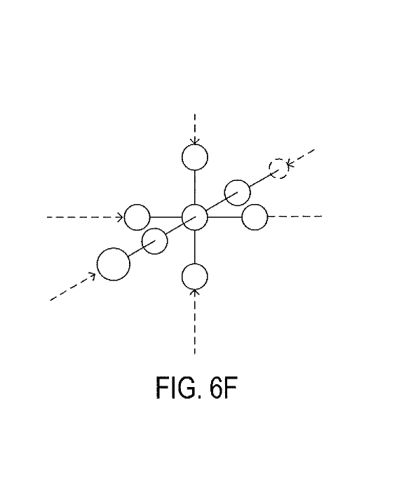

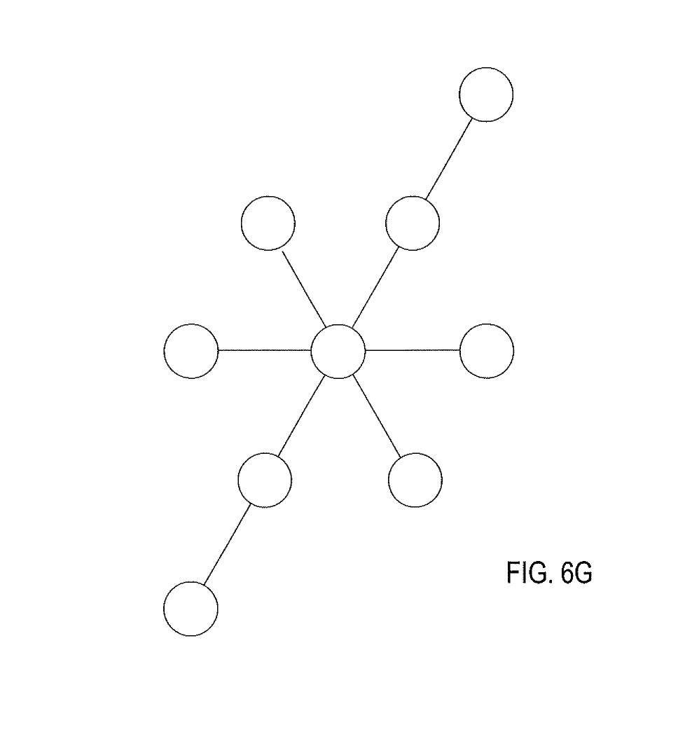

FIGS. 6A-G illustrate details about the three-dimensional display of the graph-like representations of searches and search results as well as basic manipulations of the graph-like renderings available to users through the GUI provided by the currently described methods and systems. FIG. 6A shows a very small graph-like rendering 600 consisting of three term nodes 602-604 and four document nodes 606-609. Certain implementations of the GUI may provide realistic three-dimensional renderings of the graph. For example, node 603, logically closest to the user as a result of having the greatest z coordinate, is displayed as a sphere of greater radius then the spheres used for display of nodes 602 and 606-609. Node 604, furthest away from the user as a result of having the largest negative z coordinate, would be displayed as a sphere with a smaller radius than the spheres used to display nodes 602 and 606-609. However, not only the radii of the sphere vary with respect to position along the z axis, but the appearance of the nodes may also vary. In certain implementations, nodes are increasingly blurred with increasing negative z coordinates and finally not displayed, when the magnitude of the negative z coordinates of the nodes exceed a threshold negative z-coordinate magnitude. In this fashion, a great deal of information that would otherwise clutter the rendering of the graph is not displayed to the user.

FIG. 6B further illustrates the display technique described above with reference to FIG. 6A. In FIG. 6B, abstract planes orthogonal to the z axis, such as abstract planes 610-612, are spaced long the z axis at various z coordinates. The volumes of Cartesian space between the planes represent regions in which the nodes and links of the graph have constant radii, widths, and degrees of blurring and/or fading. The sphere radii and the degrees of blurring and/or fading may be different for each abstract-plane-bounded region. In the current case, nodes with z coordinates greater than the z coordinate of abstract plane 610 have large radii, nodes with z coordinates less than the z coordinate of abstract plane 610 and greater than the z coordinate of abstract plane 612 have medium-sized radii, and nodes with z coordinates less than the z coordinate of abstract plane 612 have small radii. In this example, nodes with z coordinates less than the z coordinate of plane 612 are faded to invisibility while other nodes are displayed without blurring or fading. However, any number of abstract planes may be defined and the radii of the spherical renderings of the nodes and the degree of fading and/or blurring may differ for each sub-volume bounded by two abstract planes so that nodes appear to be progressively smaller with increasing logical distance from the user and are displayed with progressively increasing blurring and/or fading within increasing distance from the user. Generally, past some threshold negative z coordinate, all nodes with greater than the threshold negative z coordinate are not displayed.

The GUI of the currently described methods and systems allows the user, using various types of user input, including mouse clicks, touch-screen inputs, or touch-pad inputs, to manipulate the three-dimensionally rendered graph in three dimensions. FIGS. 6C-F illustrate a subset of the various types of manipulations that can be carried out by a user through the GUI. As shown in FIG. 6C, the user may translate the graph, in any direction, with respect to the original position of the graph in the display screen. In FIG. 6C, dashed arrows, such as dashed arrow 620, represent a logical translation of a node, in this case in the positive y direction. Similarly, as shown in FIGS. 6D-E, using the same illustration conventions used in FIG. 6C, the three-dimensional rendering of the graph can be arbitrarily rotated in any direction in Cartesian three-dimensional space. As shown in FIG. 6F, the three-dimensional rendering of the graph may be scaled differently in order to increase or decrease the apparent size of the nodes and bonds and the spacing between them. Additionally, as shown in FIG. 6G, a three-dimensional representation of a search process and search results may be converted to a two-dimensional representation. In FIG. 6G, the small example graph shown in FIG. 6A is re-displayed as a two-dimensional graph. Note that the conversion of a three-dimensional graph to a two-dimensional graph may not necessarily be a projection of the three-dimensional graph onto an arbitrary logical plane, but may instead involve significant change in illustration conventions and relative positions of nodes and links. However, the connectivity of nodes to other nodes remains unchanged.

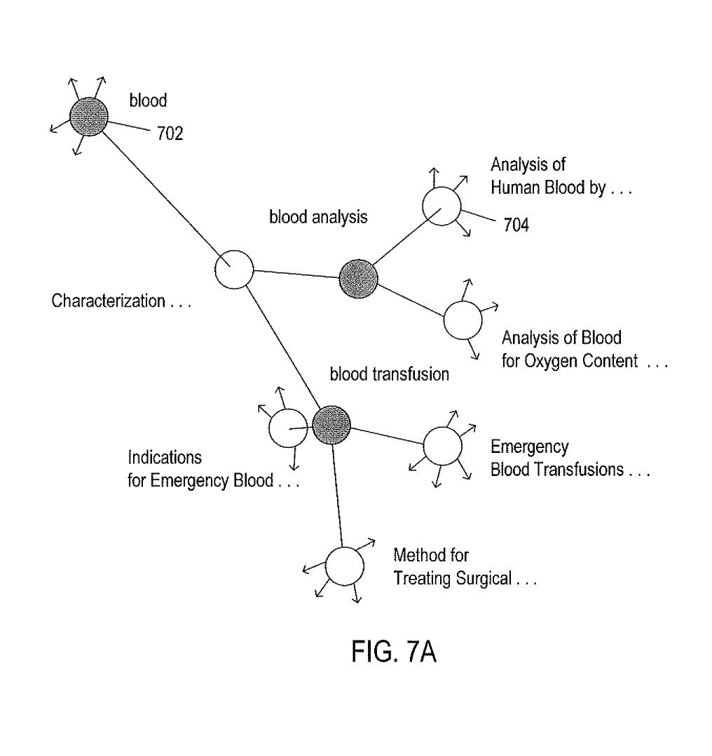

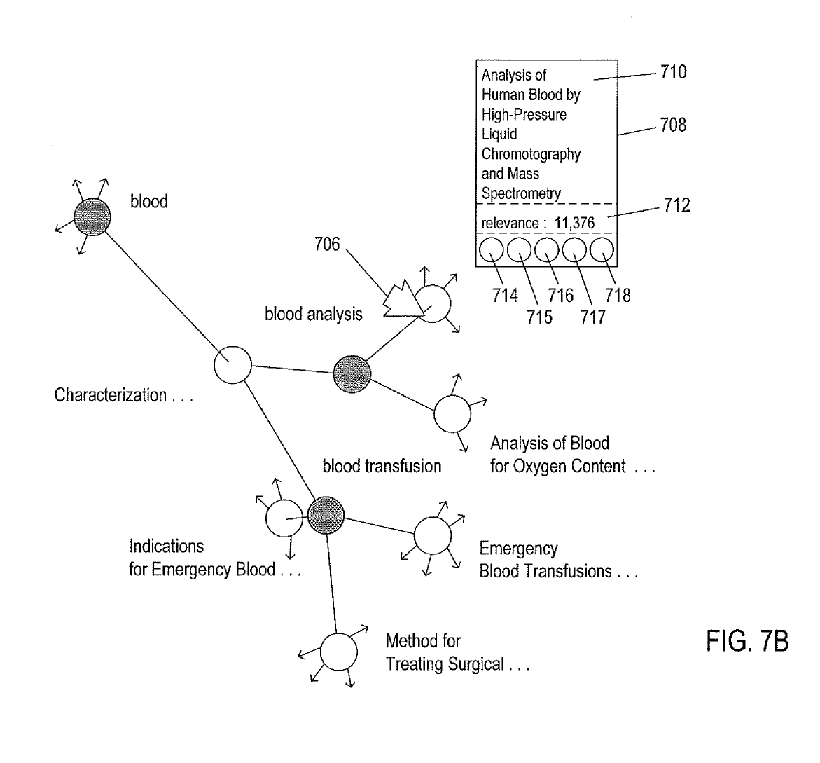

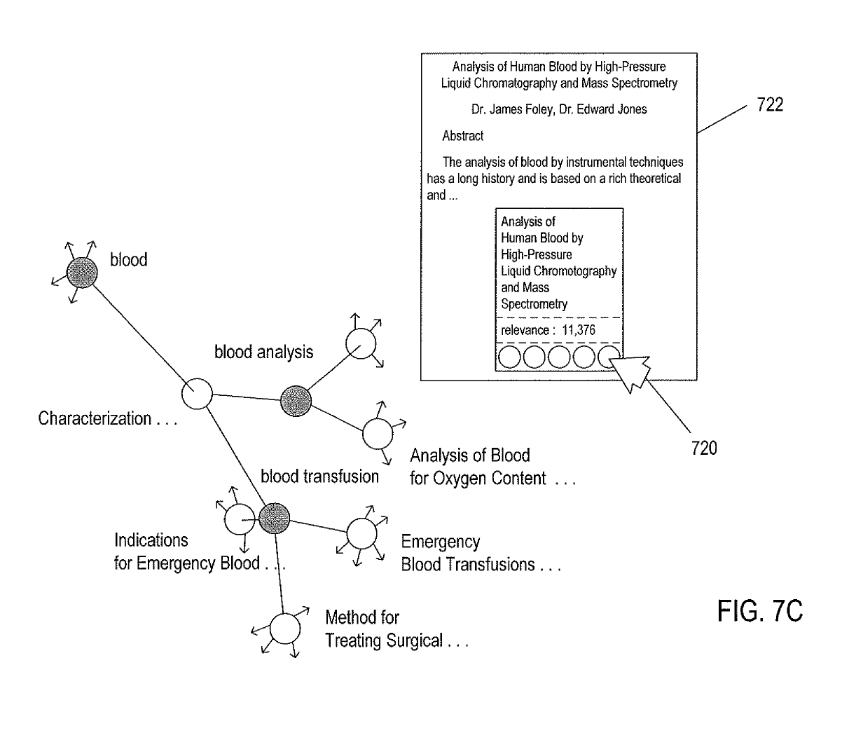

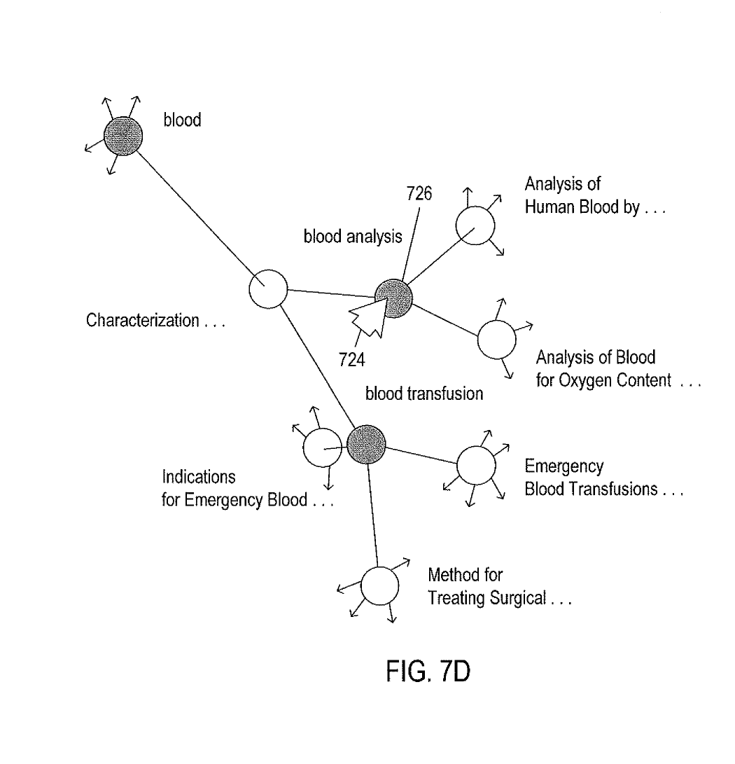

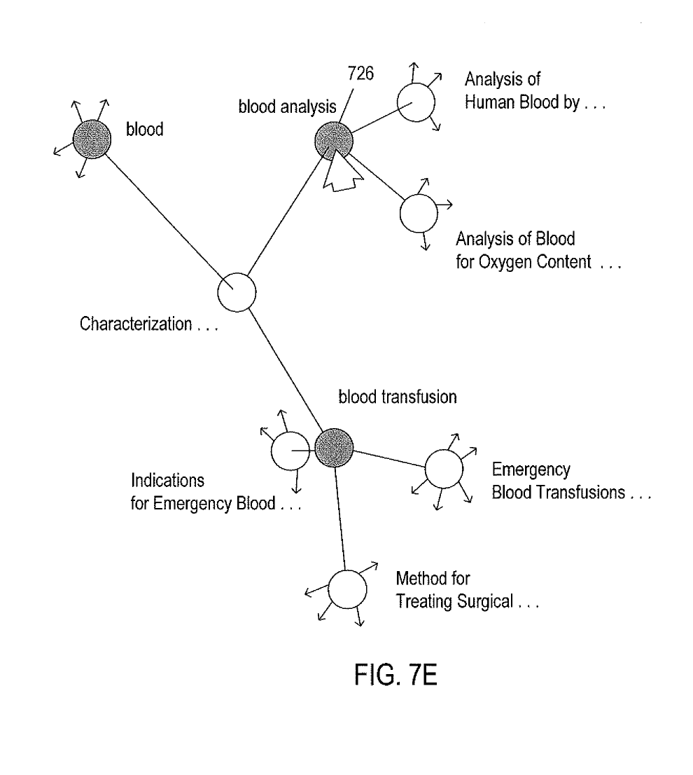

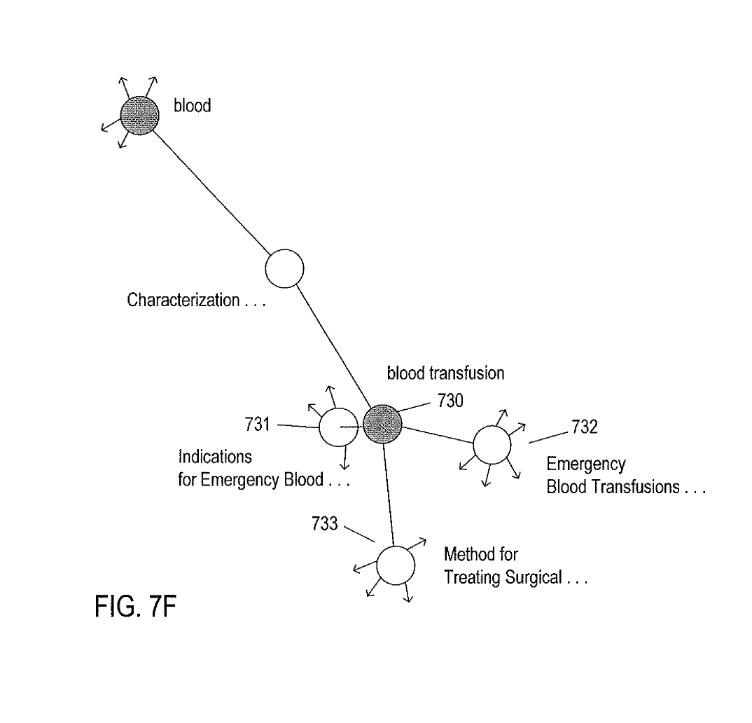

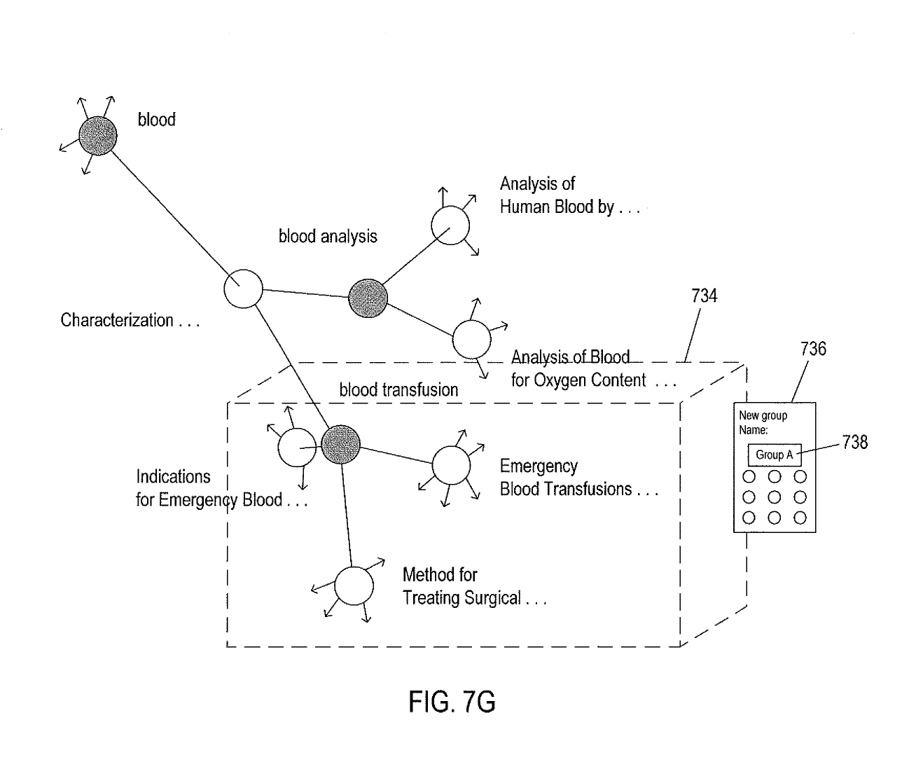

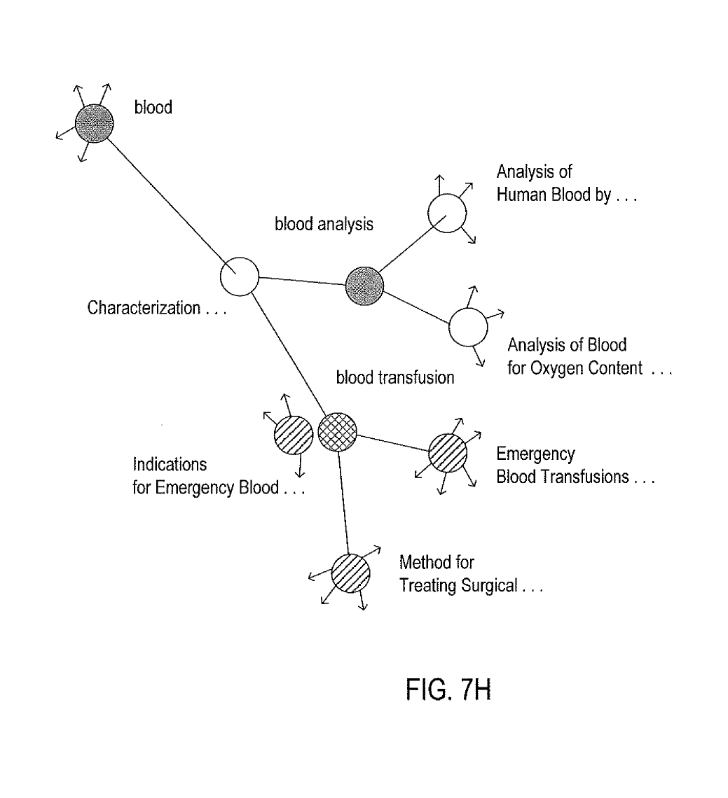

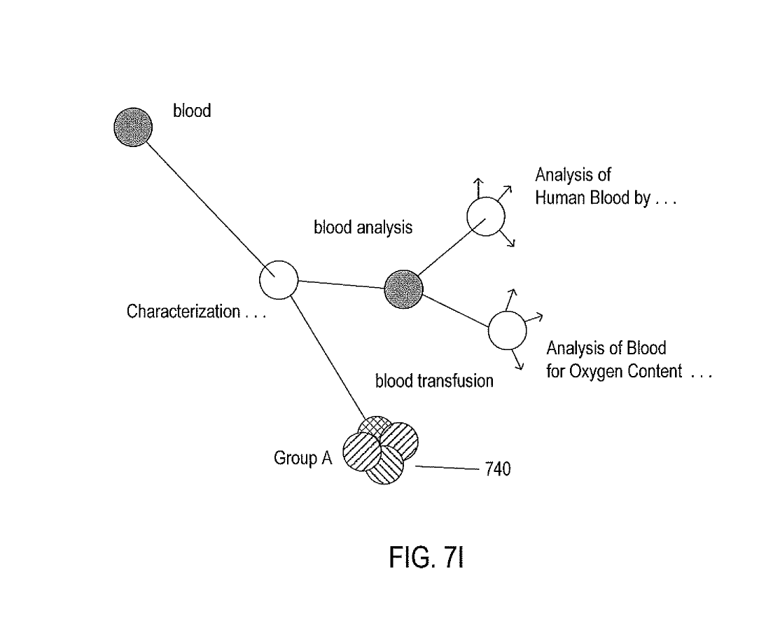

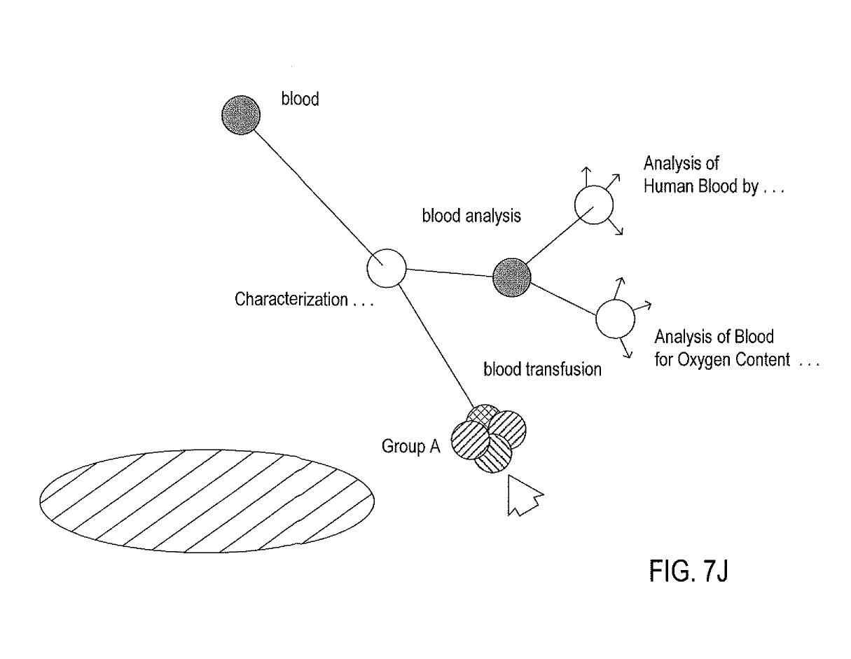

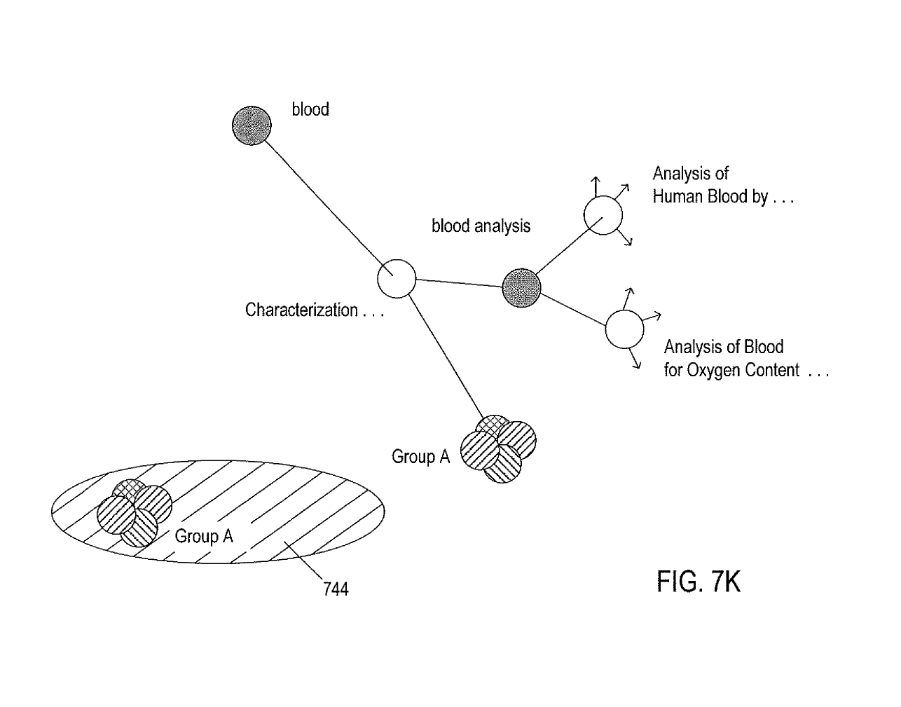

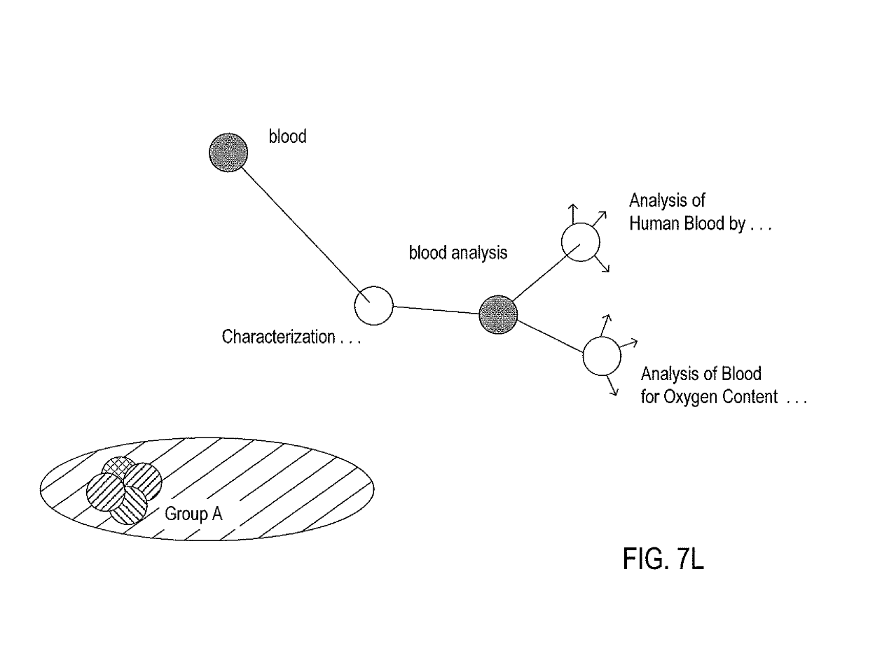

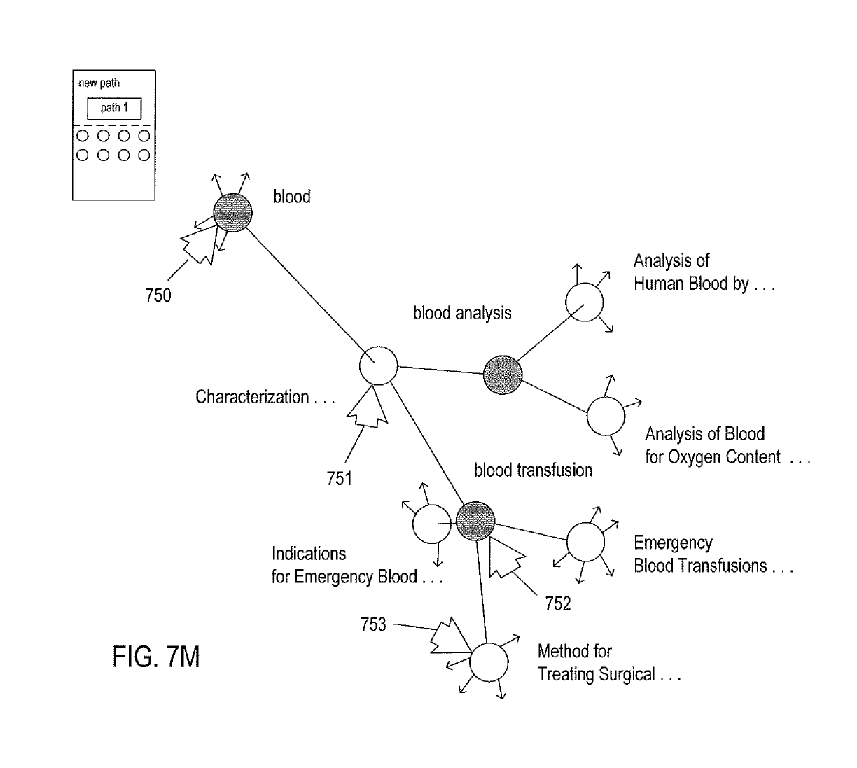

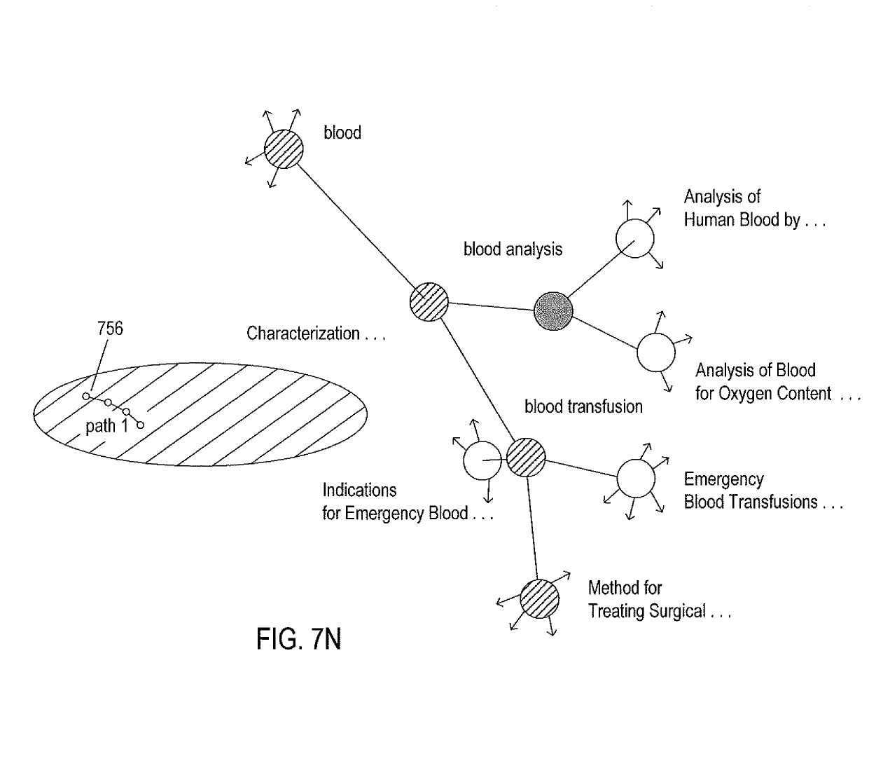

FIGS. 7A-N illustrate other types of operations and facilities made available to a user through the GUI provided by the currently disclosed methods and systems. FIG. 7A shows a small portion of a graph-like rendering of a search process and search results. Note that each node is labeled with text. Term nodes, such as term node 702, are labeled with a term or phrase that they represent. Document nodes, such as document node 704, are labeled with some initial portion of the document's title or name. A user may control whether or not labels are displayed for graph nodes. As shown in FIG. 7B, a user may position a cursor 706 over a particular node and enter user input to bring up a display 708 for the node. The display may show the full title for a document node 710, the relevance score for the document 712 with respect to a category to which the node is assigned, and various icons 714-718 which provide an interface to various operations and facilities that can be applied to the node. As shown in FIG. 7C, one such icon-represented facility, when invoked by user input 720, results in display of the actual document 722 in a scrollable window.

As shown in FIGS. 7D-E, a user may also reposition nodes in sub-trees with respect to remaining portions of a graph. In FIG. 7D, the user positions a cursor 724 over node 726 and inputs user input to the GUI that results in node 726 and the sub-tree rooted at node 726 being moved upward, shown in FIG. 7E. As shown in FIGS. 7F-I, a user may decide to group together a number of nodes, such as nodes 730-733. In order to do, as shown in FIG. 7G, the user invokes a lasso tool to create an abstract volume, shown in FIG. 7G in dashed lines 734, that includes the nodes the user wishes to group together. The dimensions and volume of this lassoed volume 734 may be changed by the user through user input. The position of the volume can also be moved by user input. An input panel 736 may be displayed to allow the user to input a name 738 for the group as well as to invoke various other group-related facilities and operations, including choosing a display color for the nodes of the group. As shown in FIG. 7H, as a result of the grouping operation, the nodes within the group may be displayed with a different color and are logically associated together by the system in an internal data structure. As shown in FIG. 7I, a user can choose to collapse the nodes of the group into a collapsed group rendering 740. As shown in FIGS. 7J-K, a user may select a group for copying into a workspace, or tray 744. Alternatively, as shown in FIG. 7L, the selected group may be removed from the graph and placed into the tray. The tray represents an internal data structure in which user-identified nodes and collections of nodes can be saved for subsequent analysis and manipulation. As shown in FIGS. 7M-N, a user may also sequentially select a sequence of nodes, indicated in FIG. 7M by cursors 750-753, and group the nodes together as a path. As shown in FIG. 7N, the user may select, using an input panel, a display color for the nodes of the path or, alternatively, for the links that link the nodes of the path, and may copy a path to the tray 756. Other tools provided by the GUI allow users to alter the colors and sizes of nodes and links and to add various types of user-defined annotations and elements to a graph.

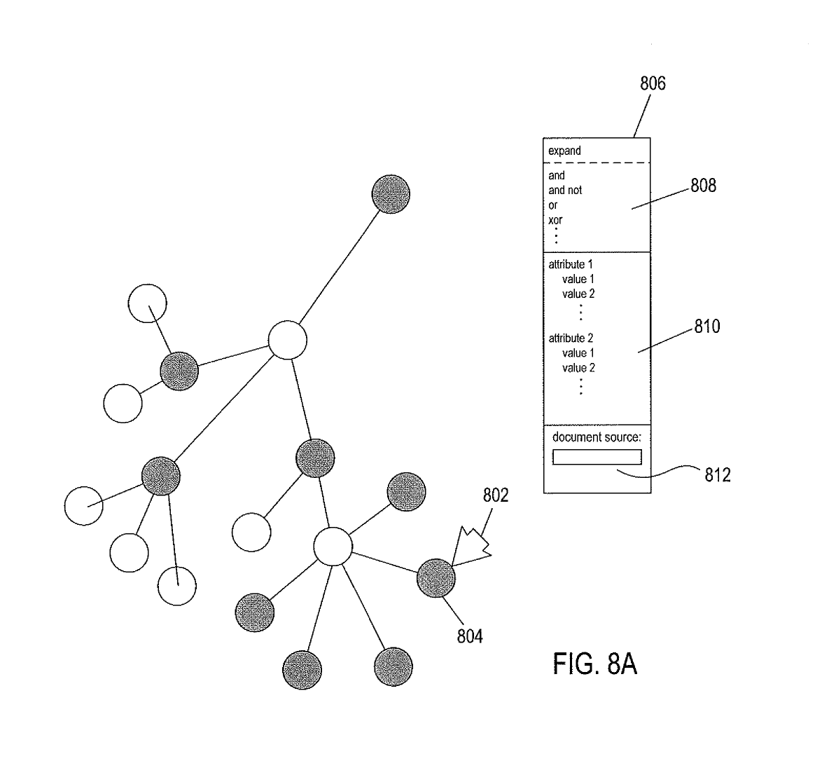

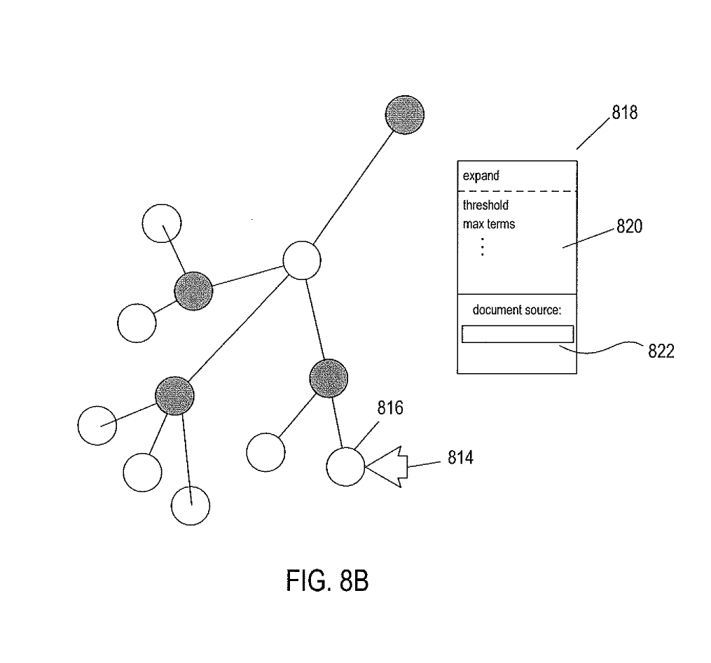

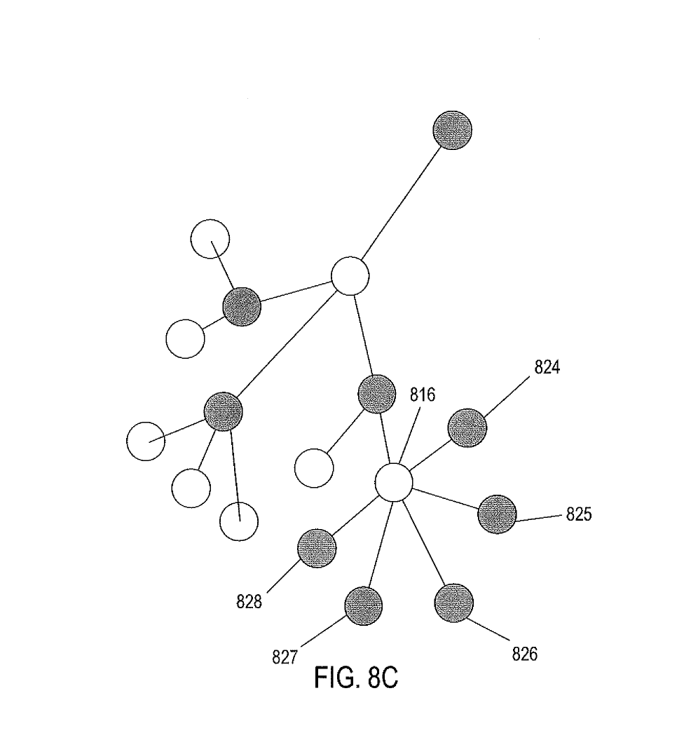

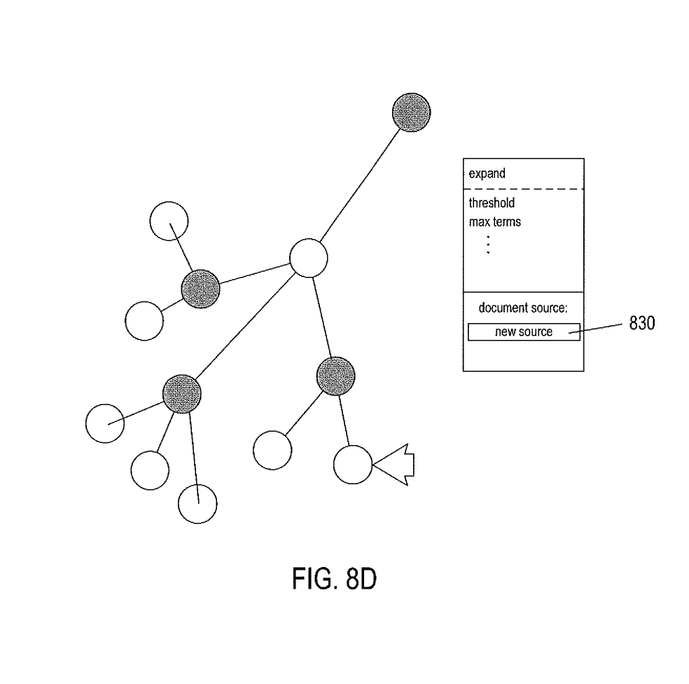

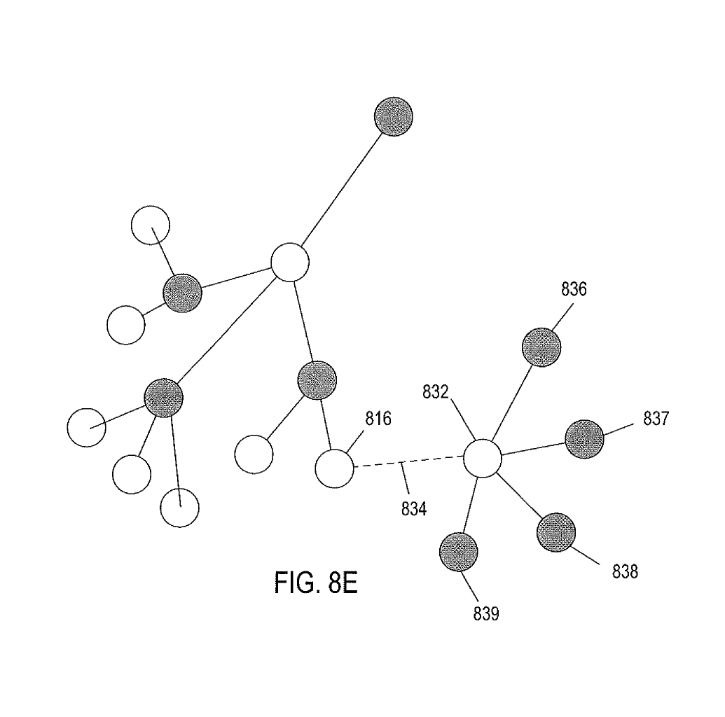

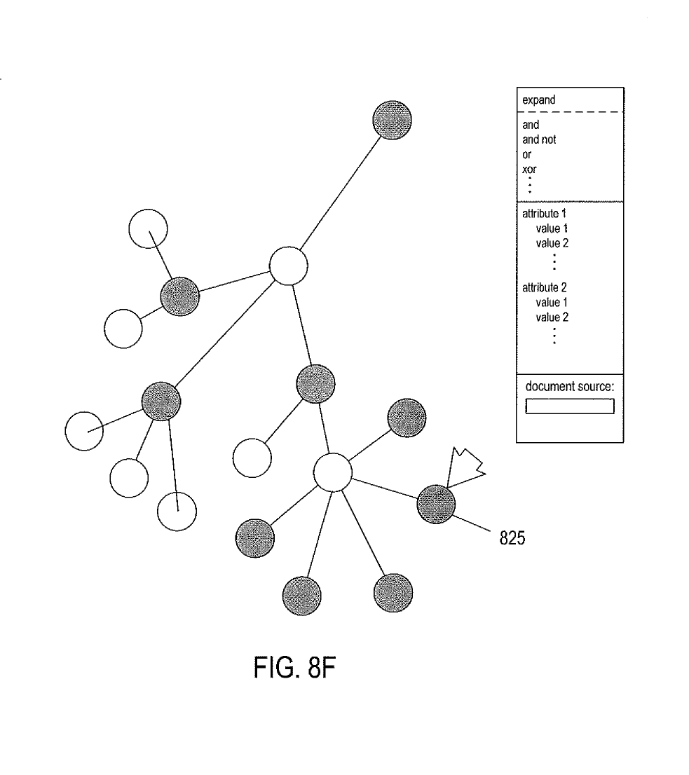

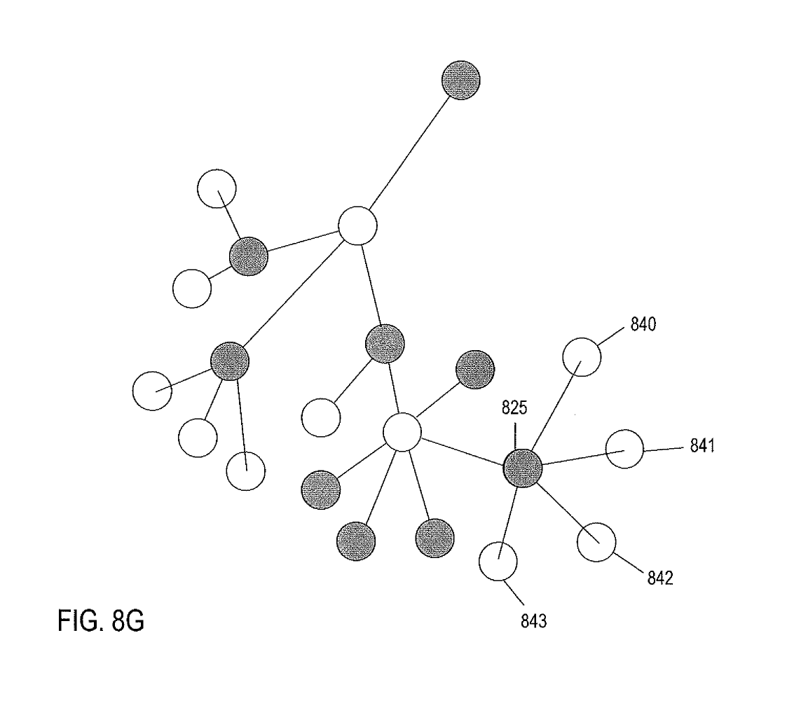

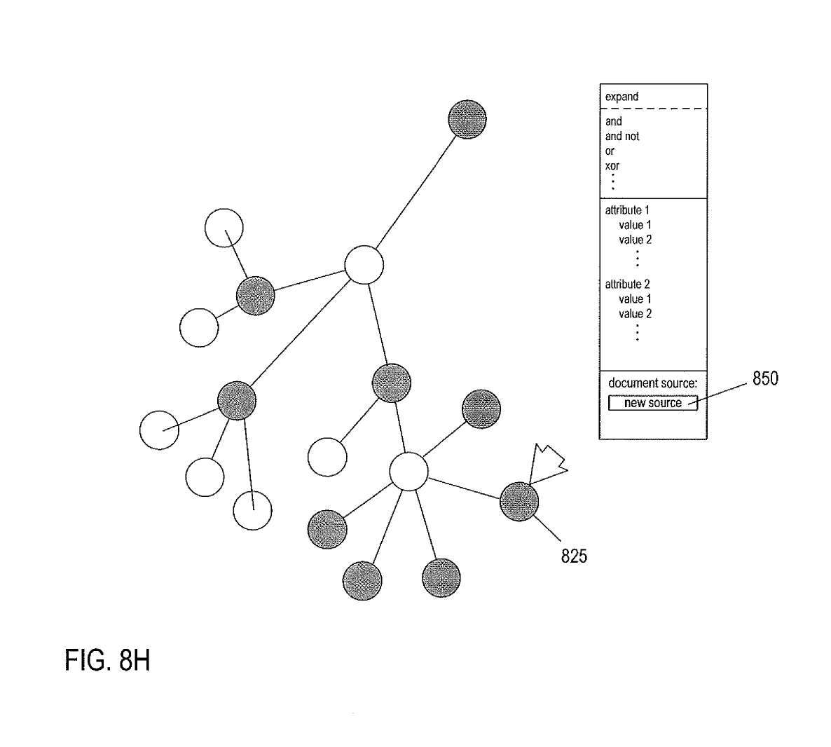

FIGS. 8A-I illustrate additional operations available to a user of the currently described method and system for manipulation of graph-like representations of search processes and search results. As shown in FIG. 8A, a user can position a cursor 802 onto a term node 804 and input user input to the GUI in order for the GUI to display an input panel 806 to allow the user to expand the node, adding additional search results to the search results currently represented by the graph. The display panel 806 may include a selection of a Boolean operation from among multiple Boolean operations 808 and may allow a user to select particular values of various types of attributes 810 in order to direct the search used to expand the node. The display panel 806 may also allow a user to input the name of a different document source for the expansion search 812. Similarly, as shown in FIG. 8B, the user can position a cursor 814 to select a particular document node 816 in order for the GUI to display a display panel 818 to allow the user to select any of various parameters 820 for expansion of the document node. Document-node expansion involves analysis of the document with respect to characteristic terms for the document source and/or other information to select new characteristic terms for the document. The display panel 818 may also allow the user to expand the document node with respect to a different document source, the name of which may be entered in a text-input window 822. As shown in FIG. 8C, when the user elects not to expand the document node with respect to a different document source, new characteristic terms 824-828 identified for the document are represented by new term nodes 824-828 linked to the document node 816 that is expanded. As shown in FIG. 8D, when the user specifies a new document source for a document-node expansion 830, the document node is bifurcated, as shown in FIG. 8E, to produce a copy of the document node 832 linked to the original document node 816 by a source-change link 834 and the copy document node 832 is expanded with new term nodes 836-839 selected with respect to the new document source. Similarly, as shown in FIG. 8F, expansion of a term node 825 without specifying a new document source results in new document nodes 840-843 selected from the same document source with respect to which the term node was generated, as shown in FIG. 8G. However, as shown in FIG. 8H, when the user specifies a new document source 850 in a term-node expansion, a copy of the term node is generated 852, shown in FIG. 8I, and linked to the original term node 825 via a source-change link 854 and the copy term node 852 is expanded to generate new document nodes 856-858 corresponding to documents selected from the new document source. These are but a few of the different types of graph-expansion operations available to a user through the GUI provided by the currently described methods and systems. Of course, any particular node expansion may generate 0, 1, or multiple expansion nodes. The illustrations and examples used in this discussion show only small numbers of expansion nodes, for sake of clarity.

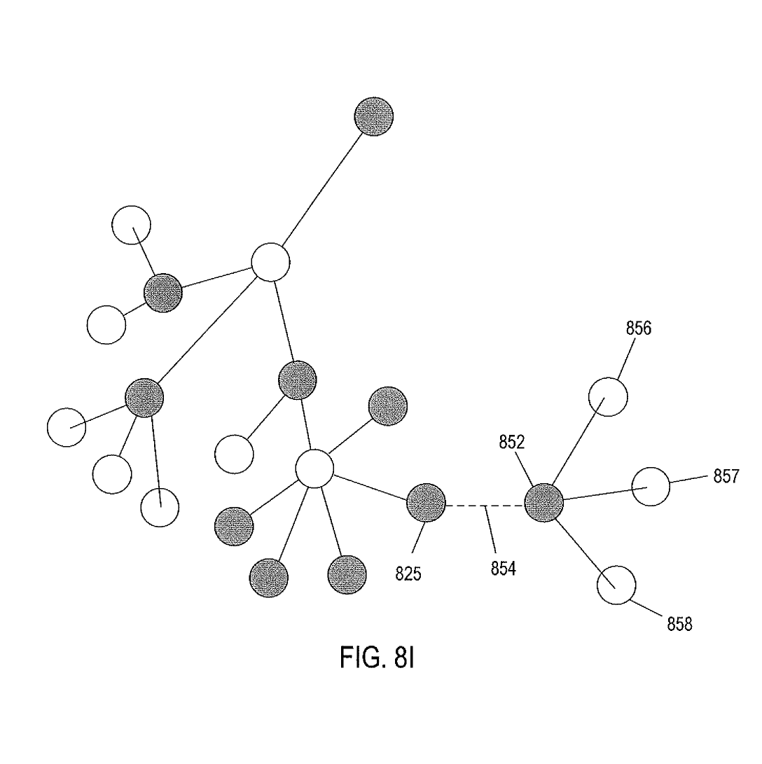

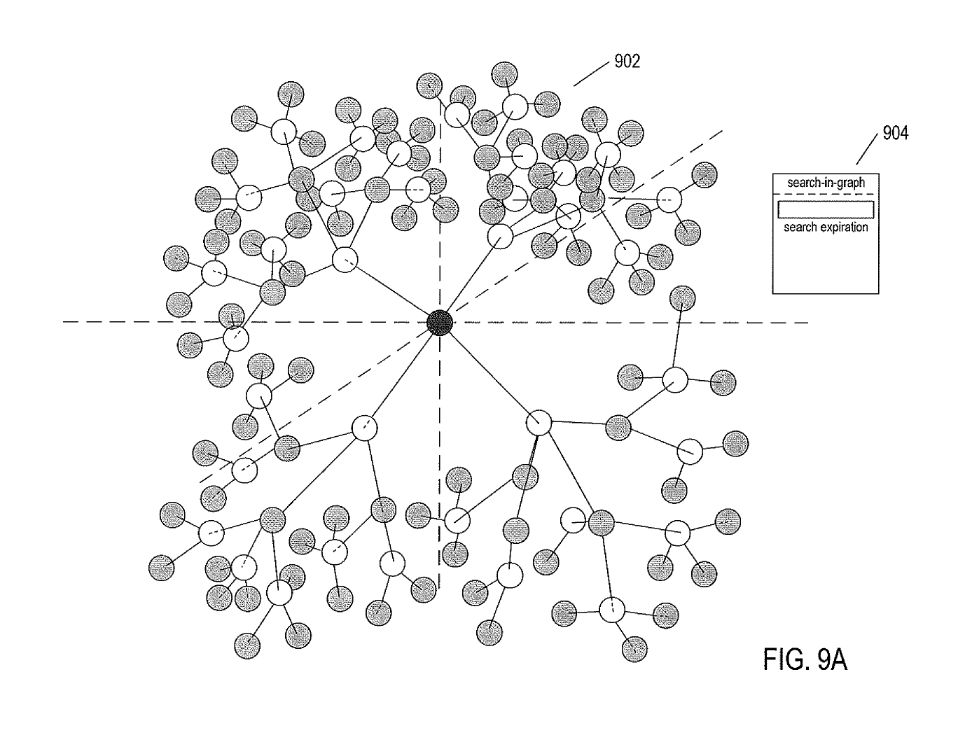

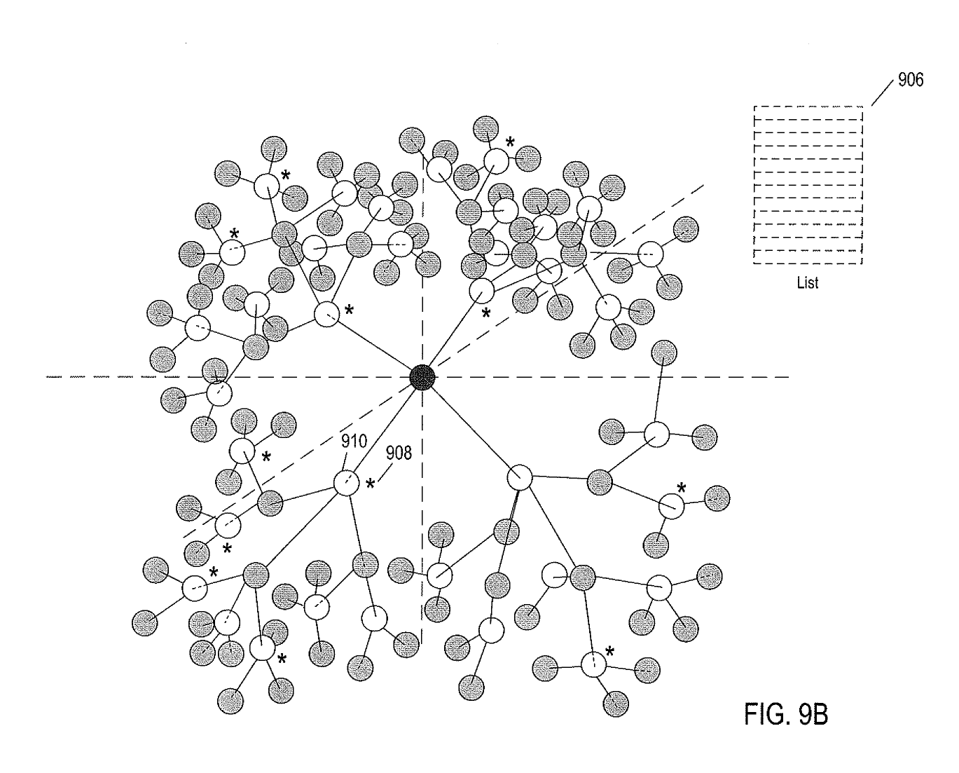

FIGS. 9A-B illustrate a search-in-graph operation provided by the currently described methods and systems. In FIG. 9A, a small three-dimensional graph-like rendering of a search process and search results 902 is currently displayed by the GUI provided by the currently discussed methods and systems. The user has provided to the GUI user input which requests the search-in-graph operation. In response, the GUI displays an input panel 904 which allows the user to input a search expression, such as a term or multiple terms connected by Boolean operators. The search-in-graph functionality results in carrying out a next search only on those documents represented by document nodes in the current graph. As shown in FIG. 9B, the results of the search-in-graph search, specified in FIG. 9A, are stored in an internal list data structure 906. In FIG. 9B, those nodes that form the result set for the search-in-graph search are shown associated with asterisks, such as asterisk 908 associated with document node 910. There are a variety of ways that these types of internally stored lists can be used.

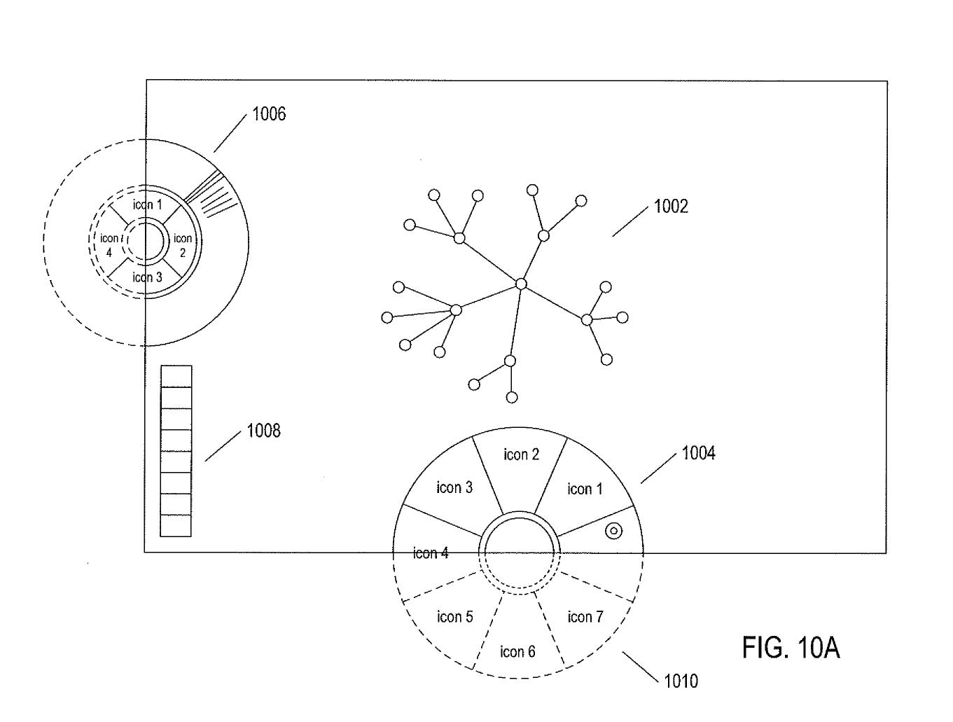

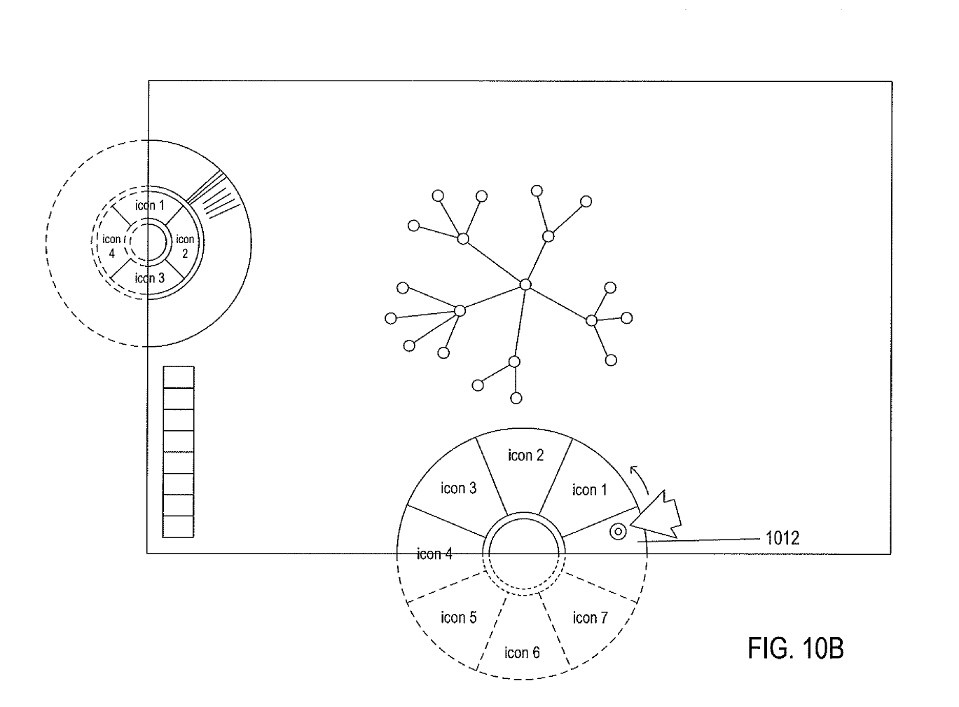

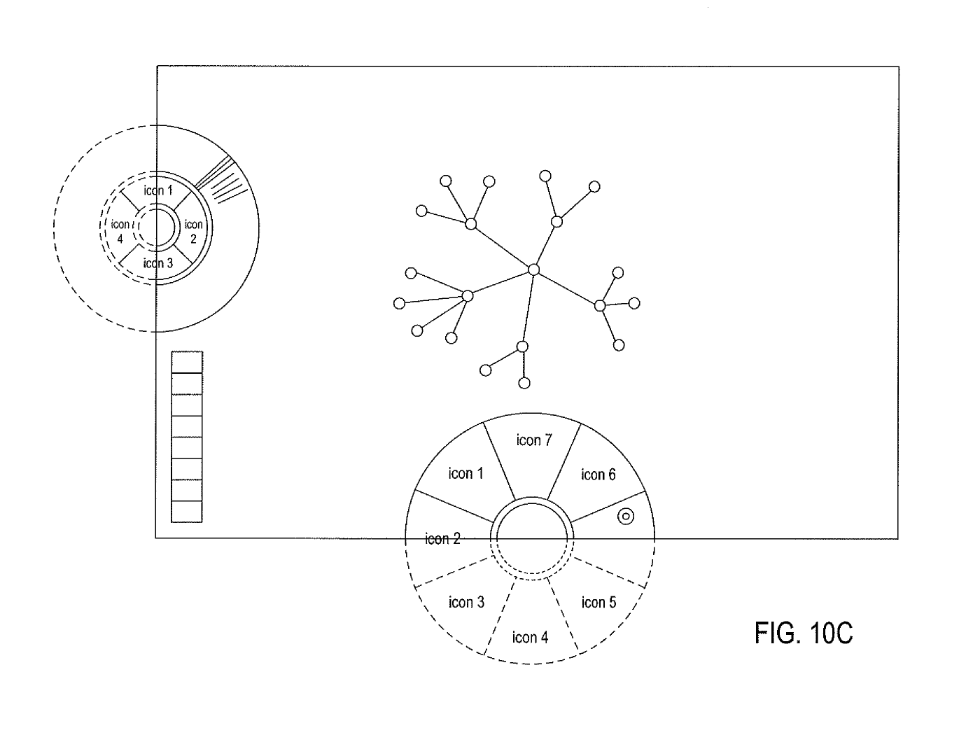

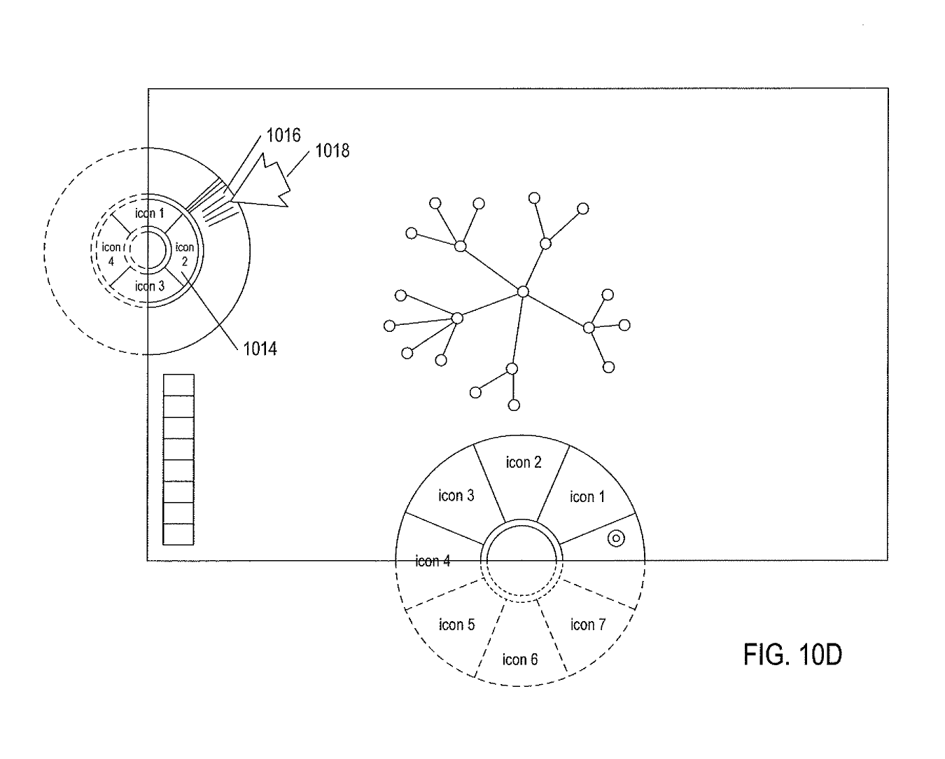

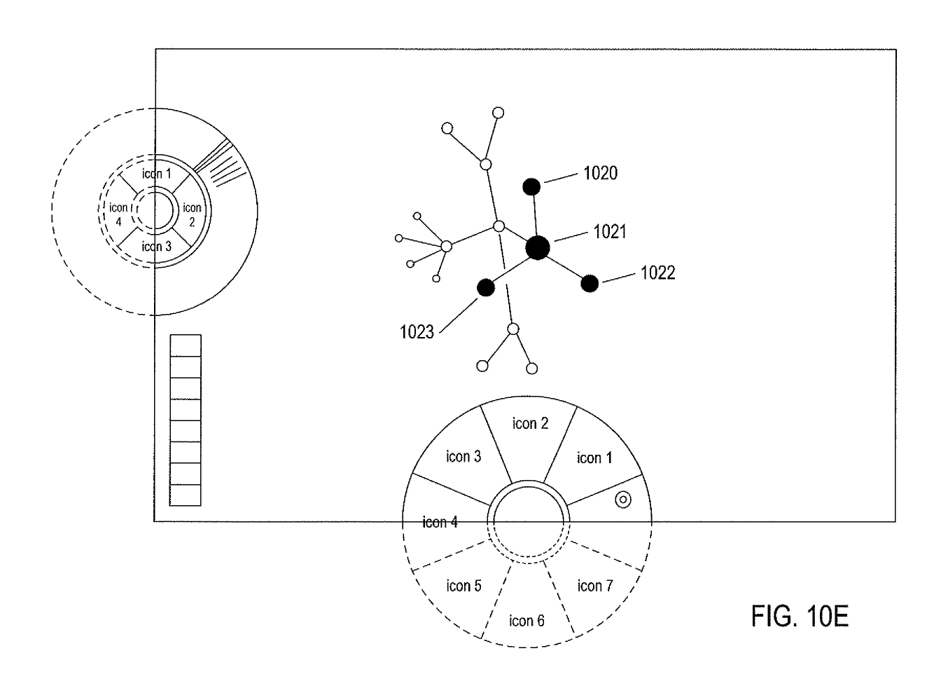

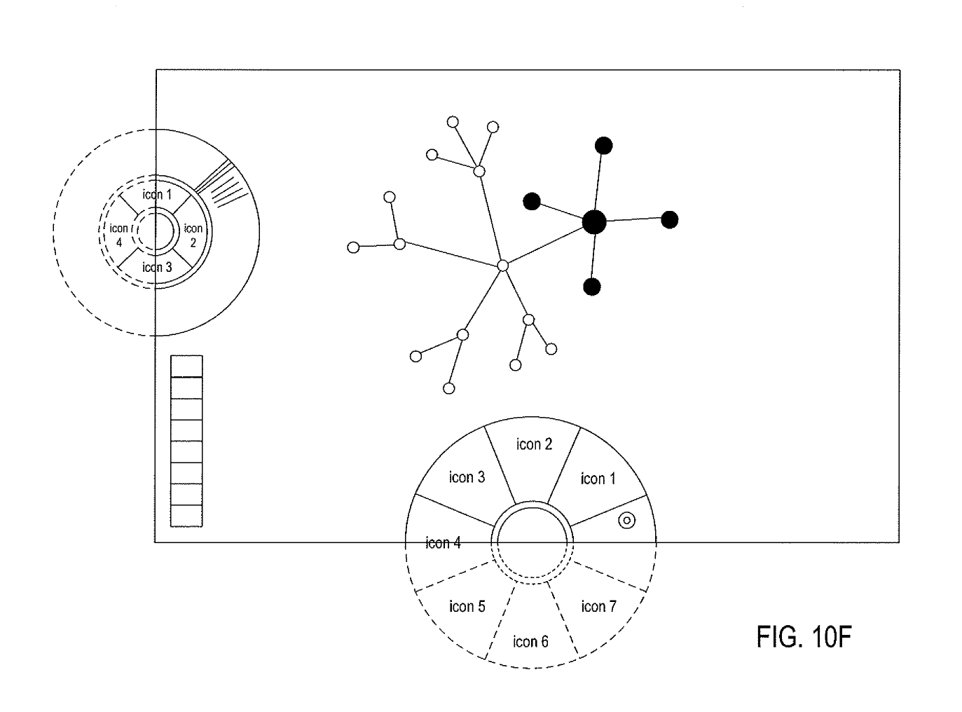

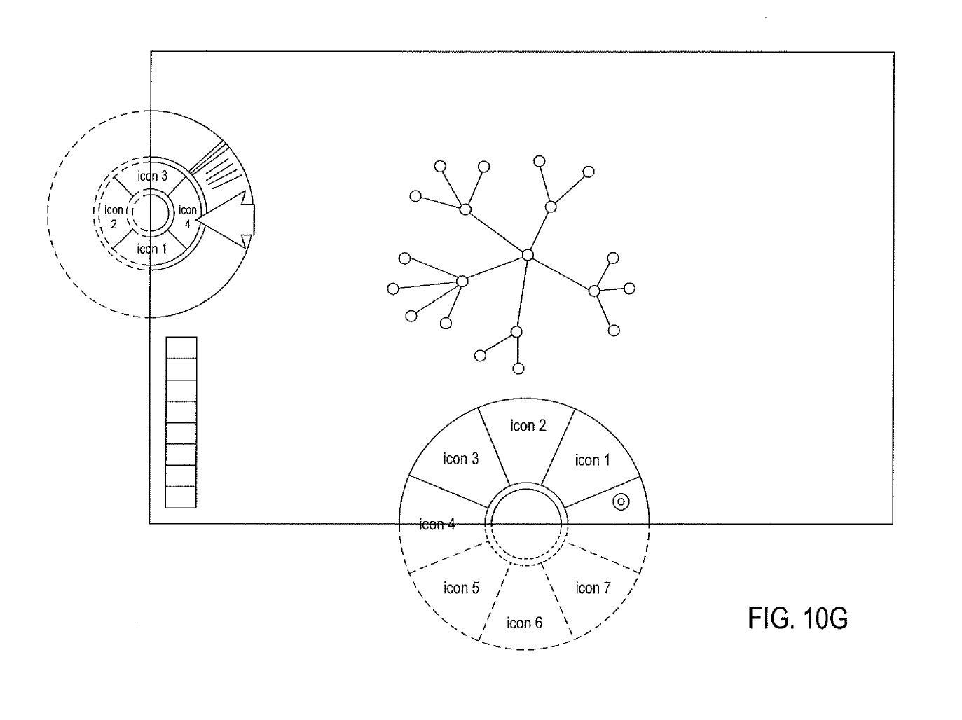

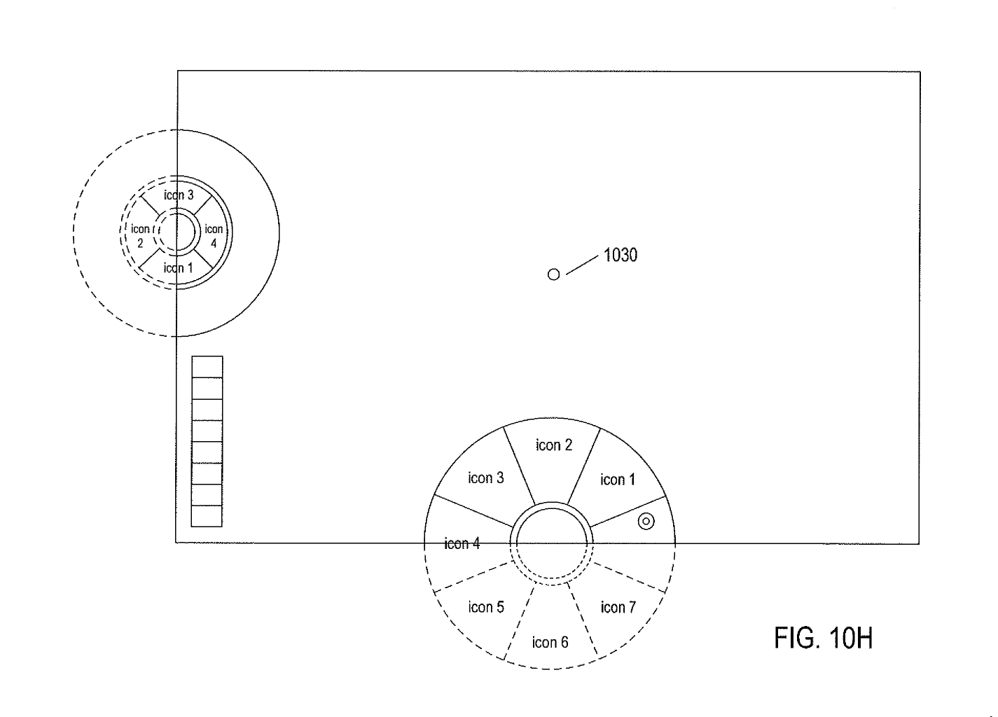

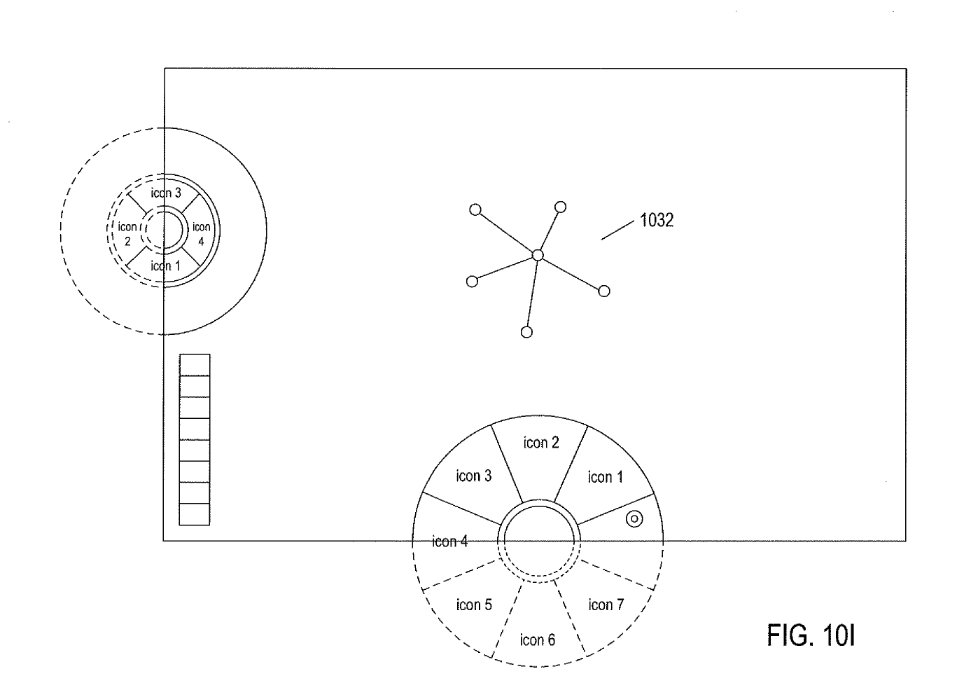

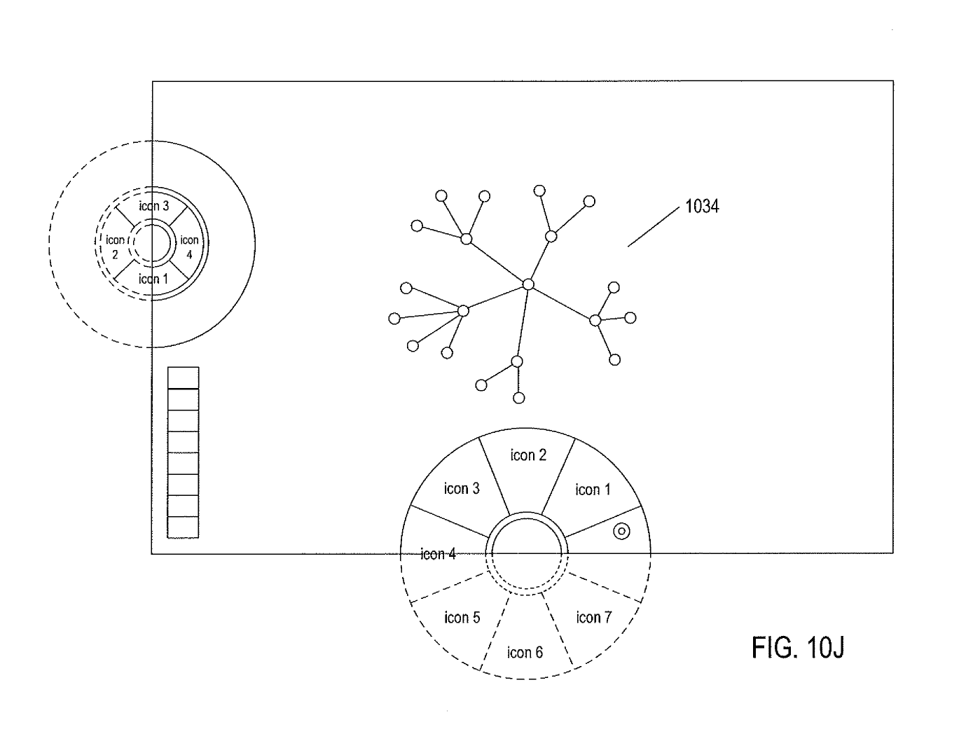

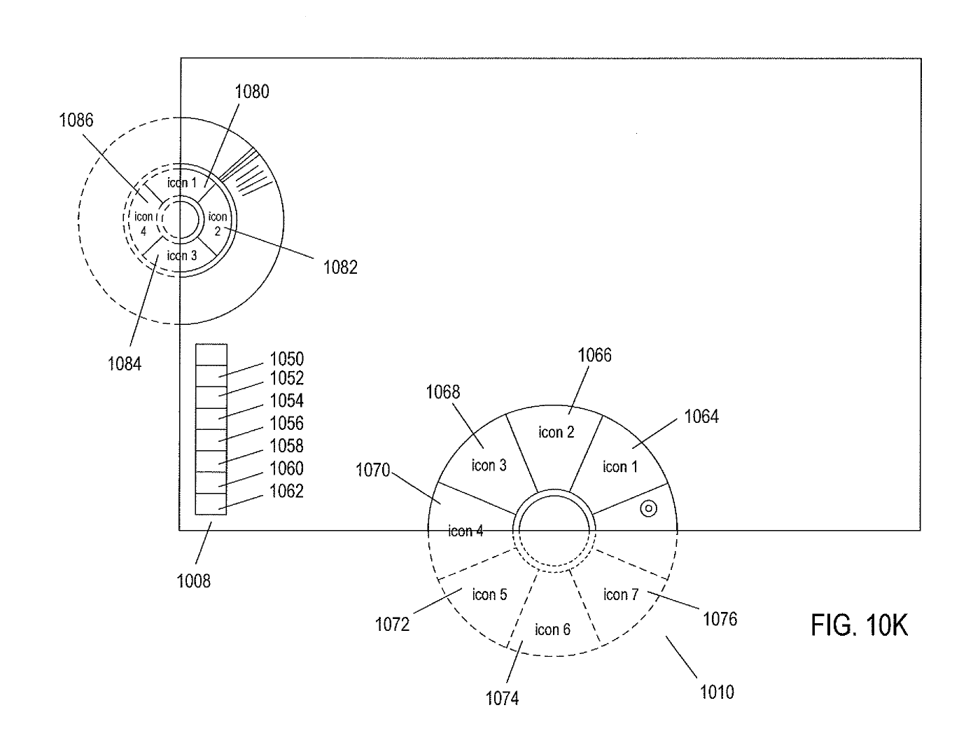

FIGS. 10A-K illustrate additional features of the GUI provided by the currently discussed methods and systems. As shown in FIG. 10A, the GUI generally displays a representation of a search process and search results, such as a graph-like representation 1002 and, in addition, may display various selection devices 1004, 1006, and 1008 that allow a user to find and select various operations, utilities, and features. A main-menu selection wheel 1004 may be displayed at the bottom of the display. The upper portion of the main-menu selection wheel is displayed to the user, while the lower portion 1010, illustrated using dashed lines, is not displayed, but is assumed to be logically present. The locator-menu display wheel 1006 is similarly displayed, with a right-hand portion displayed to the user and a left-hand portion not displayed, but assumed to be logically present. A column of icons 1008 is additionally provided to allow the user to select various types of features, functionalities, and utilities. As shown in FIG. 10B, user input to a special sector 1012 of the main-menu selection wheel causes, as shown in FIG. 10C, the selection wheel to rotate logically, resulting in display of a different portion of the main-menu selection wheel to the user. The locator-menu selection wheel 1006 operates similarly. The locator-menu selection wheel provides numerous different functions to facilitate location of particular nodes and groups of nodes within a graph-like representation of a search process and search results. For example, as shown in FIG. 10D, input to one of the inner-wheel icons, such as inner-wheel icon 1014, may result in the display of various groups of nodes in the outer wheel 1016. User selection of one of these groups, as represented by cursor 1018, results, as shown in FIG. 10E, in the system rotating, scaling, and/or translating the graph-like representation in order to position the selected group of nodes in a logical z position close to the user and in a way that the group is prominently displayed to the user. In certain implementations, this may involve changing the color, size, or other display properties of the selected node group. In FIG. 10E, the selected group of nodes 1020-1023 are shaded. When a user selects multiple groups for location and display, the GUI may rotate, scale, and/or translate the graph to display a first selected group, as shown in FIG. 10E, and then after a short period of time, may again rotate, scale, and/or translate the graph to display a second selected group, as shown in FIG. 10F. An arbitrary number of selected groups can be sequentially displayed in this fashion. Selection of another of the inner-wheel icons, shown in FIG. 10G, may invoke a historical replay function that replays the search process which generated a particular graph-like representation. As shown in FIGS. 10H-J, this function first displays the original search term 1030, shown in FIG. 10H, then carries out an initial expansion of the initial search term 1032, as shown in FIG. 10I, and then carries out a next expansion 1034, as shown in FIG. 10J. The replay function may, in addition to replaying a sequence of expansions, replay a variety of other operations carried out by a user, including local expansions, alternation of the positions and relative arrangements of nodes, insertion of user-defined links between nodes, rotations, scaling, and translations, group and path selections, and many other such operations.

FIG. 10K illustrates a user-selection-icon layout used in one implementation of the currently described methods and systems. The column of icons 1008 includes: (1) an icon 1050 that, when selected by a user, results in display of a variety of different navigation tools that a user can use to manually navigate within a graph; (2) an icon that, when selected by a user, undoes the last completed operation 1052; (3) an icon 1054 that, when selected by a user, provides an eraser tool to allow for nodes to be deleted from a graph; (4) an icon that, when selected by a user, invokes various different types of expansion functionalities 1056, described above; (5) an icon 1058 that, when selected by a user, invokes the lasso operation for defining groups, described above; (6) an icon 1060 that, when selected by a user, invokes a path-definition utility for defining paths through the graph, as described above; and (7) an icon 1062 that, when selected by a user, invokes the search-in-graph functionality, described above. The main-menu selection wheel 1010 includes the following icons: (1) an icon 1064 that, when selected by a user, invokes the locator-menu selection wheel; (2) an icon 1066 that, when selected by a user, invokes a new search and display of a new graph-like representation of the search process and search results; (3) an icon 1068 that, when selected by a user, toggles between three-dimensional and two-dimensional representations of the search process and search results; (4) an icon 1070 that, when selected by a user, invokes a heat-map representation of a search results, described below; (5) an icon 1072 that, when selected by a user, toggles between displaying and not displaying titles for nodes, as discussed above; (6) an icon 1074 that, when selected by a user, invokes a help utility; and (7) an icon 1076 that, when selected by a user, invokes an aggregation utility that can aggregate the outer level of leaf nodes in order to facilitate viewing lower-level layers of nodes in a displayed graph. The inner wheel of the locator-menu selection wheel includes the following icons: (1) an icon that, when selected by a user, invokes selection of groups and/or paths for automated navigation 1080; (2) an icon 1082 that, when selected by a user, invokes a utility for selection of document categories for automatic navigation; (3) an icon 1084 that, when selected by a user, selects attribute-value-based node location; and (4) an icon 1086 that, when selected by a user, provides for automatic navigation to nodes representing added terms in sequential searching. Various implementations include different mappings of functionality invocation to icons and additional displayed selection devices for selecting operations, utilities, and functions.

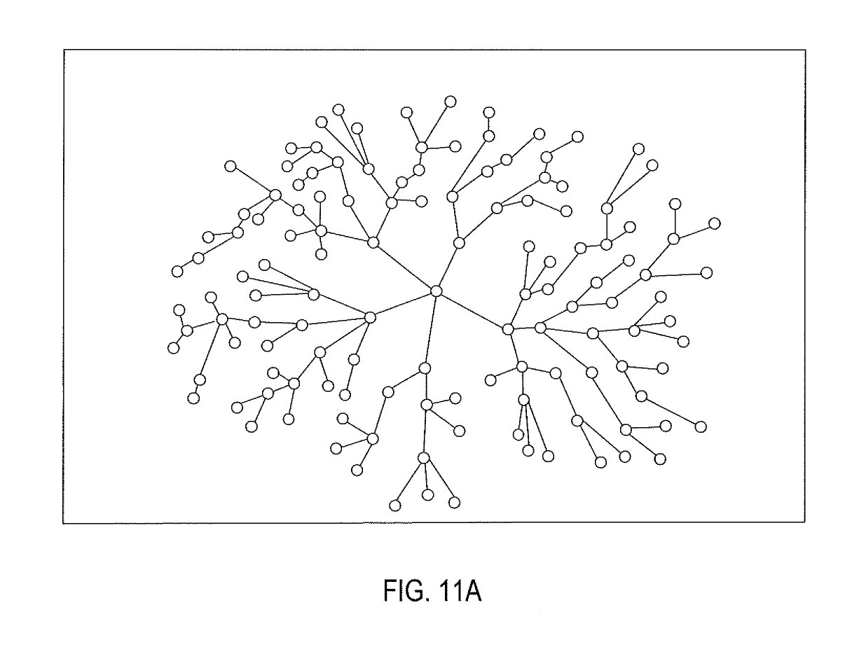

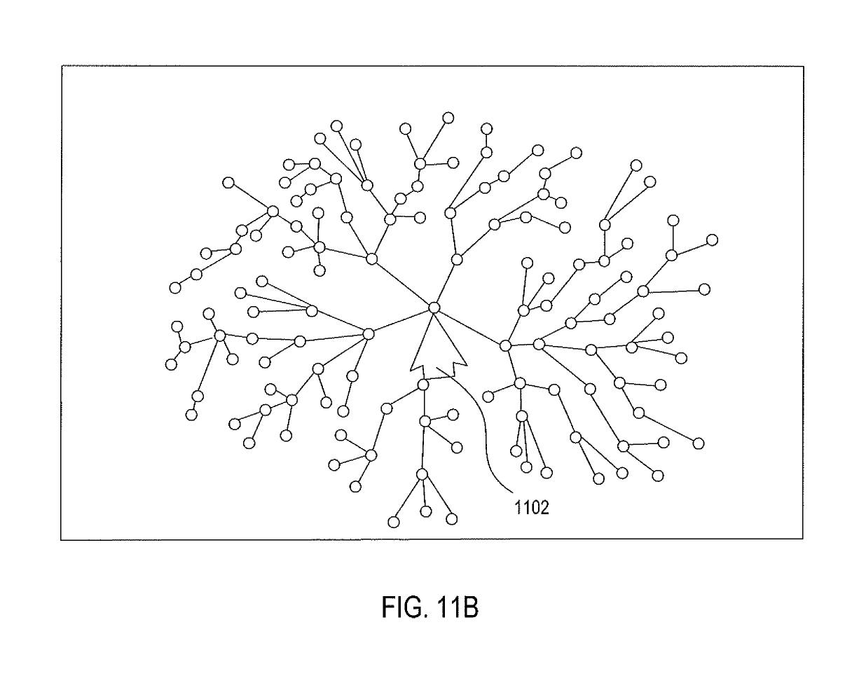

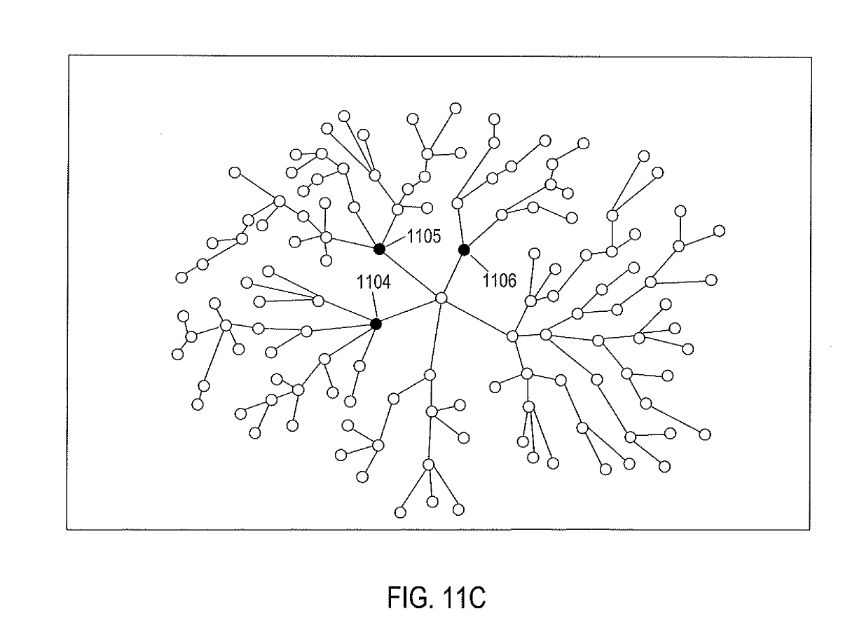

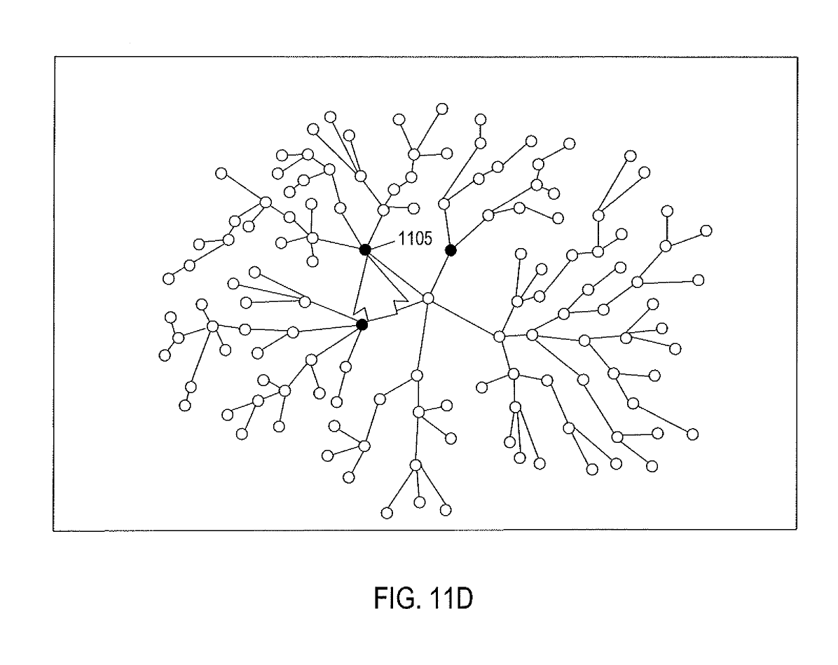

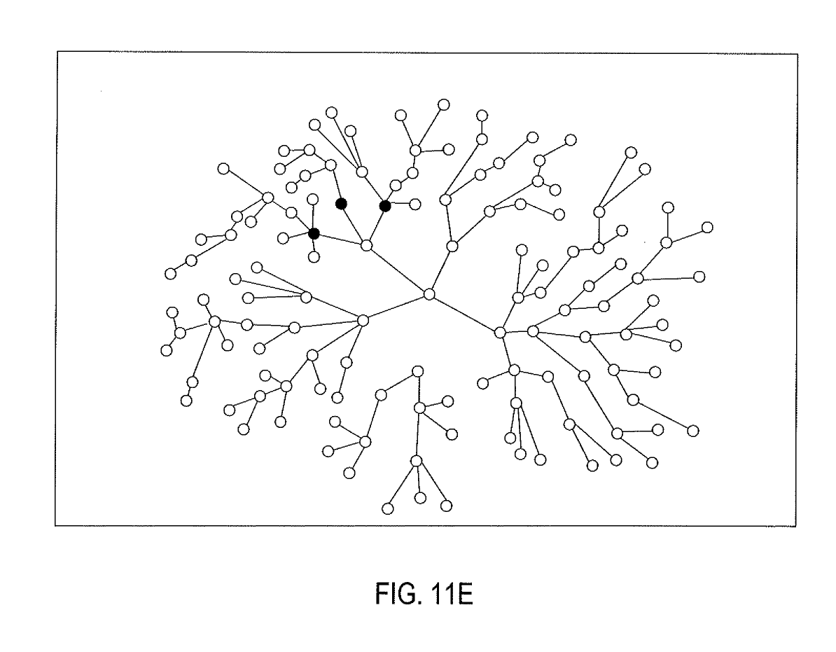

FIGS. 11A-E illustrate one navigation tool provided by the GUI that is, in turn, provided by the currently discussed methods and systems. In FIG. 1 IA, a small graph-like representation of a search process search results is display on an electronic display device through the GUI. When, as shown in FIG. 11B, the user selects a particular node from which to begin navigation, as represented by cursor 1102, the navigation tool illuminates, or changes the color of, nodes connected to the selected node, as shown in FIG. 11C. In FIG. 11C, nodes 1104-1106 are displayed in a different color to indicate that they are possible continuations of paths that can be constructed from a current node according to user-specified criteria. When, as shown in FIG. 11D, the user selects one of these highlighted nodes 1105, the navigation tool highlights a next set of nodes that represent a next level of continuation along paths corresponding to the user-provided path criteria. In certain implementations, two or more subsequent node levels may be illuminated by the navigation tool. In essence, this navigation tool acts like a flashlight to assist a user in traversing potential paths through the graph.

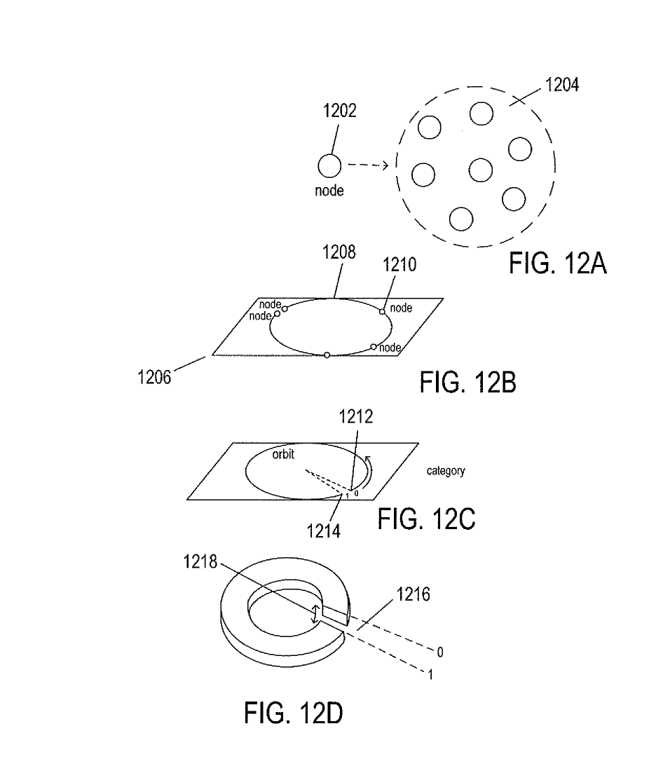

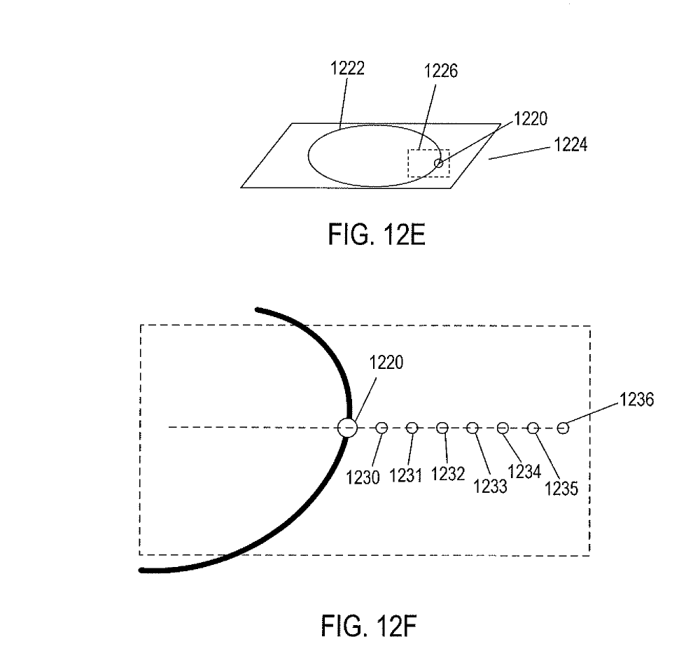

In addition to the graph-like representation of search processes and search results, the currently described methods and systems provide for alternative display modes. The first alternative method is referred to as the “stack method.” FIGS. 12A-F illustrate certain elements of a stack-mode display. The first element, shown in FIG. 12A, is a node 1202 which may represent a single document node or a group of document nodes 1204. The next element, shown in FIG. 12B, is a dimension plane 1206 which includes an orbit 1208 along which nodes are positioned, such as node 1210. A dimension plane gathers nodes representing documents that have been assigned to a particular category. The position of the nodes along the orbit reflects the computed relevance of the documents corresponding to the nodes with respect to the category. As shown in FIG. 12C, a starting point 1212 of an orbit may correspond to a relevance of 0.0 and a final point along the orbit 1214 may correspond to a relevance of 1.0. The orbit is displayed as a broken helical segment with a very shallow pitch. There is a gap, shown in FIG. 12D, 1216 that separates the two ends of the orbit and the two ends are vertically displaced 1218 from one another. As discussed above, a node may correspond to a group or collection of document nodes. When a stack is displayed, a user may zoom in on a node within an orbit. Past a particular threshold zoom level, a node representing a collection of document nodes may be radially expanded outward, from the collection node, to show the individual nodes within the collection node. In FIG. 12E, a collection node 1220 is shown positioned on the orbit 1222 of a dimension plane 1224. When the region outlined with dashed lines 1226 is magnified by a zoom-in operation, as shown in FIG. 12F, the collection node 1220 is radially expanded to show the individual document nodes 1230-1236 that together comprise the collection node 1220.

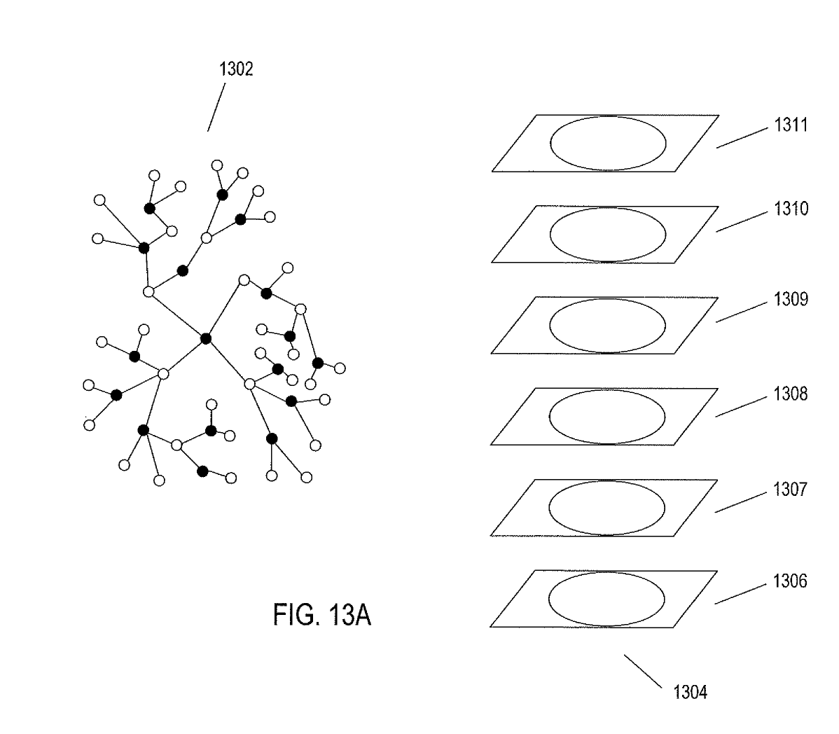

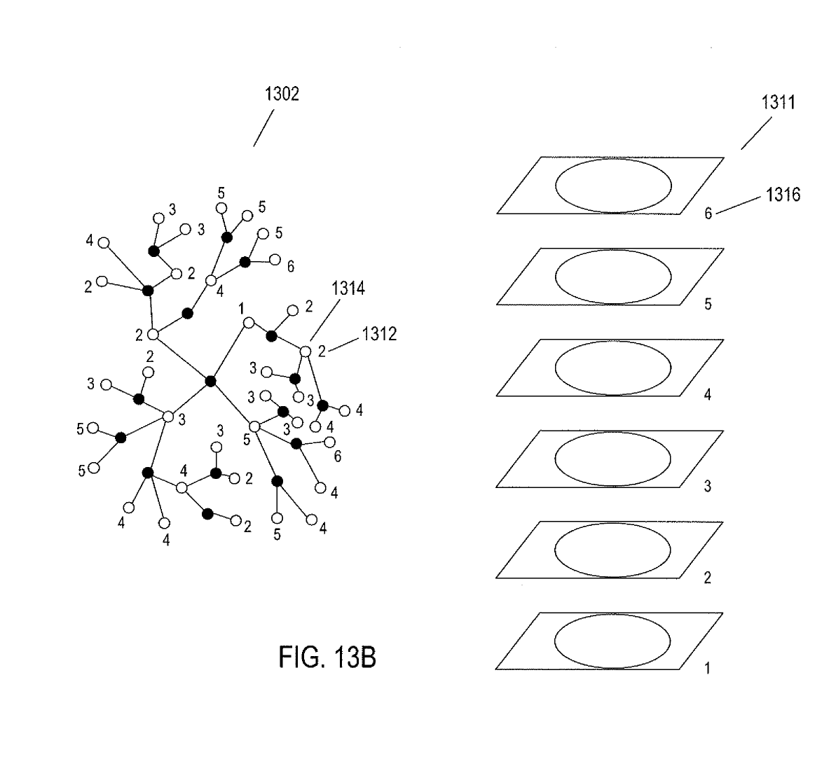

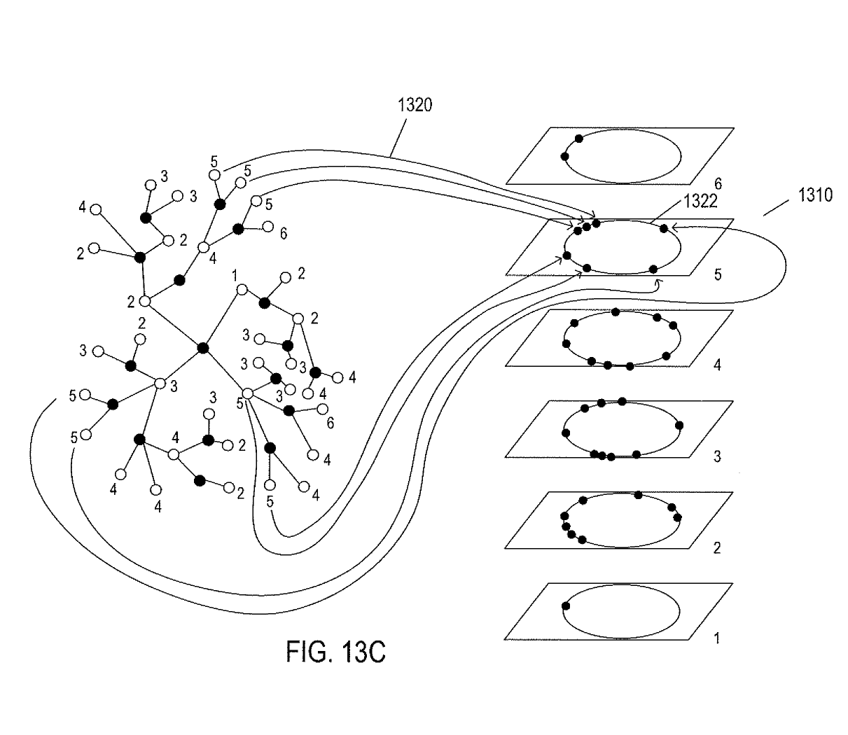

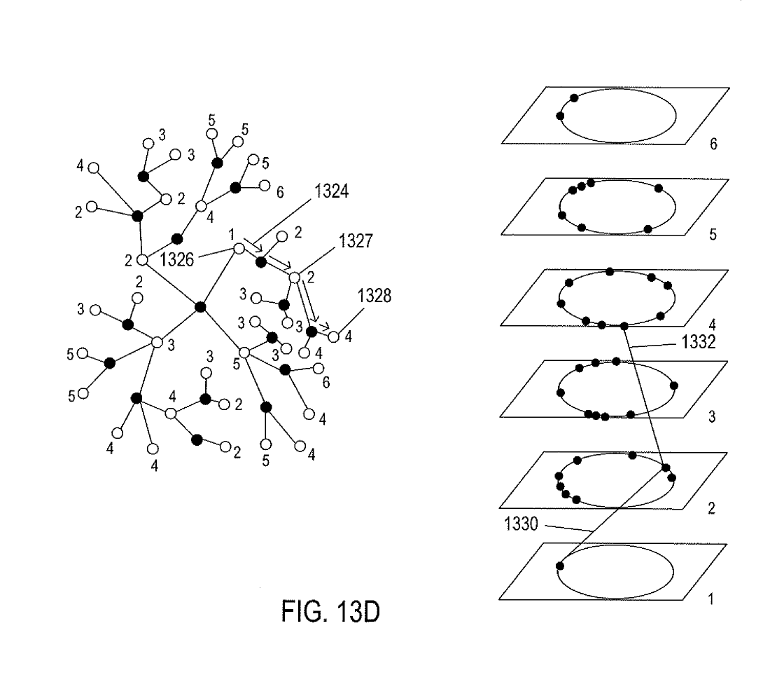

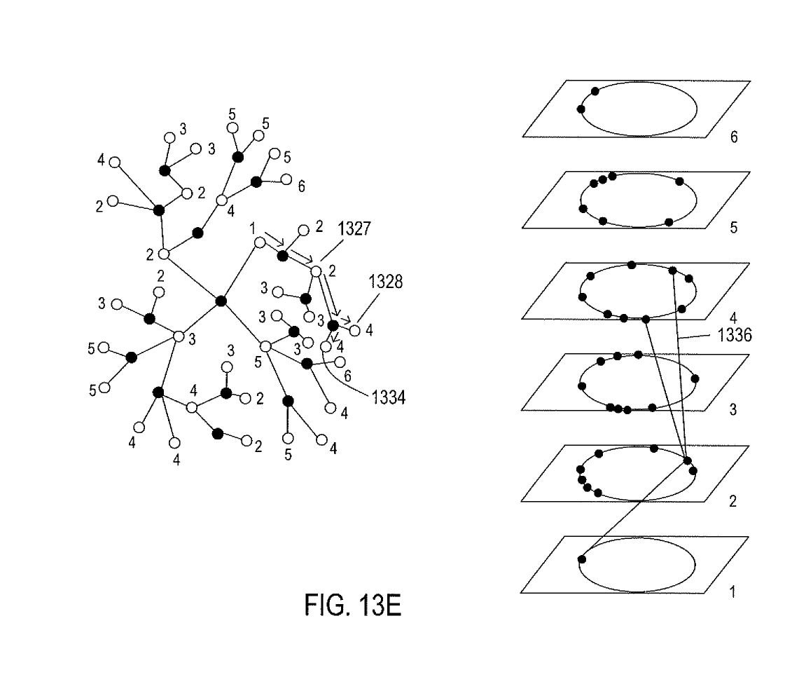

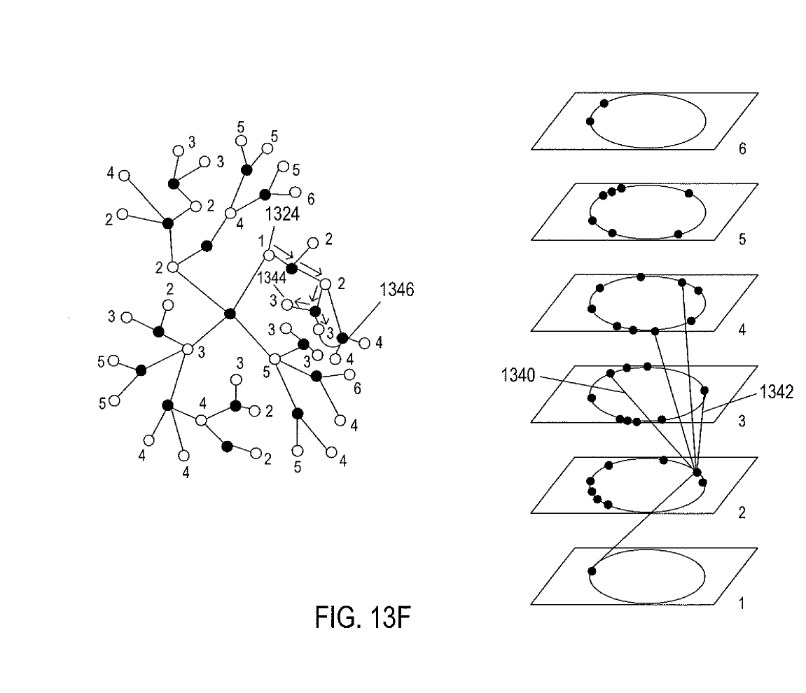

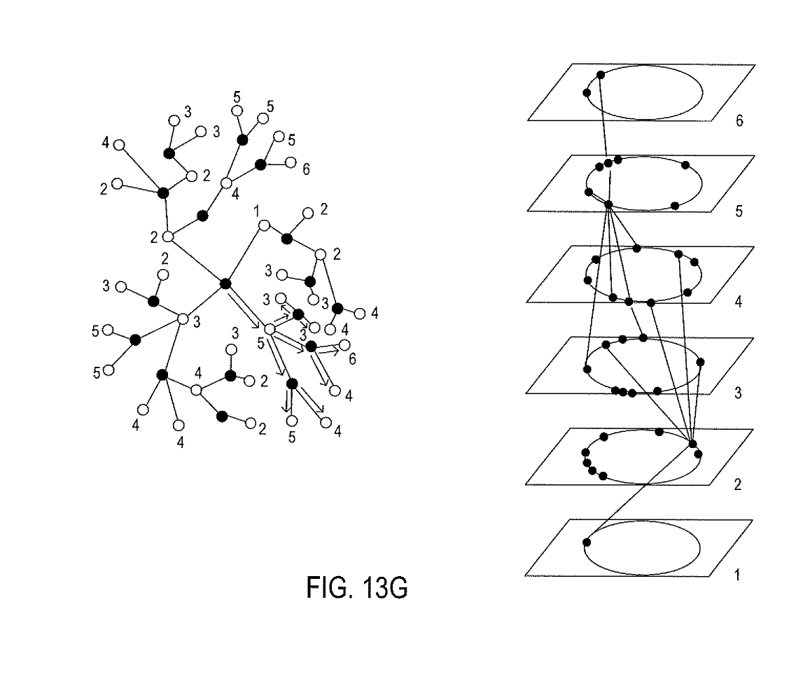

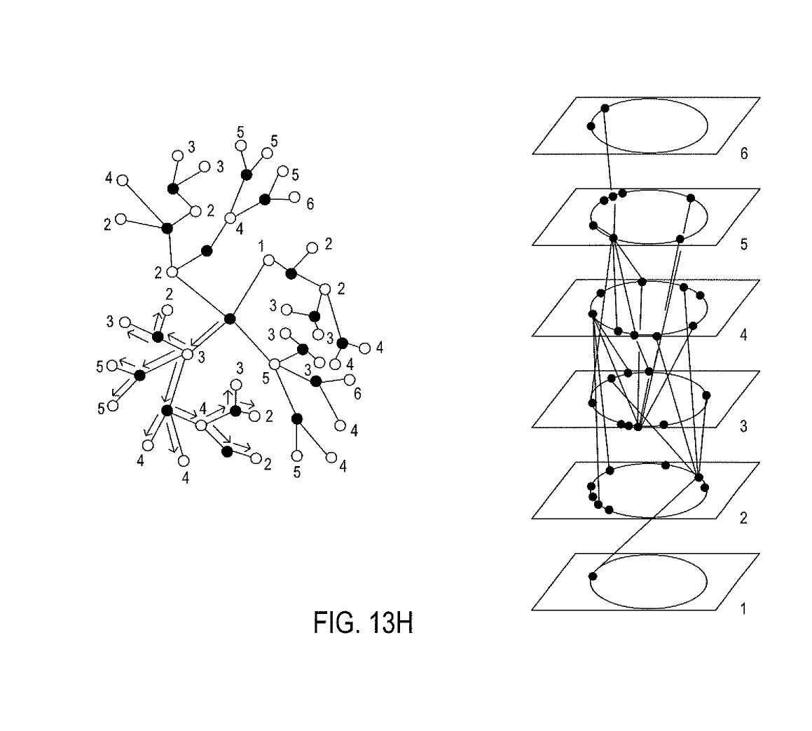

FIGS. 13A-13H illustrate the correspondence between a graph-like representation of a search process and search results and a stack representation of the same search process and search results. In FIG. 13A, a graph-like representation of a search process and search results 1302 shown on the left-hand side of the figure and a nascent stack representation 1304 shown on the right-hand side of the figure. The nascent stack representation includes multiple dimension planes 1306-1311 that each represents a different category to which document nodes can be assigned.

FIG. 13B shows numeric categories associated with each document node in the graph 1302, such as the category 2 1312 associated with document node 1314. Each dimension plane is labeled with a numeric representation of a category, such as the category 6 1316 labeling dimension plane 1311. In a first logical step of creating the stack representation, each document node in the graph is copied into a particular orbital position of the dimension plane corresponding to the category to which the document node has been assigned. In FIG. 13C, curved arrows, such as curved arrow 1320, show the mapping between category-5 document nodes and stack nodes positioned along the orbit 1322 of the category-5 dimension plane 1310. Again, the positions of the stack nodes reflect the relevance of a document or group of documents with respect to the category represented by the dimension plane. Next, as shown in FIGS. 13D-H, paths that interconnect nodes in the graph are copied into the stack representation. As shown in FIG. 13D, there is a path, represented by arrows, such as arrow 1324, that interconnects nodes 1326-1328 in the graph. Line segments representing connections between document nodes of this path are then created in the stack representation. For example, line segment 1330 represents the interconnection of nodes 1326 and 1327 in the path and line segment 1332 represents interconnection of nodes 1327 and 1328 in the graph. FIG. 13E illustrates copying of a second path from the graph to the stack representation. A second path includes node 1334 rather than node 1328, so that line segment 1336 is added to the stack representation to represent the path segment of the new path between node 1327 and node 1334. FIG. 13F shows addition of line segments 1340 and 1342 to the stack representation in order to represent paths that begin at node 1324 and extend to nodes 1344 and 1346. Using the same illustration conventions as used in FIGS. 13D-F, FIGS. 13G and 13H illustrate construction of more line segments within the stack representation in order to represent more paths within the graph. Thus, a stack representation represents the same information represented by the graph display, but in a different fashion. The stack representation is more convenient for visualizing very large result sets of up to hundreds of thousands of nodes. The GUI provides a full range of three-dimensional display manipulation operations for stack representations that allow stacks to be scaled, rotated, altered, and annotated in similar fashion to graph representations.

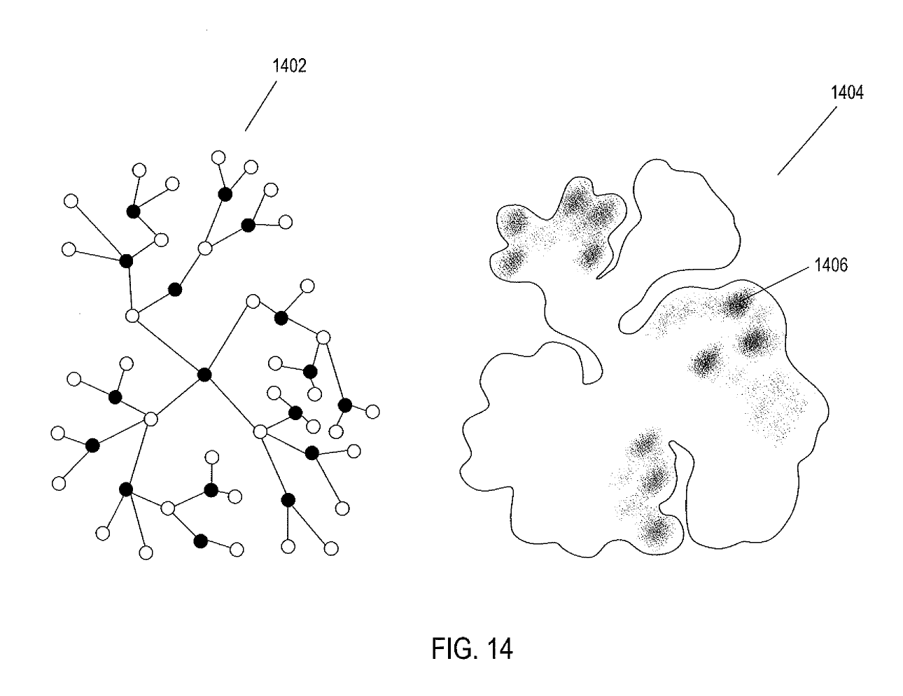

FIG. 14 illustrates a third type of representation of search processes and search results referred to as a “heat-map display.” In the heat-map display, a surface is fitted over the node of a graph. In FIG. 14, a graph representation 1402 is shown on the left-hand side of the figure and the equivalent heat-map display 1404 is shown on the right-hand side of the figure. In the heat-map display, the surface has varying shading and color to illustrate the varying relevance of underlying nodes with respect to a particular category, or other such information. In FIG. 14, darkened areas, such as darkened area 1406, represents a high degree of relevance of the underlying nodes. The heat-map display can be manipulated in the same fashion as graphs and stacks. The heat-map display allows a user to quickly visualize relative relevances or other relative characteristics of large numbers of nodes in order to facilitate identifying documents of particular interest or identifying relationships between documents.

FIG. 15 illustrates yet another feature of the GUI provided by the currently discussed methods and systems. The GUI may provide a carousel feature 1502 that shows thumbnail-like descriptions of various different graph-like representations of search results and search processes 1504-1510. This allows a user to concurrently work on multiple different parallel searches. Search results may be stored, by the system, to flat files and recovered from flat files to various types of representations in the GUI. In addition, the previously described tray feature 1504 can be used to accumulate groups, paths, and other objects of interest from multiple concurrent searches. In FIG. 15, the tray contains a first group 1506 selected from the graph representing one search 1505 and a second group 1508 selected from the currently displayed graph, also shown as the currently selected thumbnail graph 1507 in the carousel.

One implementation of the currently described methods and systems includes a client-side application, that runs on a personal computer, laptop, notebook, smart phone, or other user device in the context of a web browser. This client-side application communicates, through the web browser and device operating system, with one or more server-side applications. The communications is carried out using the REST protocol over HTTP. The server-side application accesses online information services, Internet-connected information services, and/or databases and caches on behalf of client-side applications in order to carry out searches on behalf of the client-side application and return search results. In certain implementations, the client-side application may also undertake partial rendering of search results into the various different types of visual representations provided to users by the GUI, described above. The client-side application executes the above-described GUI interface and carries out lower-level graphics processing in order to render representations of search processes and search results for display to the user. Different implementations may adjust the boundaries between client-side-application processing and responsibilities and server-side-application processing and responsibilities. In general, the client-side application assumes greater processing overheads when the user device has greater general-processing and special-purpose-graphics processing capabilities.

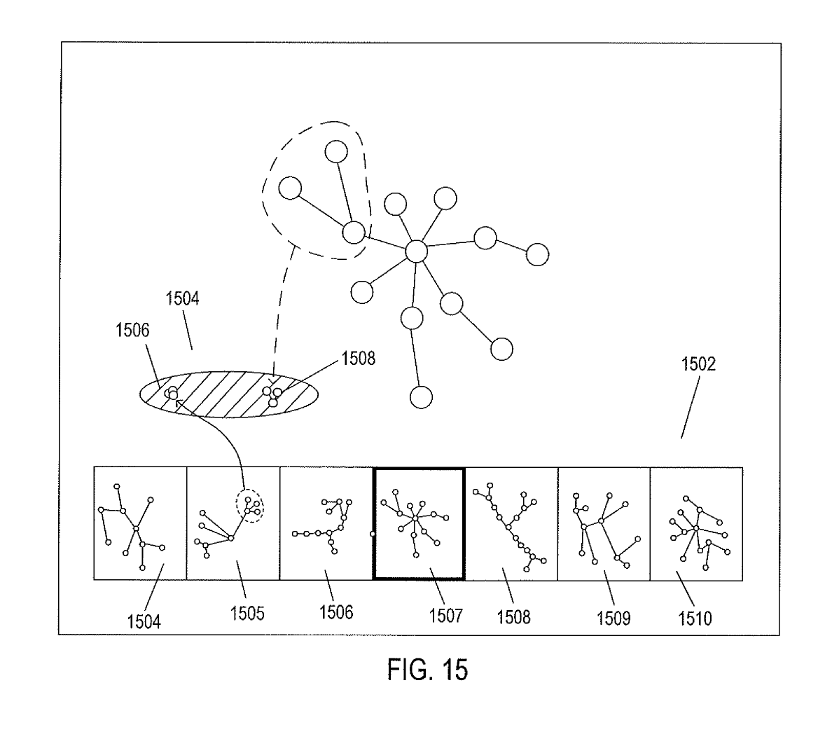

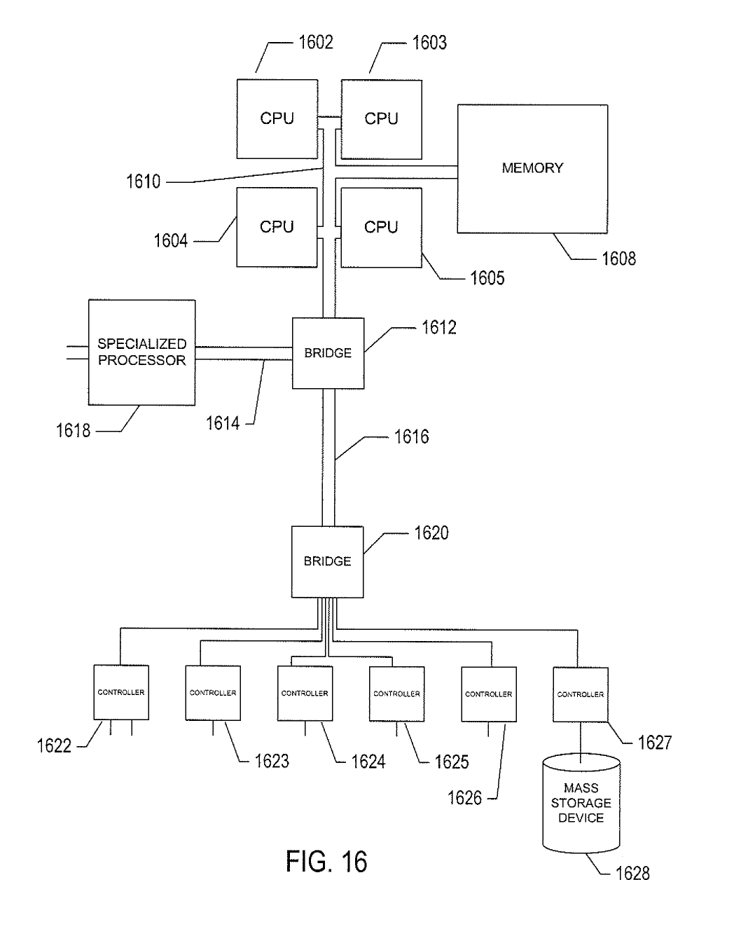

FIG. 16 provides a general architectural diagram for various types of computers and other processor-controlled devices. The high-level architectural diagram may describe a modern computer system, such as a personal computer or server. The computer system contains one or multiple central processing units (“CPUs”) 1602-1605, one or more electronic memories 1608 interconnected with the CPUs by a CPU/memory-subsystem bus 1610 or multiple busses, a first bridge 1612 that interconnects the CPU/memory-subsystem bus 1610 with additional busses 1614 and 1616, or other types of high-speed interconnection media, including multiple, high-speed serial interconnects. These busses or serial interconnections, in turn, connect the CPUs and memory with specialized processors, such as a graphics processor 1618, and with one or more additional bridges 1620, which are interconnected with high-speed serial links or with multiple controllers 1622-1627, such as controller 1627, that provide access to various different types of mass-storage devices 1628, electronic displays, input devices, and other such components, subcomponents, and computational resources.

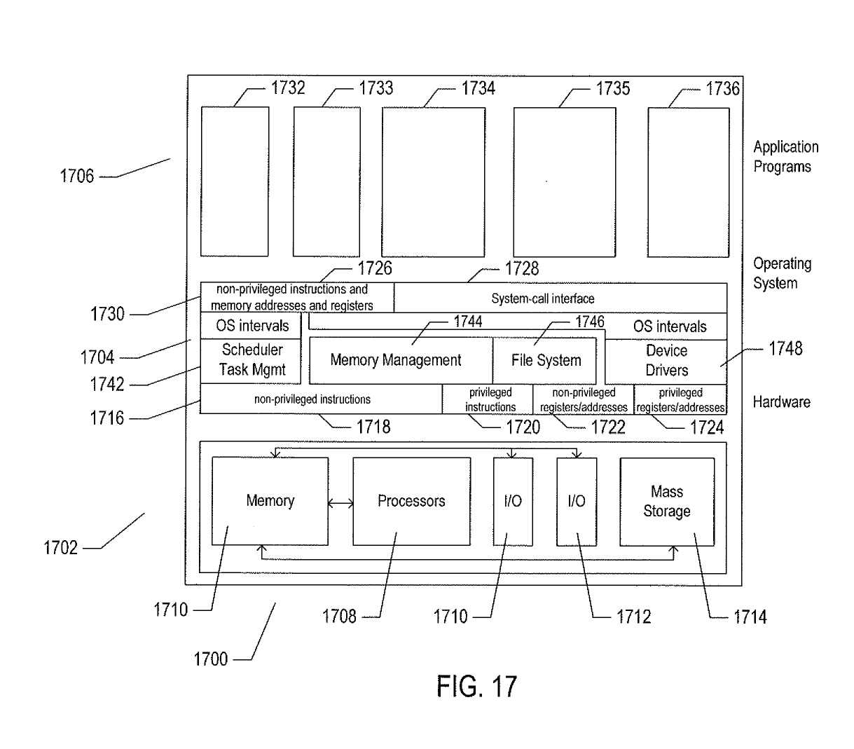

FIG. 17 illustrates generalized hardware and software components of a general-purpose computer system. The computer system 1700 is often considered to include three fundamental layers: (1) a hardware layer or level 1702; (2) an operating-system layer or level 1704; and (3) an application-program layer or level 1706. The hardware layer 1702 includes one or more processors 1708, system memory 1710, various different types of input-output (“I/O”) devices 1710 and 1712, and mass-storage devices 1714. Of course, the hardware level also includes many other components, including power supplies, internal communications links and busses, specialized integrated circuits, many different types of processor-controlled or microprocessor-controlled peripheral devices and controllers, and many other components. The operating system 1704 interfaces to the hardware level 1702 through a low-level operating system and hardware interface 1716 generally comprising a set of non-privileged computer instructions 1718, a set of privileged computer instructions 1720, a set of non-privileged registers and memory addresses 1722, and a set of privileged registers and memory addresses 1724. In general, the operating system exposes non-privileged instructions, non-privileged registers, and non-privileged memory addresses 1726 and a system-call interface 1728 as an operating-system interface 1730 to application programs 1732-1736 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 1742, memory management 1744, a file system 1746, device drivers 1748, and many other components and modules.

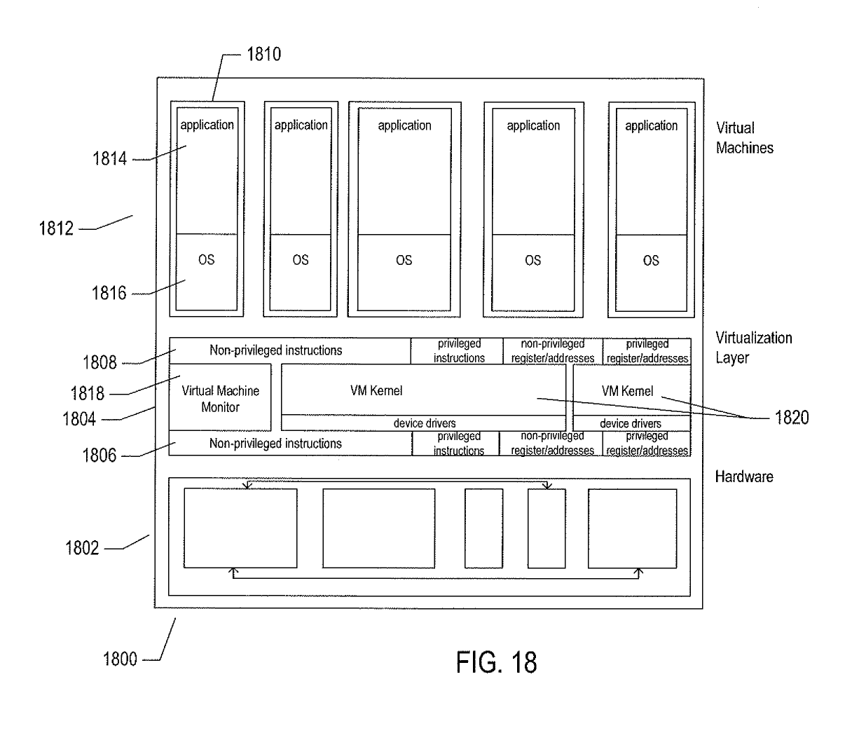

FIG. 18 illustrates generalized hardware and software components of a general-purpose computer system that includes a virtualization layer. FIG. 18 uses the same illustration conventions as used in FIG. 17. In particular, the computer system 1800 in FIG. 18 includes the same hardware layer 1802 as the hardware layer 402 shown in FIG. 17. However, rather than providing an operating system layer directly above the hardware layer, as in FIG. 17, the virtualized computing environment illustrated in FIG. 18 features a virtualization layer 1804 that interfaces through a virtualization-layer/hardware-layer interface 1806, equivalent to interface 1716 in FIG. 17, to the hardware. The virtualization layer provides a hardware-like interface 1808 to a number of virtual machines, such as virtual machine 1810, executing above the virtualization layer in a virtual-machine layer 1812. Each virtual machine includes one or more application programs or other higher-level computational entities packaged together with an operating system, such as application 1814 and operating system 1816 packaged together within virtual machine 1810. Each virtual machine is thus equivalent to the operating-system layer 1704 and application-program layer 1706 in the general-purpose computer system shown in FIG. 17. Each operating system within a virtual machine interfaces to the virtualization-layer interface 1808 rather than to the actual hardware interface 1806. The virtualization layer partitions hardware resources into abstract virtual-hardware layers to which each operating system within a virtual machine interfaces. The operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 1808 may differ for different operating systems. For example, the virtualization layer is generally able to provide virtual hardware interfaces for a variety of different types of computer hardware. This allows, as one example, a virtual machine that includes an operating system designed for a particular computer architecture to run on hardware of a different architecture. The number of virtual machines need not be equal to the number of physical processors or even a multiple of the number of processors. The virtualization layer includes a virtual-machine-monitor module 1818 that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the operating system within a virtual machine accesses virtual privileged instructions, virtual privileged registers, and virtual privileged memory through the virtualization-layer interface 1808, the accesses may result in execution of virtualization-layer code to simulate or emulate the privileged resources. The virtualization layer additionally includes a kernel module 1820 that manages memory, communications, and data-storage machine resources on behalf of executing virtual machines. The kernel, for example, may maintain shadow page tables on each virtual machine so that hardware-level virtual-memory facilities can be used to process memory accesses. The kernel may additionally include routines that implement virtual communications and data-storage devices as well as device drivers that directly control the operation of underlying hardware communications and data-storage devices. Similarly, the kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

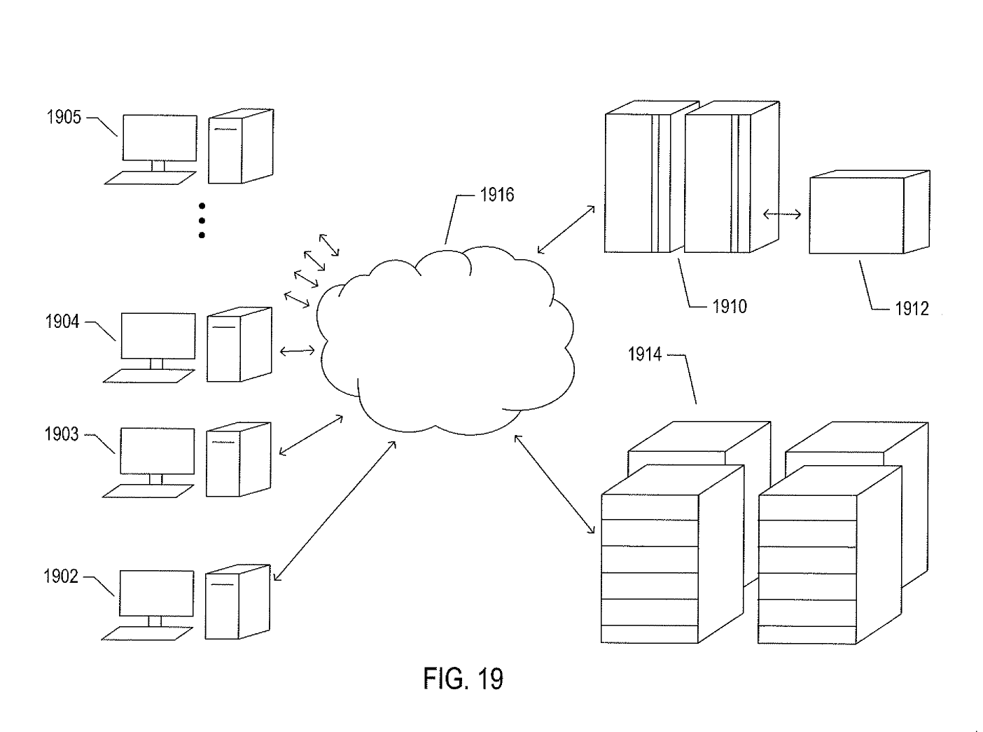

FIG. 19 illustrates an Internet-connected distributed computer system. FIG. 19 shows a typical distributed system in which a large number of PCs 1902-1905, a high-end distributed mainframe system 1910 with a large data-storage system 1912, and a large computer center 1914 with large numbers of rack-mounted servers or blade servers all interconnected through various communications and networking systems that together comprise the Internet 1916. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

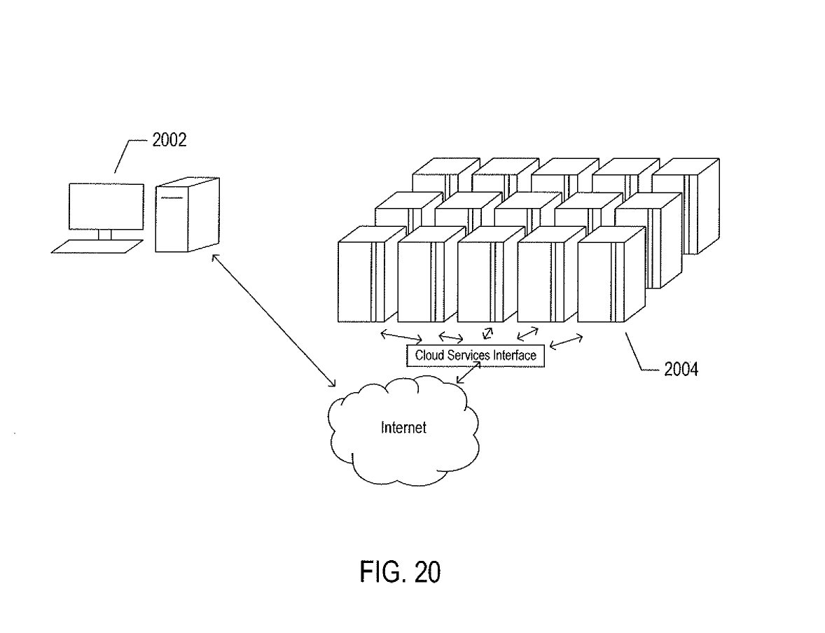

FIG. 20 illustrates cloud computing. In the recently developed cloud-computing paradigm, computing cycles and data-storage facilities are provided to organizations and individuals by cloud-computing providers. In FIG. 20, a user using a personal computer 2002 accesses a service provided by an organization that has implemented server-side applications to execute in a public cloud 2004. The organization can configure virtual computer systems and even entire virtual data centers and can launch execution of server-side application programs on the virtual computer systems and virtual data centers in order to carry out any of many different types of computational tasks Cloud-computing facilities are intended to provide computational bandwidth and data-storage services much as utility companies provide electrical power and water to consumers. Cloud computing provides enormous advantages to organizations which do not wish to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

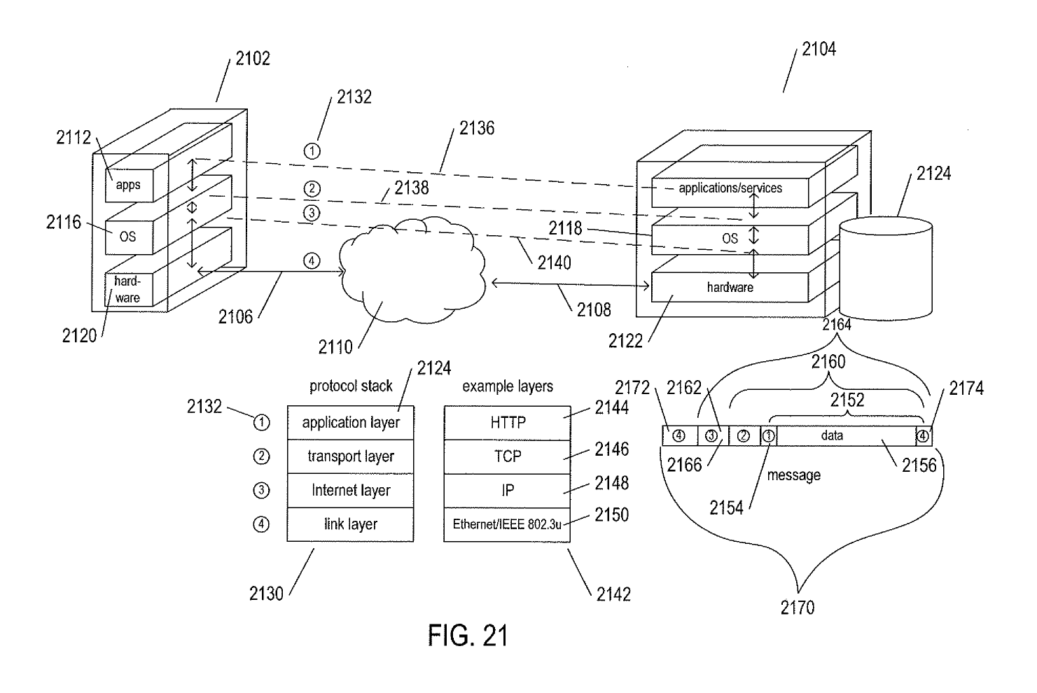

FIG. 21 illustrates electronic communications between a client and server computer. In FIG. 21, a client computer 2102 is shown to be interconnected with a server computer 2104 via local communication links 2106 and 2108 and a complex distributed intermediary communications system 2110, such as the Internet. This complex communications system may include a large number of individual computer systems and many types of electronic communications media, including wide-area networks, public switched telephone networks, wireless communications, satellite communications, and many other types of electronics-communications systems and intermediate computer systems, routers, bridges, and other device and system components. Both the server and client computers are shown to include three basic internal layers including an applications layer 2112 in the client computer and a corresponding applications and services layer 2114 in the server computer, an operating-system layer 2116 and 2118, and a hardware layer 2120 and 2122. The server computer 2104 is additionally associated with an internal, peripheral, or remote data-storage subsystem 2124. The hardware layers 2120 and 2122 may include the components discussed above with reference to FIG. 1 as well as many additional hardware components and subsystems, such as power supplies, cooling fans, switches, auxiliary processors, and many other mechanical, electrical, electromechanical, and electro-optical-mechanical components. The operating system 2116 and 2118 represents the general control system of both a client computer 2102 and a server computer 2104. The operating system interfaces to the hardware layer through a set of registers that, under processor control, are used for transferring data, including commands and stored information, between the operating system and various hardware components. The operating system also provides a complex execution environment in which various application programs, including database management systems, web browsers, web services, and other application programs execute. In many cases, modern computer systems employ an additional layer between the operating system and the hardware layer, referred to as a “virtualization layer,” that interacts directly with the hardware and provides a virtual-hardware-execution environment for one or more operating systems.

Client systems may include any of many types of processor-controlled devices, including tablet computers, laptop computers, mobile smart phones, and other such processor-controlled devices. These various types of clients may include only a subset of the components included in a desktop personal component as well components not generally included in desktop personal computers.

Electronic communications between computer systems generally comprises packets of information, referred to as datagrams, transferred from client computers to server computers and from server computers to client computers. In many cases, the communications between computer systems is commonly viewed from the relatively high level of an application program which uses an application-layer protocol for information transfer. However, the application-layer protocol is implemented on top of additional layers, including a transport layer, Internet layer, and link layer. These layers are commonly implemented at different levels within computer systems. Each layer is associated with a protocol for data transfer between corresponding layers of computer systems. These layers of protocols are commonly referred to as a “protocol stack.” In FIG. 21, a representation of a common protocol stack 2130 is shown below the interconnected server and client computers 2104 and 2102. The layers are associated with layer numbers, such as layer number “1” 2132 associated with the application layer 2134. These same layer numbers are used in the depiction of the interconnection of the client computer 2102 with the server computer 2104, such as layer number “1” 2132 associated with a horizontal dashed line 2136 that represents interconnection of the application layer 2112 of the client computer with the applications/services layer 2114 of the server computer through an application-layer protocol. A dashed line 2136 represents interconnection via the application-layer protocol in FIG. 21, because this interconnection is logical, rather than physical. Dashed-line 2138 represents the logical interconnection of the operating-system layers of the client and server computers via a transport layer. Dashed line 2140 represents the logical interconnection of the operating systems of the two computer systems via an Internet-layer protocol. Finally, links 2106 and 2108 and cloud 2110 together represent the physical communications media and components that physically transfer data from the client computer to the server computer and from the server computer to the client computer. These physical communications components and media transfer data according to a link-layer protocol. In FIG. 21, a second table 2142 aligned with the table 2130 that illustrates the protocol stack includes example protocols that may be used for each of the different protocol layers. The hypertext transfer protocol (“HTTP”) may be used as the application-layer protocol 2144, the transmission control protocol (“TCP”) 2146 may be used as the transport-layer protocol, the Internet protocol 2148 (“IP”) may be used as the Internet-layer protocol, and, in the case of a computer system interconnected through a local Ethernet to the Internet, the Ethernet/IEEE 802.3u protocol 2150 may be used for transmitting and receiving information from the computer system to the complex communications components of the Internet. Within cloud 2110, which represents the Internet, many additional types of protocols may be used for transferring the data between the client computer and server computer.

Consider the sending of a message, via the HTTP protocol, from the client computer to the server computer. An application program generally makes a system call to the operating system and includes, in the system call, an indication of the recipient to whom the data is to be sent as well as a reference to a buffer that contains the data. The data and other information are packaged together into one or more HTTP datagrams, such as datagram 2152. The datagram may generally include a header 2154 as well as the data 2156, encoded as a sequence of bytes within a block of memory. The header 2154 is generally a record composed of multiple byte-encoded fields. The call by the application program to an application-layer system call is represented in FIG. 21 by solid vertical arrow 2158. The operating system employs a transport-layer protocol, such as TCP, to transfer one or more application-layer datagrams that together represent an application-layer message. In general, when the application-layer message exceeds some threshold number of bytes, the message is sent as two or more transport-layer messages. Each of the transport-layer messages 2160 includes a transport-layer-message header 2162 and an application-layer datagram 2152. The transport-layer header includes, among other things, sequence numbers that allow a series of application-layer datagrams to be reassembled into a single application-layer message. The transport-layer protocol is responsible for end-to-end message transfer independent of the underlying network and other communications subsystems, and is additionally concerned with error control, segmentation, as discussed above, flow control, congestion control, application addressing, and other aspects of reliable end-to-end message transfer. The transport-layer datagrams are then forwarded to the Internet layer via system calls within the operating system and are embedded within Internet-layer datagrams 2164, each including an Internet-layer header 2166 and a transport-layer datagram. The Internet layer of the protocol stack is concerned with sending datagrams across the potentially many different communications media and subsystems that together comprise the Internet. This involves routing of messages through the complex communications systems to the intended destination. The Internet layer is concerned with assigning unique addresses, known as “IP addresses,” to both the sending computer and the destination computer for a message and routing the message through the Internet to the destination computer. Internet-layer datagrams are finally transferred, by the operating system, to communications hardware, such as a network-interface controller (“NIC”) which embeds the Internet-layer datagram 2164 into a link-layer datagram 2170 that includes a link-layer header 2172 and generally includes a number of additional bytes 2174 appended to the end of the Internet-layer datagram. The link-layer header includes collision-control and error-control information as well as local-network addresses. The link-layer packet or datagram 2170 is a sequence of bytes that includes information introduced by each of the layers of the protocol stack as well as the actual data that is transferred from the source computer to the destination computer according to the application-layer protocol.

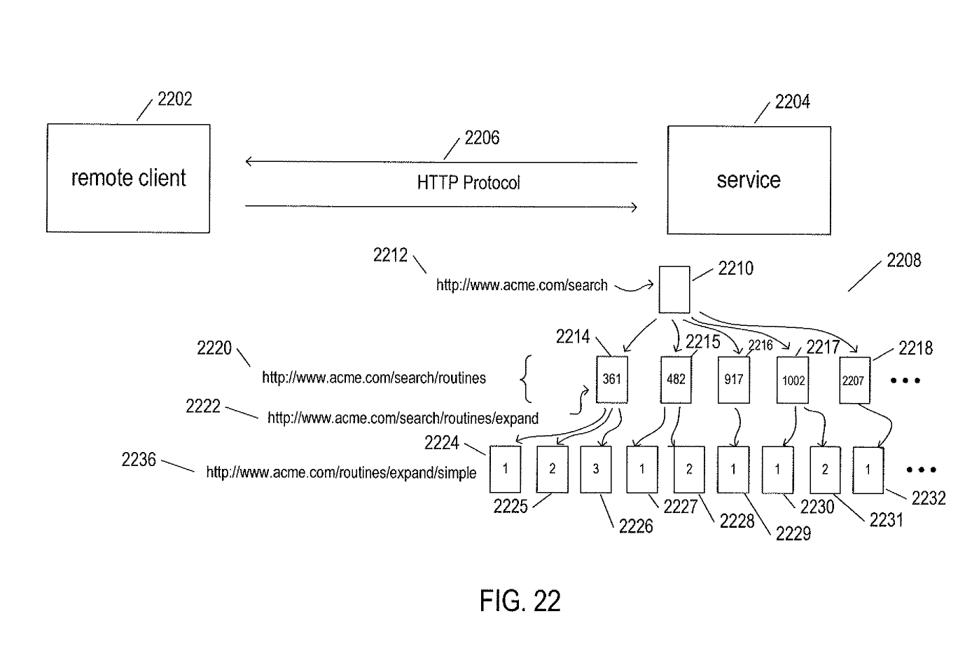

Next, the RESTful approach to web-service APIs is described, beginning with FIG. 22. FIG. 22 illustrates the role of resources in RESTful APIs. In FIG. 22, and in subsequent figures, a remote client 2202 is shown to be interconnected and communicating with a service provided by one or more service computers 2204 via the HTTP protocol 2206. Many RESTful APIs are based on the HTTP protocol. Thus, the focus is on the application layer in the following discussion. However, as discussed above with reference to FIG. 21, the remote client 2202 and service provided by one or more server computers 2204 are, in fact, physical systems with application, operating-system, and hardware layers that are interconnected with various types of communications media and communications subsystems, with the HTTP protocol the highest-level layer in a protocol stack implemented in the application, operating-system, and hardware layers of client computers and server computers. The service may be provided by one or more server computers, as discussed above in a preceding section. As one example, a number of servers may be hierarchically organized as various levels of intermediary servers and end-point servers. However, the entire collection of servers that together provide a service are addressed by a domain name included in a uniform resource identifier (“URI”), as further discussed below. A RESTful API is based on a small set of verbs, or operations, provided by the HTTP protocol and on resources, each uniquely identified by a corresponding URI. Resources are logical entities, information about which is stored on one or more servers that together comprise a domain. URIs are the unique names for resources. A resource about which information is stored on a server that is connected to the Internet has a unique URI that allows that information to be accessed by any client computer also connected to the Internet with proper authorization and privileges. URIs are thus globally unique identifiers, and can be used to specify resources on server computers throughout the world. A resource may be any logical entity, including people, digitally encoded documents, organizations, services, routines, and other such entities that can be described and characterized by digitally encoded information. A resource is thus a logical entity. Digitally encoded information that describes the resource and that can be accessed by a client computer from a server computer is referred to as a “representation” of the corresponding resource. As one example, when a resource is a web page, the representation of the resource may be a hypertext markup language (“HTML”) encoding of the resource. As another example, when the resource is an employee of a company, the representation of the resource may be one or more records, each containing one or more fields, that store information characterizing the employee, such as the employee's name, address, phone number, job title, employment history, and other such information.

In the example shown in FIG. 22, the web servers 2204 provides a RESTful API based on the HTTP protocol 2206 and a hierarchically organized set of resources 2208 that allow clients of the service to access information about the customers and orders placed by customers of the Acme Company. This service may be provided by the Acme Company itself or by a third-party information provider. All of the customer and order information is collectively represented by a customer information resource 2210 associated with the URI “http://www.acme.com/customerInfo” 2212. As discussed further, below, this single URI and the HTTP protocol together provide sufficient information for a remote client computer to access any of the particular types of customer and order information stored and distributed by the service 2204. A customer information resource 2210 represents a large number of subordinate resources. These subordinate resources include, for each of the customers of the Acme Company, a customer resource, such as customer resource 2214. All of the customer resources 2214-2218 are collectively named or specified by the single URI “http://www.acme.com/customerInfo/customers” 2220. Individual customer resources, such as customer resource 2214, are associated with customer-identifier numbers and are each separately addressable by customer-resource-specific URIs, such as URI “http://www.acme.com/customerInfo/customers/361” 2222 which includes the customer identifier “361” for the customer represented by customer resource 2214. Each customer may be logically associated with one or more orders. For example, the customer represented by customer resource 2214 is associated with three different orders 2224-2226, each represented by an order resource. All of the orders are collectively specified or named by a single URI “http://www.acme.com/customerInfo/orders” 2236. All of the orders associated with the customer represented by resource 2214, orders represented by order resources 2224-2226, can be collectively specified by the URI “http://www.acme.com/customerInfo/customers/361/orders” 2238. A particular order, such as the order represented by order resource 2224, may be specified by a unique URI associated with that order, such as URI “http://www.acme.com/customerInfo/customers/361/orders/1” 2240, where the final “1” is an order number that specifies a particular order within the set of orders corresponding to the particular customer identified by the customer identifier “361.”

In one sense, the URIs bear similarity to path names to files in file directories provided by computer operating systems. However, it should be appreciated that resources, unlike files, are logical entities rather than physical entities, such as the set of stored bytes that together compose a file within a computer system. When a file is accessed through a path name, a copy of a sequence of bytes that are stored in a memory or mass-storage device as a portion of that file are transferred to an accessing entity. By contrast, when a resource is accessed through a URI, a server computer returns a digitally encoded representation of the resource, rather than a copy of the resource. For example, when the resource is a human being, the service accessed via a URI specifying the human being may return alphanumeric encodings of various characteristics of the human being, a digitally encoded photograph or photographs, and other such information. Unlike the case of a file accessed through a path name, the representation of a resource is not a copy of the resource, but is instead some type of digitally encoded information with respect to the resource.

In the example RESTful API illustrated in FIG. 22, a client computer can use the verbs, or operations, of the HTTP protocol and the top-level URI 2212 to navigate the entire hierarchy of resources 2208 in order to obtain information about particular customers and about the orders that have been placed by particular customers.

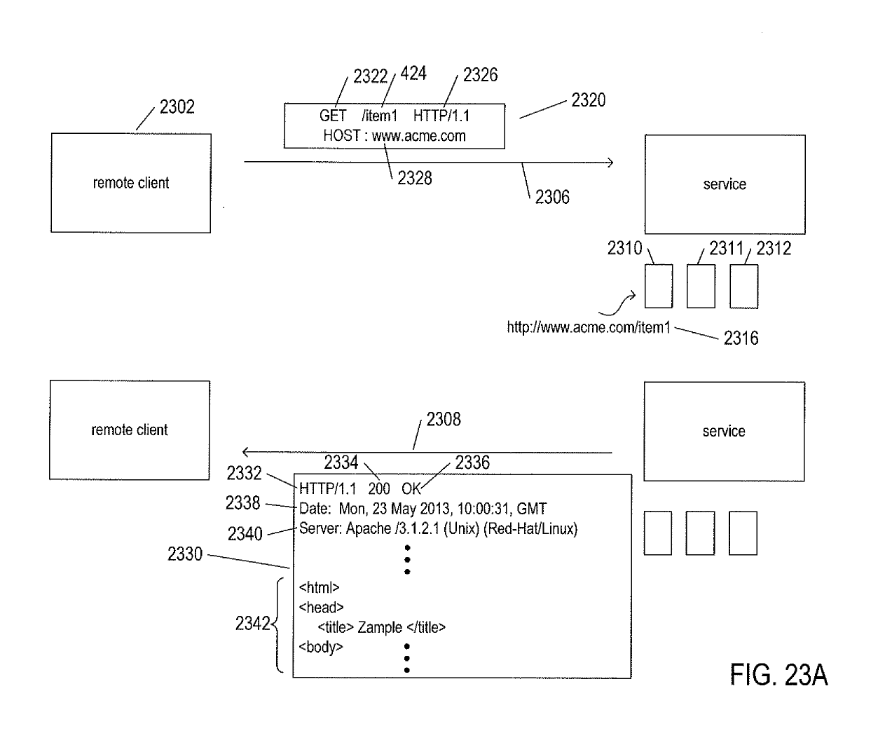

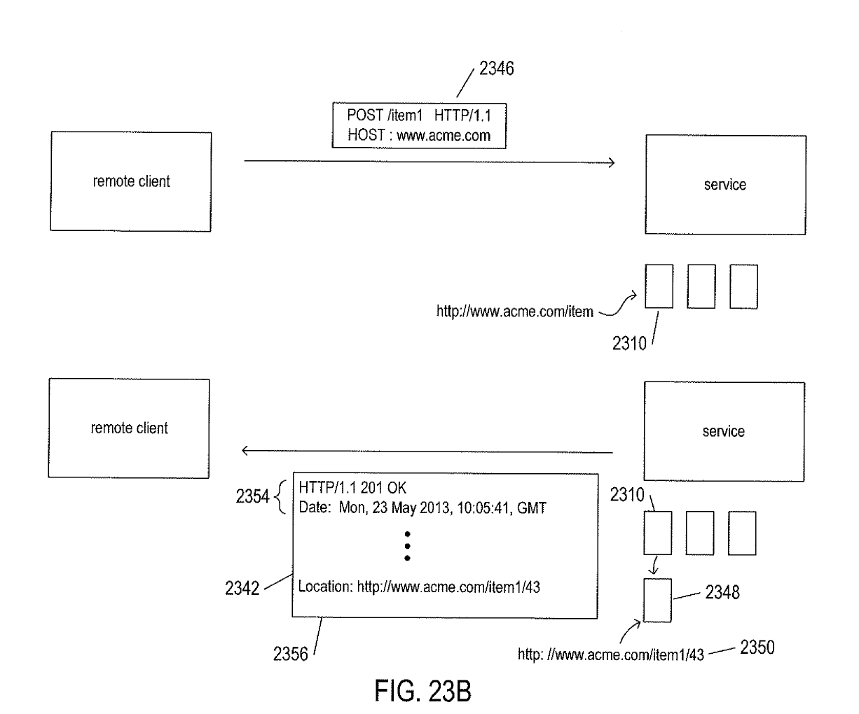

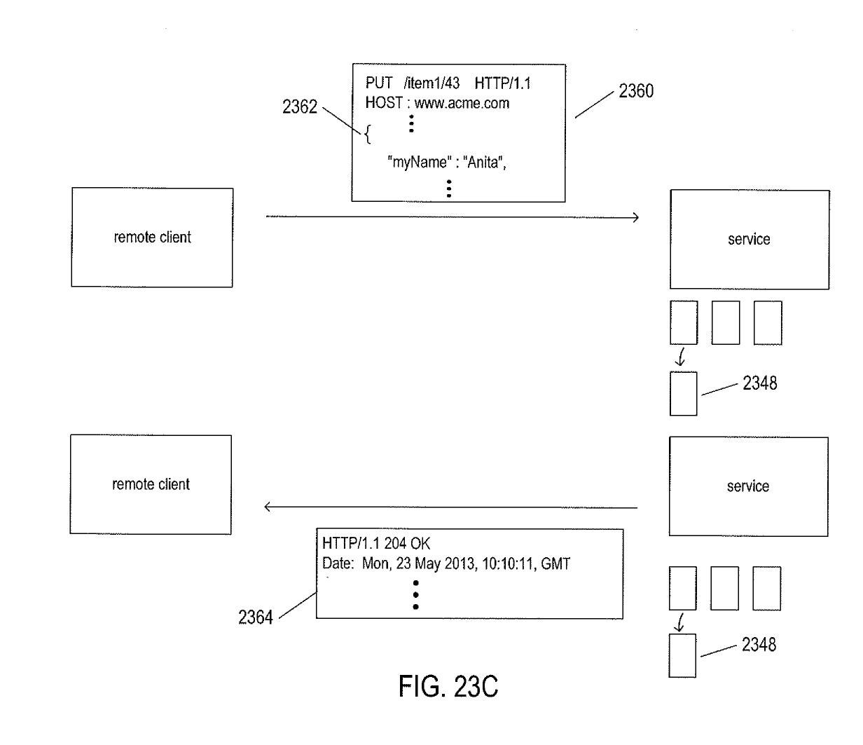

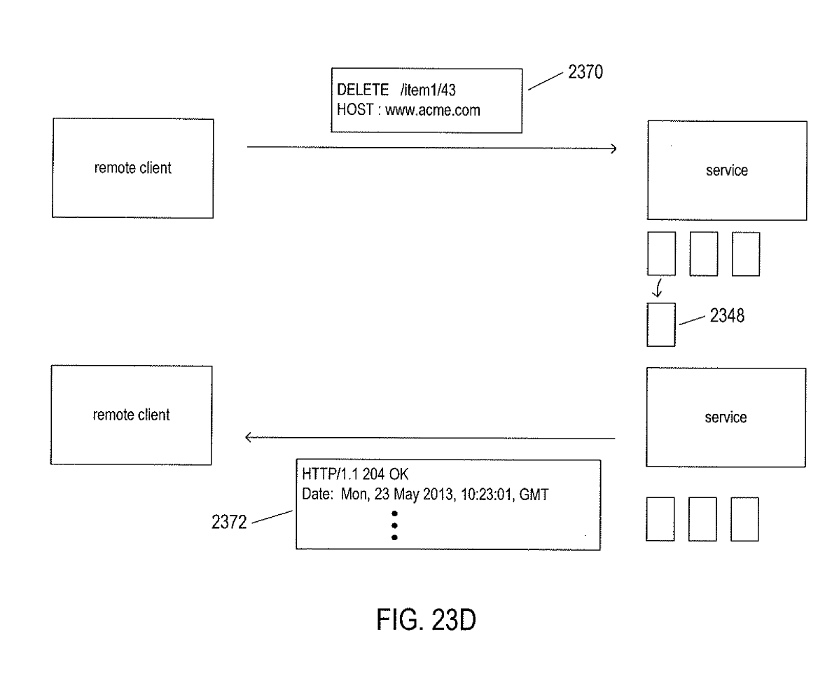

FIGS. 23A-D illustrate four basic verbs, or operations, provided by the HTTP application-layer protocol used in RESTful applications. RESTful applications are client/server protocols in which a client issues an HTTP request message to a service or server and the service or server responds by returning a corresponding HTTP response message. FIGS. 23A-D use the illustration conventions discussed above with reference to FIG. 22 with regard to the client, service, and HTTP protocol. For simplicity and clarity of illustration, in each of these figures, a top portion illustrates the request and a lower portion illustrates the response. The remote client 2302 and service 2304 are shown as labeled rectangles, as in FIG. 22. A right-pointing solid arrow 2306 represents sending of an HTTP request message from a remote client to the service and a left-pointing solid arrow 2308 represents sending of a response message corresponding to the request message by the service to the remote client. For clarity and simplicity of illustration, the service 2304 is shown associated with a few resources 2310-2312.

FIG. 23A illustrates the GET request and a typical response. The GET request requests the representation of a resource identified by a URI from a service. In the example shown in FIG. 23A, the resource 2310 is uniquely identified by the URI “http://www.acme.com/item1” 2316. The initial substring “http://www.acme.com” is a domain name that identifies the service. Thus, URI 2316 can be thought of as specifying the resource “item1” that is located within and managed by the domain “www.acme.com.” The GET request 2320 includes the command “GET” 2322, a relative resource identifier 2324 that, when appended to the domain name, generates the URI that uniquely identifies the resource, and in an indication of the particular underlying application-layer protocol 2326. A request message may include one or more headers, or key/value pairs, such as the host header 2328 “Host:www.acme.com” that indicates the domain to which the request is directed. There are many different headers that may be included. In addition, a request message may also include a request-message body. The body may be encoded in any of various different self-describing encoding languages, often JSON, XML, or HTML. In the current example, there is no request-message body. The service receives the request message containing the GET command, processes the message, and returns a corresponding response message 2330. The response message includes an indication of the application-layer protocol 2332, a numeric status 2334, a textural status 2336, various headers 2338 and 2340, and, in the current example, a body 2342 that includes the HTML encoding of a web page. Again, however, the body may contain any of many different types of information, such as a JSON object that encodes a personnel file, customer description, or order description. GET is the most fundamental and generally most often used verb, or function, of the HTTP protocol.

FIG. 23B illustrates the POST HTTP verb. In FIG. 23B, the client sends a POST request 2346 to the service that is associated with the URI “http://www.acme.com/item1.” In many RESTful APIs, a POST request message requests that the service create a new resource subordinate to the URI associated with the POST request and provide a name and corresponding URI for the newly created resource. Thus, as shown in FIG. 2313, the service creates a new resource 2348 subordinate to resource 2310 specified by URI “http://www.acme.com/item1,” and assigns an identifier “36” to this new resource, creating for the new resource the unique URI “http://www.acme.com/item1/36” 2350. The service then transmits a response message 2352 corresponding to the POST request back to the remote client. In addition to the application-layer protocol, status, and headers 2354, the response message includes a location header 2356 with the URI of the newly created resource. According to the HTTP protocol, the POST verb may also be used to update existing resources by including a body with update information. However, RESTful APIs generally use POST for creation of new resources when the names for the new resources are determined by the service. The POST request 2346 may include a body containing a representation or partial representation of the resource that may be incorporated into stored information for the resource by the service.

FIG. 23C illustrates the PUT HTTP verb. In RESTful APIs, the PUT HTTP verb is generally used for updating existing resources or for creating new resources when the name for the new resources is determined by the client, rather than the service. In the example shown in FIG. 23C, the remote client issues a PUT HTTP request 2360 with respect to the URI “http://www.acme.com/item1/36” that names the newly created resource 2348. The PUT request message includes a body with a JSON encoding of a representation or partial representation of the resource 2362. In response to receiving this request, the service updates resource 2348 to include the information 2362 transmitted in the PUT request and then returns a response corresponding to the PUT request 2364 to the remote client.

FIG. 23D illustrates the DELETE HTTP verb. In the example shown in FIG. 23D, the remote client transmits a DELETE HTTP request 2370 with respect to URI “http://www.acme.com/item1/36” that uniquely specifies newly created resource 2348 to the service. In response, the service deletes the resource associated with the URL and returns a response message 2372.

As further discussed below, and as mentioned above, a service may return, in response messages, various different links, or URIs, in addition to a resource representation. These links may indicate, to the client, additional resources related in various different ways to the resource specified by the URI associated with the corresponding request message. As one example, when the information returned to a client in response to a request is too large for a single HTTP response message, it may be divided into pages, with the first page returned along with additional links, or URIs, that allow the client to retrieve the remaining pages using additional GET requests. As another example, in response to an initial GET request for the customer info resource (2210 in FIG. 22), the service may provide URIs 2220 and 2236 in addition to a requested representation to the client, using which the client may begin to traverse the hierarchical resource organization in subsequent GET requests.

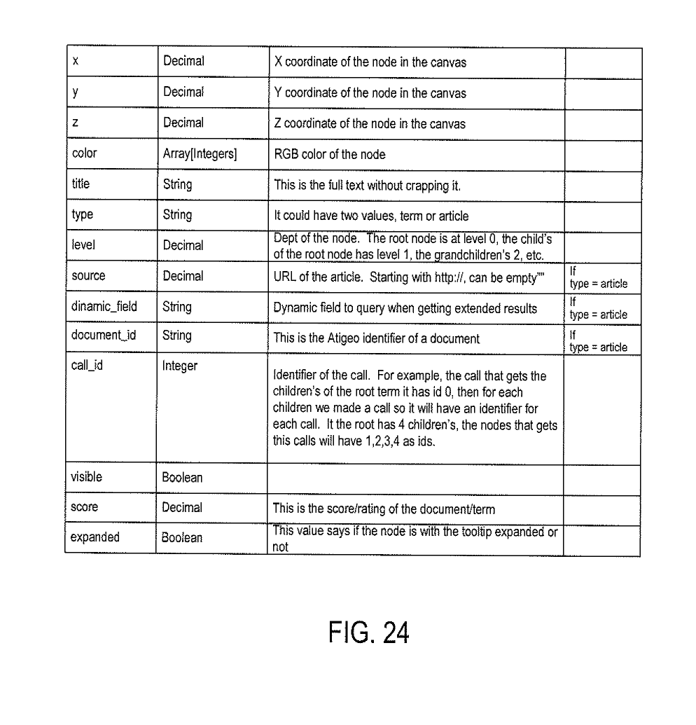

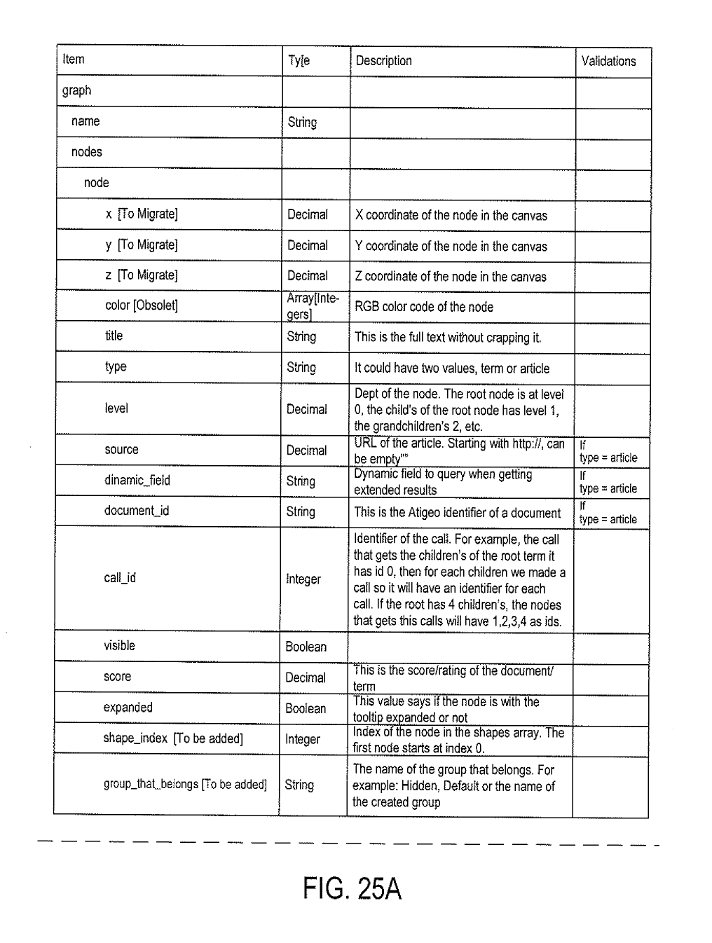

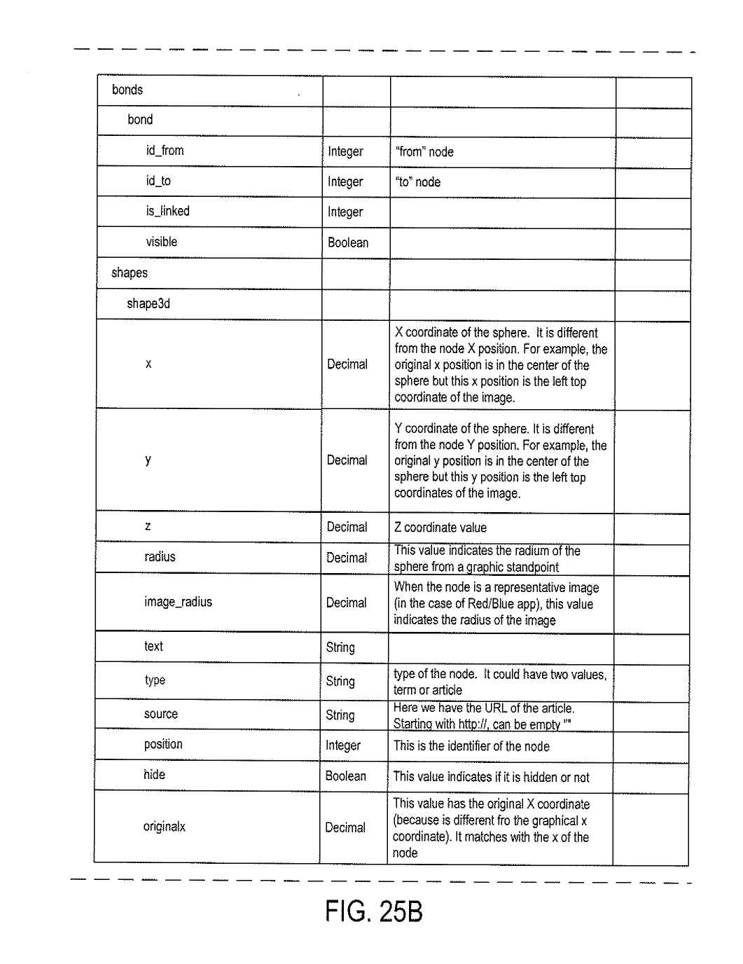

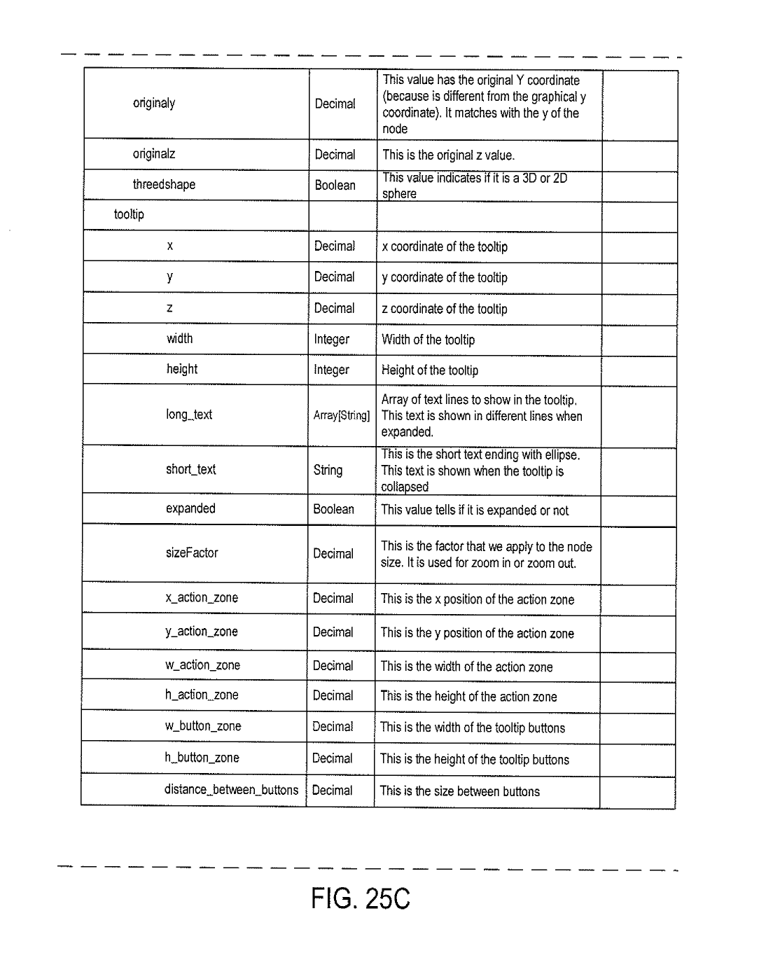

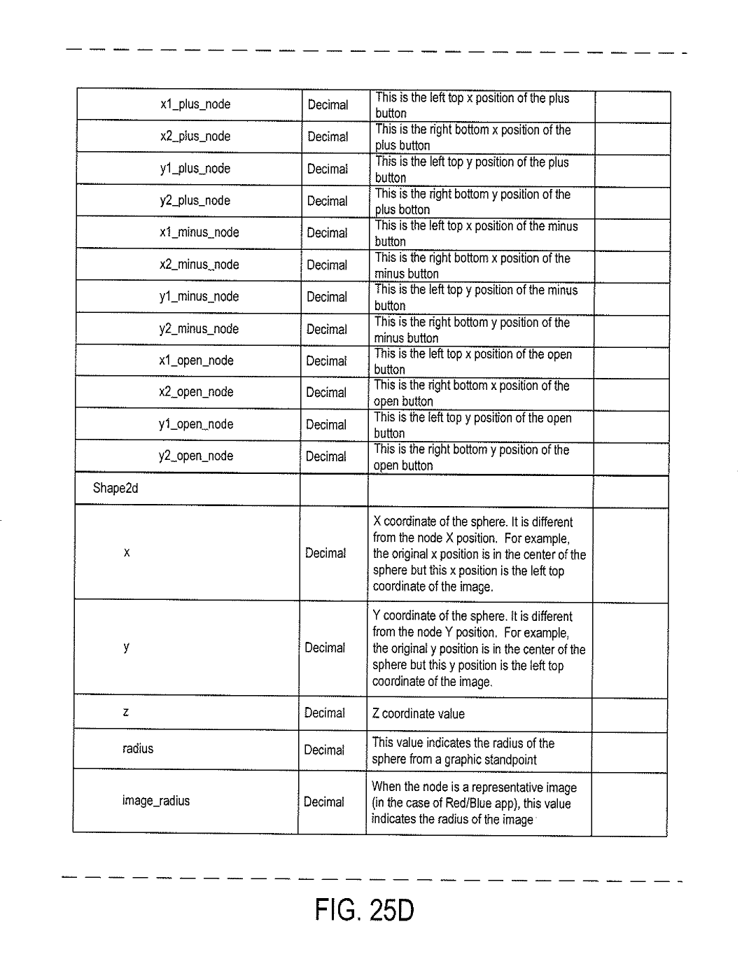

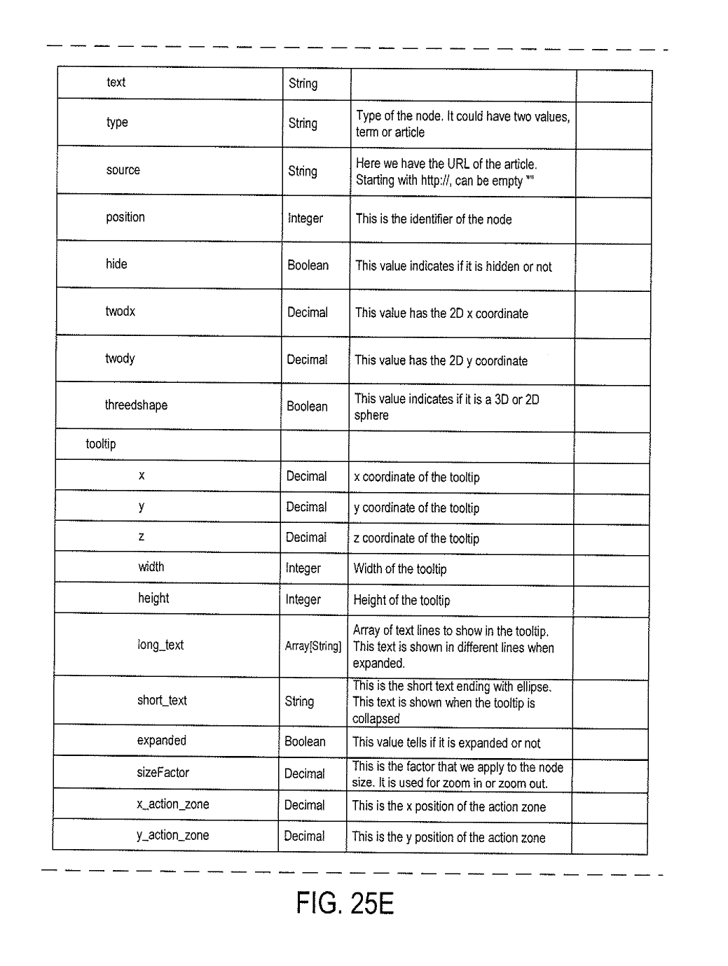

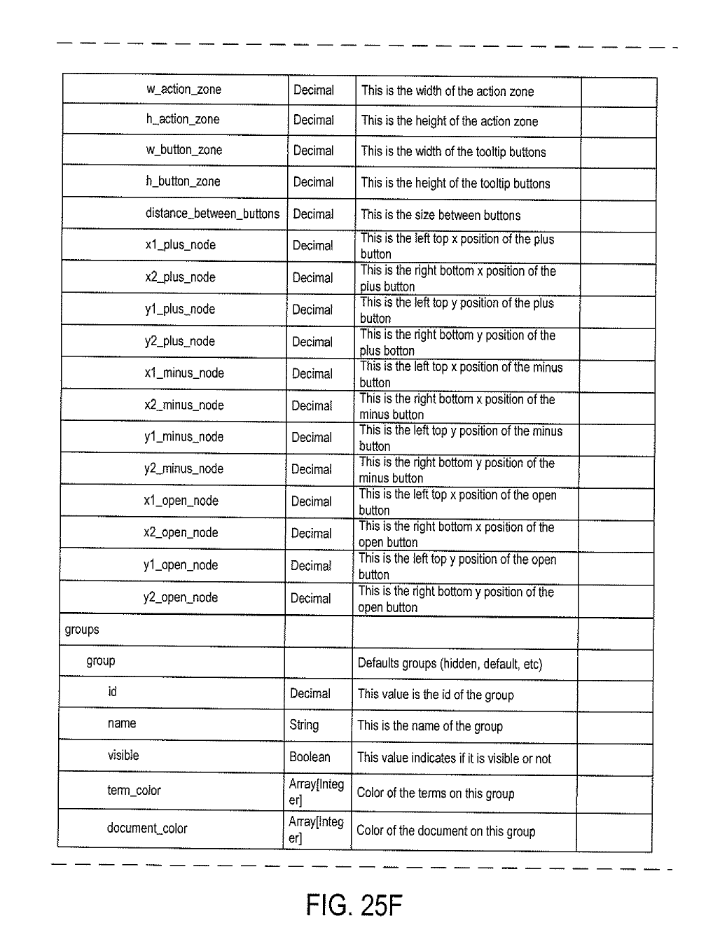

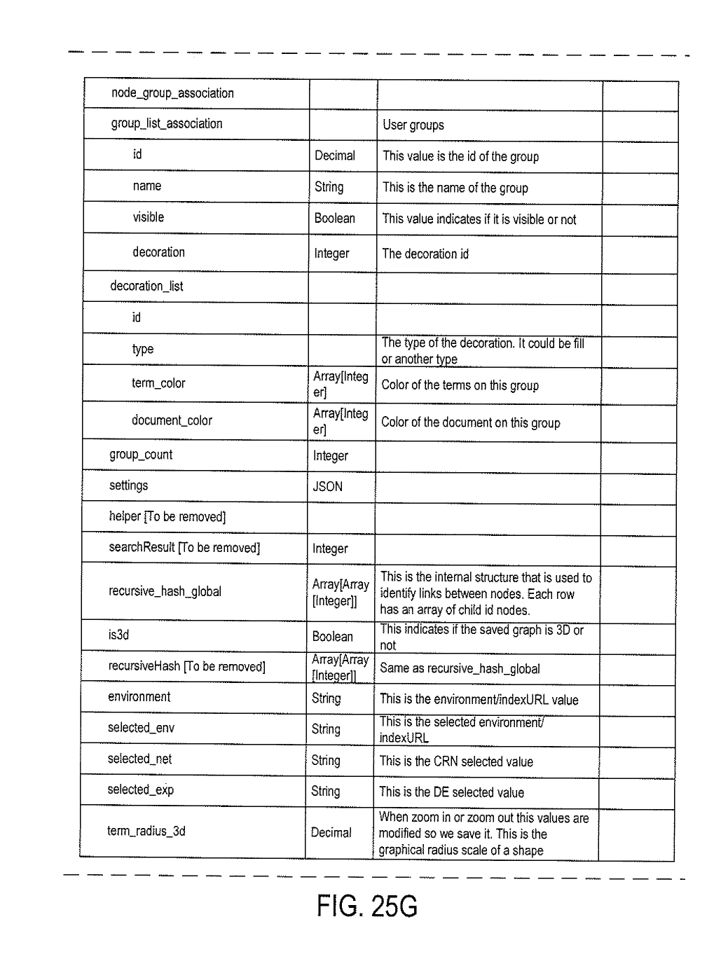

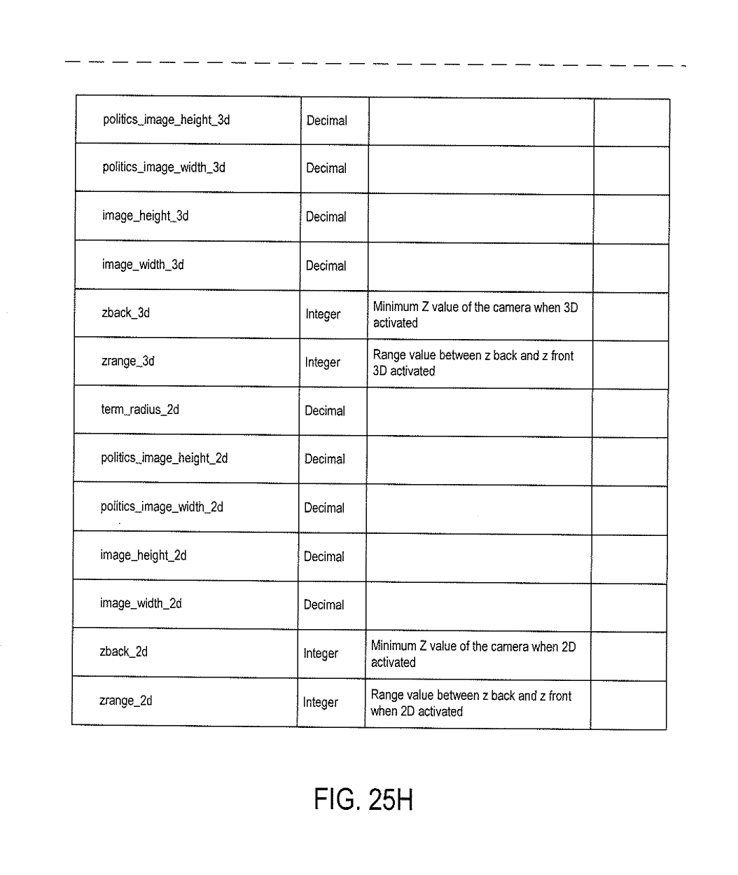

Data for the graph-like representation of search processes and search results is stored in numerous data structures. FIG. 24 provides one example of the data stored within a node object to describe a document node. FIGS. 25A-H show data contained in a data script structure to describe an entire graph, in one implementation of the currently described methods and systems. Of course, there are many different possible ways of organizing the data stored to represent a search process and search results.

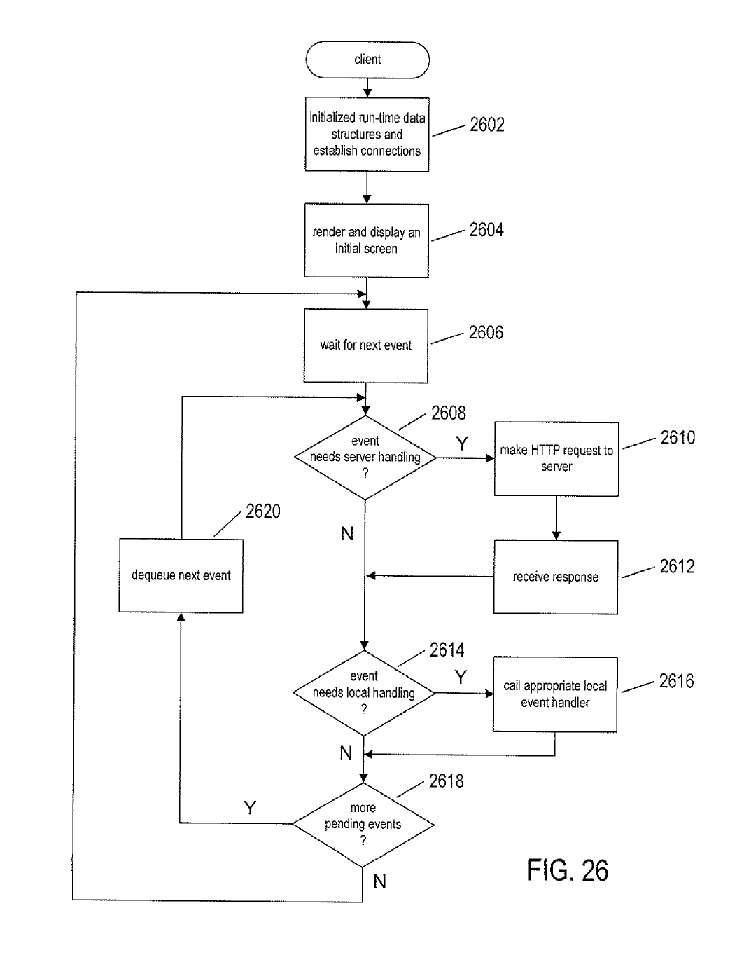

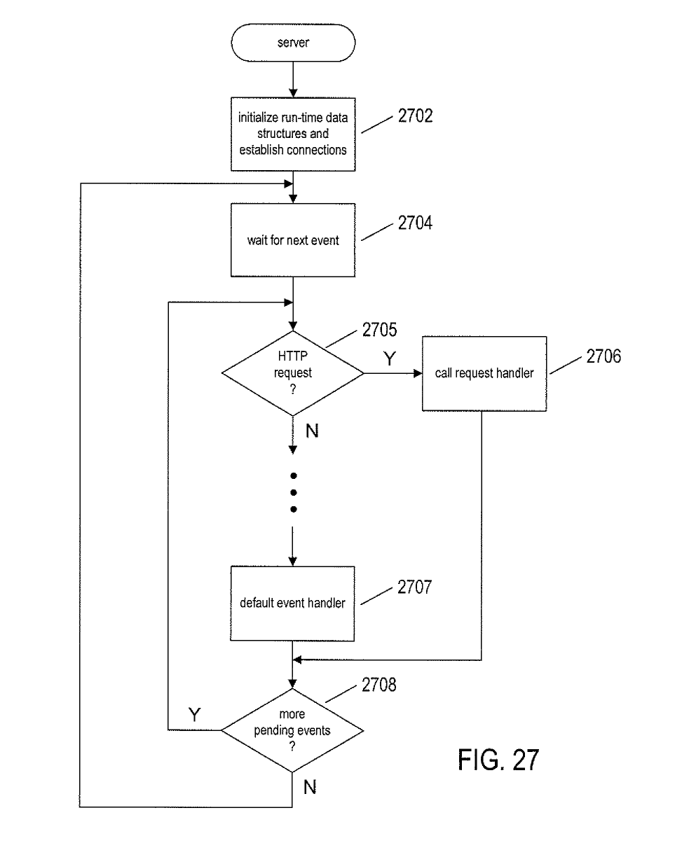

FIGS. 26-27 show control-flow diagrams that describe overall operation of one implementation of the currently described methods and systems. FIG. 26 illustrates client-side-application operation. In step 2602, the client-side application is launched and the client-side application initializes run-time data structures and establishes connections to local-device services and functionalities as well as to one or more server-side applications. In step 2604, the client-side application renders and displays an initial screen of the GUI. Then, in step 2606, the client-side application waits for the occurrence of a next event. There are many different types of events to which the client-side application responds, including web-browser-generated events, including user-input events and events associated with communication between the web browser and server-side application. When a next event occurs, the client-side application determines, in step 2608, whether server-side handling of the event is needed. When server-side handling is needed, the client-side application generates and transmits an HTTP request to the server, via the web browser and operating system, in step 2610 and receives a response to the request in step 2612. In step 2614, the client-side application determines whether the event needs local handling, such as execution of client-side routines for rendering information for display and, when so, calls appropriate local event handler for the event in step 2616. Local handling may generate additional events for handling by the client-side application. When there are more pending events to handle, as determined in step 2618, a next event is dequeued from an event queue, in step 2620, and control flows back to step 2608. Otherwise, control flows back to step 2606, or the client-side application waits for a next event.

FIG. 27 shows a similar control-flow diagram for server-side-application operation. When initially launched, the server-side application initializes run-time data structure, establishes connections with other servers, databases, and data sources, and prepares for responding to requests in step 2702. Then, the server-side application enters an event loop of steps 2704-2708 in which HTTP requests from client-side applications are handled.

Although the present invention has been described in terms of particular embodiments, it is not intended that the invention be limited to these embodiments. Modifications within the spirit of the invention will be apparent to those skilled in the art. For example, many different implementations can be obtained by varying any of many different design and implementation parameters, including hardware platforms and user devices, operating systems, programming languages, data structures, control structures, modular organizations, and other such design and implementation parameters.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A document-searching system comprising:
a user device having at least one processor, one or more memories, a network interface, an electronic display, and processor instructions, stored in one or more of the one or more memories that, when executed on the processor, control the user device to
receive user input,
transmit requests to a remote server through the network interface, including document-search requests,
receive responses to the transmitted requests from the remote server through the network interface, including document search results, and
display a graphical user interface on the electronic display, the graphical user interface displaying
a graph-like three-dimensional representation of a document search process and corresponding search results, and
selection features that, when activated by user input, invoke document searches, rotate the graph-like three-dimensional representation, and alter the three-dimensional representation.

2. The document-searching system of claim 1 wherein the graph-like three-dimensional representation of the document search process and corresponding search results comprises term nodes, document nodes, and links that link term nodes to document nodes.

3. The document-searching system of claim 2 wherein the graph-like three-dimensional representation of the document search process and corresponding search results further includes bifurcated term-node pairs and bifurcated document-node pairs interconnected with source-change links.

4. The document-searching system of claim 2 wherein selection features that, when activated by user input, invoke document searches, alter the graph-like three-dimensional representation of the document search process and corresponding search results include a column of icons that includes:
an icon that, when selected by a user, results in display of a variety of different navigation tools using which a user navigate within the graph-like three-dimensional representation of the document search process and corresponding search results;
an icon that, when selected by a user, undoes the last completed operation;
an icon that, when selected by a user, provides an eraser tool to allow for nodes to be deleted from the graph-like three-dimensional representation of the document search process and corresponding search results;
an icon that, when selected by a user, invokes various different types of expansion functionalities that expand term nodes with additional searches and that expand document nodes with document analyses;
an icon that, when selected by a user, invokes a lasso operation for defining groups of nodes, the defined groups having selectable alternative display modes;
an icon that, when selected by a user, invokes a path-definition utility for defining paths of nodes through the graph, the defined paths having selectable alternative display modes; and
an icon that, when selected by a user, invokes a search-in-graph functionality that searches document nodes within the graph-like three-dimensional representation of the document search process and corresponding search results include a column of icons.

5. The document-searching system of claim 2 wherein selection features that, when activated by user input, invoke document searches, alter the graph-like three-dimensional representation of the document search process and corresponding search results include a main-menu selection wheel that includes:
an icon that, when selected by a user, invokes a locator-menu selection wheel;
an icon that, when selected by a user, invokes a new search and display of a new graph-like representation of the search process and search results;
an icon that, when selected by a user, toggles between three-dimensional and two-dimensional representations of the search process and search results;
an icon that, when selected by a user, invokes a heat-map representation of search results;
an icon that, when selected by a user, toggles between displaying and not displaying titles for nodes;
an icon that, when selected by a user, invokes a help utility; and
an icon that, when selected by a user, invokes an aggregation utility that can aggregate the outer level of leaf nodes in order to facilitate viewing lower-level layers of nodes in a displayed graph-like three-dimensional representation of the document search process and corresponding search results.

6. The document-searching system of claim 5 wherein the heat-map representation of search results comprises a three-dimensional surface fitted over the graph-like three-dimensional representation of the document search process and corresponding search results with coloring and/or shading representing the relevance of underlying document nodes.

7. The document-searching system of claim 2 wherein selection features that, when activated by user input, invoke document searches, alter the graph-like three-dimensional representation of the document search process and corresponding search results include a locator-menu selection wheel that includes:
an icon that, when selected by a user, invokes selection of groups and/or paths for automated navigation;
an icon that, when selected by a user, invokes a utility for selection of document categories for automatic navigation;
an icon that, when selected by a user, selects attribute-value-based node location; and
an icon that, when selected by a user, provides for automatic navigation to nodes representing added terms in sequential searching.

8. The document-searching system of claim 2 wherein the graphical user interface alternatively displays a search process and corresponding search results as a stack, the stack comprising a set of vertically layered dimension planes corresponding to categories, each dimension plane containing an orbit along which nodes are positioned according to relevance.

9. The document-searching system of claim 8 wherein the stack further includes links between nodes corresponding to paths between corresponding document nodes in the graph-like three-dimensional representation of the document search process and corresponding search results

10. The document-searching system of claim 9 wherein a stack node may represent one or more document nodes and may be radially expanded to show individual document nodes.

11. A document-searching method comprising:
providing a user device having at least one processor, one or more memories, a network interface, and an electronic display, the user device receiving user input, transmitting requests to a remote server through the network interface, including document-search requests, and receiving responses to the transmitted requests from the remote server through the network interface, including document search results;
displaying a graphical user interface on the electronic display that includes selection features that, when activated by user input, invoke document searches, rotate the graph-like three-dimensional representation, and alter the three-dimensional representation; and
in response to invocation of a document search, displaying a graph-like three-dimensional representation of a document search process and corresponding search results.

12. The method of claim 11 wherein the graph-like three-dimensional representation of the document search process and corresponding search results comprises term nodes, document nodes, and links that link term nodes to document nodes.

13. The method of claim 12 wherein the graph-like three-dimensional representation of the document search process and corresponding search results further includes bifurcated term-node pairs and bifurcated document-node pairs interconnected with source-change links.

14. The method of claim 12 wherein selection features that, when activated by user input, invoke document searches, alter the graph-like three-dimensional representation of the document search process and corresponding search results include a column of icons that includes:
an icon that, when selected by a user, results in display of a variety of different navigation tools using which a user navigate within the graph-like three-dimensional representation of the document search process and corresponding search results;
an icon that, when selected by a user, undoes the last completed operation;
an icon that, when selected by a user, provides an eraser tool to allow for nodes to be deleted from the graph-like three-dimensional representation of the document search process and corresponding search results;
an icon that, when selected by a user, invokes various different types of expansion functionalities that expand term nodes with additional searches and that expand document nodes with document analyses;
an icon that, when selected by a user, invokes a lasso operation for defining groups of nodes, the defined groups having selectable alternative display modes;
an icon that, when selected by a user, invokes a path-definition utility for defining paths of nodes through the graph, the defined paths having selectable alternative display modes; and
an icon that, when selected by a user, invokes a search-in-graph functionality that searches document nodes within the graph-like three-dimensional representation of the document search process and corresponding search results include a column of icons.

15. The method of claim 12 wherein selection features that, when activated by user input, invoke document searches, alter the graph-like three-dimensional representation of the document search process and corresponding search results include a main-menu selection wheel that includes:
an icon that, when selected by a user, invokes a locator-menu selection wheel;
an icon that, when selected by a user, invokes a new search and display of a new graph-like representation of the search process and search results;
an icon that, when selected by a user, toggles between three-dimensional and two-dimensional representations of the search process and search results;
an icon that, when selected by a user, invokes a heat-map representation of search results;
an icon that, when selected by a user, toggles between displaying and not displaying titles for nodes;
an icon that, when selected by a user, invokes a help utility; and
an icon that, when selected by a user, invokes an aggregation utility that can aggregate the outer level of leaf nodes in order to facilitate viewing lower-level layers of nodes in a displayed graph-like three-dimensional representation of the document search process and corresponding search results.

16. The method of claim 15 wherein the heat-map representation of search results comprises a three-dimensional surface fitted over the graph-like three-dimensional representation of the document search process and corresponding search results with coloring and/or shading representing the relevance of underlying document nodes.

17. The method of claim 12 wherein selection features that, when activated by user input, invoke document searches, alter the graph-like three-dimensional representation of the document search process and corresponding search results include a locator-menu selection wheel that includes:
an icon that, when selected by a user, invokes selection of groups and/or paths for automated navigation;
an icon that, when selected by a user, invokes a utility for selection of document categories for automatic navigation;
an icon that, when selected by a user, selects attribute-value-based node location; and
an icon that, when selected by a user, provides for automatic navigation to nodes representing added terms in sequential searching.

18. The method of claim 12 wherein the graphical user interface alternatively displays a search process and corresponding search results as a stack, the stack comprising a set of vertically layered dimension planes corresponding to categories, each dimension plane containing an orbit along which nodes are positioned according to relevance.

19. The method of claim 18 wherein the stack further includes links between nodes corresponding to paths between corresponding document nodes in the graph-like three-dimensional representation of the document search process and corresponding search results

20. The method of claim 19 wherein a stack node may represent one or more document nodes and may be radially expanded to show individual document nodes.
